(19) United States
(12) Patent Application Publication
(10) Pub. No.: US 2020/0322868 A1
(43) Pub. Date: Oct. 8, 2020

(54) METHOD, APPARATUS, AND SYSTEM FOR IMPROVING TOPOLOGY OF WIRELESS SENSING SYSTEMS

(71) Applicant: ORIGIN WIRELESS, INC., Greenbelt, MD (US)

(72) Inventors: David N. CLAFFEY, Somerville, MA (US); Zhung-Han WU, College Park, MD (US); Hung-Quoc Duc LAI, Parkville, MD (US); Beibei WANG, Clarksville, MD (US); Oscar Chi-Lim AU, San Jose, CA (US); K. J. Ray LIU, Potomac, MD (US); Jeng-Feng LEE, Cambridge, MA (US); Chao-Lun MAI, Cambridge, MA (US); Feng ZHANG, Greenbelt, MD (US)

(73) Assignee: ORIGIN WIRELESS, INC., Greenbelt, MD (US)

(21) Appl. No.: 16/909,913

(22) Filed: Jun. 23, 2020

Related U.S. Application Data
(63) Continuation-in-part of application No. 15/326,112, filed on Jan. 13, 2017.
Application No. 15/326,112 is a continuation-in-part of application No. 16/127,151, filed on Sep. 10, 2018.
Application No. 16/127,151 is a continuation-in-part of application No. PCT/US2017/021963, filed on Mar. 10, 2017.
Application No. PCT/US2017/021963 is a continuation-in-part of application No. 16/125,748, filed on Sep. 9, 2018.
Application No. 16/125,748 is a continuation-in-part of application No. PCT/US2017/015909, filed on Jan. 31, 2017.
Application No. PCT/US2017/015909 is a continuation-in-part of application No. 15/861,422, filed on Jan. 3, 2018.
Application No. 15/861,422 is a continuation-in-part of application No. 16/200,608, filed on Nov. 26, 2018, now Pat. No. 10,735,298.
Application No. 16/200,608 is a continuation-in-part of application No. 16/446,589, filed on Jun. 19, 2019, now Pat. No. 10,742,475.
Application No. 16/446,589 is a continuation-in-part of application No. 16/667,648, filed on Oct. 29, 2019.
Application No. 16/667,648 is a continuation-in-part of application No. 16/667,757, filed on Oct. 29, 2019.
Application No. 16/667,757 is a continuation-in-part of application No. 16/790,610, filed on Feb. 13, 2020.
Application No. 16/790,610 is a continuation-in-part of application No. 16/790,627, filed on Feb. 13, 2020.
Application No. 16/790,627 is a continuation-in-part of application No. 16/798,337, filed on Feb. 22, 2020.
Application No. 16/798,337 is a continuation-in-part of application No. 16/798,343, filed on Feb. 22, 2020.
Application No. 16/798,343 is a continuation-in-part of application No. 62/984,737, filed on Mar. 3, 2020.
Application No. 62/984,737 is a continuation-in-part of application No. 16/870,996, filed on May 10, 2020.
Application No. 16/870,996 is a continuation-in-part of application No. 16/871,000, filed on May 10, 2020.
Application No. 16/871,000 is a continuation-in-part of application No. 16/871,004, filed on May 10, 2020.
Application No. 16/871,004 is a continuation-in-part of application No. 16/871,006, filed on May 10, 2020.
(60) Provisional application No. 62/868,782, filed on Jun. 28, 2019.
(60) Provisional application No. 62/873,781, filed on Jul. 12, 2019.
(60) Provisional application No. 62/900,565, filed on Sep. 15, 2019.
(60) Provisional application No. 62/902,357, filed on Sep. 18, 2019.
(60) Provisional application No. 62/950,093, filed on Dec. 18, 2019.
(60) Provisional application No. 62/977,326, filed on Feb. 16, 2020.
(60) Provisional application No. 62/980,206, filed on Feb. 22, 2020.
(60) Provisional application No. 62/981,387, filed on Feb. 25, 2020.
(60) Provisional application No. 63/001,226, filed on Mar. 27, 2020.
(60) Provisional application No. 63/038,037, filed on Jun. 11, 2020.

(51) Int. Cl. H04W 40/02; H04L 12/44

(52) U.S. Cl. CPC H04W 40/02; H04W 84/18; H04L 12/44

(57) ABSTRACT

Methods, apparatus and systems for analyzing and improving topology and architecture of a wireless sensing system are described. In one embodiment, a described method comprises: determining an interconnection structure of a wireless sensing system comprising a plurality of wireless devices in a venue to be a tree; and for each pairwise wireless link being a branch of the tree and connecting a first device and a second device, transmitting, by the first device, a wireless signal through a wireless multipath channel of the venue to the second device, wherein the wireless multipath channel is impacted by an object motion of an object in the venue, receiving the wireless signal by the second device, obtaining a time series of channel information (CI) of the wireless multipath channel based on the wireless signal, monitoring the object motion based on the time series of CI (TSCI), and computing a linkwise analytics related to the object motion based on the TSCI.

### CROSS-REFERENCE TO RELATED APPLICATIONS

The present application hereby incorporates by reference the entirety of the disclosures of, and claims priority to, each of the following cases:
(a) U.S. patent application Ser. No. 15/326,112, entitled “WIRELESS POSITIONING SYSTEMS”, filed on Jan. 13, 2017,
   (1) which is a national stage entry of PCT patent application PCT/US2015/041037, entitled “WIRELESS POSITIONING SYSTEMS”, filed on Jul. 17, 2015, published as WO 2016/011433A2 on Jan. 21, 2016,
(b) U.S. patent application Ser. No. 16/127,151, entitled “METHODS, APPARATUS, SERVERS, AND SYSTEMS FOR VITAL SIGNS DETECTION AND MONITORING”, filed on Sep. 10, 2018,
   (1) which is a continuation-in-part of PCT patent application PCT/US2017/021963, entitled “METHODS, APPARATUS, SERVERS, AND SYSTEMS FOR VITAL SIGNS DETECTION ANDMONITORING”, tiled on Mar. 10, 2017, published. as WO2017/156492A1 on Sep. 14, 2017,
(c) U.S. patent application Ser. No. 16/125,748, entitled “METHODS, DEVICES, SERVERS, APPARATUS, AND SYSTEMS FOR WIRELESS INTERNET OF THINGS APPLICATIONS”, filed on Sep. 9, 2018,
   (1) which is a continuation-in-part of PCT patent application PCT/US2017/015909, entitled “METHODS, DEVICES, SERVERS, APPARATUS, AND SYSTEMS FOR WIRELESS INTERNET OF THINGS APPLICATIONS”, filed on Jan. 31, 2017, published as WO2017/155634A1 on Sep. 14, 2017,
(d) U.S. patent application Ser. No. 15/861,422, entitled “METHOD, APPARATUS, SERVER, AND SYSTEMS OF TIME-REVERSAL TECHNOLOGY”, filed on Jan. 3, 2018,
(e) U.S. patent application Ser. No. 16/200,608, entitled “METHOD, APPARATUS, SERVER AND SYSTEM FOR VITAL SIGN DETECTION AND MONITORING”, filed on Nov. 26, 2018,
(f) U.S. patent application Ser. No. 16/446,589, entitled “METHOD, APPARATUS, AND SYSTEM FOR OBJECT TRACKING AND SENSING USING BROADCASTING”, filed on Jun. 19, 2019,
(g) U.S. Provisional Patent application 62/868,782, entitled “METHOD, APPARATUS, AND SYSTEM FOR VITAL SIGNS MONITORING USING HIGH FREQUENCY WIRELESS SIGNALS”, filed on Jun. 28, 2019,
(h) U.S. Provisional Patent application 62/873,781, entitled “METHOD, APPARATUS, AND SYSTEM FOR IMPROVING TOPOLOGY OF WIRELESS SENSING SYSTEMS”, filed on Jul. 12, 2019,
(i) U.S. Provisional Patent application 62/900,565, entitled “QUALIFIED WIRELESS SENSING SYSTEM”, filed on Sep. 15, 2019,
(j) U.S. Provisional Patent application 62/902,357, entitled “METHOD, APPARATUS, AND SYSTEM FOR AUTOMATIC AND OPTIMIZED DEVICE-TO-CLOUD CONNECTION FOR WIRELESS SENSING”, filed on Sep. 18, 2019,
(k) U.S. patent application Ser. No. 16/667,648, entitled “METHOD, APPARATUS, AND SYSTEM FOR WIRELESS PROXIMITY AND PRESENCE MONITORING”, filed on Oct. 29, 2019,
(l) U.S. patent application Ser. No. 16/667,757, entitled “METHOD, APPARATUS, AND SYSTEM FOR HUMAN IDENTIFICATION BASED ON HUMAN RADIO BIOMETRIC INFORMATION”, filed on Oct. 29, 2019,
(m) U.S. Provisional Patent application 62/950,093, entitled “METHOD, APPARATUS, AND SYSTEM FOR TARGET POSITIONING”, filed on Dec. 18, 2019,
(n) U.S. patent application Ser. No. 16/790,610, entitled “METHOD, APPARATUS, AND SYSTEM FOR WIRELESS GAIT RECOGNITION”, tiled Feb. 13, 2020,
(o) U.S. patent application Ser. No. 16/790,627, entitled “METHOD, APPARATUS, AND SYSTEM FOR OUTDOOR TARGET TRACKING”, filed Feb. 13, 2020.
(p) U.S. Provisional Patent application 62/977,326, entitled “METHOD, APPARATUS, AND SYSTEM FOR AUTOMATIC AND ADAPTIVE WIRELESS MONITORING AND TRACKING”, filed on Feb. 16, 2020,
(q) U.S. patent application Ser. No. 16/798,337, entitled “METHOD, APPARATUS, AND SYSTEM FOR WIRELESS OBJECT SCANNING”, filed Feb. 22, 2020,
(r) U.S. patent application Ser. No. 16/798,343, entitled “METHOD, APPARATUS, AND SYSTEM FOR WIRELESS OBJECT TRACKING”, filed. Feb. 22, 2020,
(s) U.S. Provisional Patent application 62/980,206, entitled “METHOD, APPARATUS, AND SYSTEM FOR WIRELESS SENSING”, filed on Feb. 22, 2020,
(t) U.S. Provisional Patent application 62/981,387, entitled “METHOD, APPARATUS, AND SYSTEM FOR VEHICLE WIRELESS MONITORING”, filed on Feb. 25, 2020,
(u) U.S. Provisional Patent application 62/984,737, entitled “METHOD, APPARATUS, AND SYSTEM FOR IMPROVED WIRELESS MONITORING”, filed on Mar. 3, 2020,
(v) U.S. Provisional Patent application 63/001,226, entitled “METHOD, APPARATUS, AND SYSTEM FOR IMPROVED WIRELESS MONITORING AND USER INTERFACE”, filed on Mar. 27, 2020,
(w) U.S. patent application Ser. No. 16/870,996, entitled “METHOD, APPARATUS, AND SYSTEM FOR WIRELESS INERTIAL MEASUREMENT”, filed on May 10, 2020,
(x) U.S. patent application Ser. No. 16/871,000, entitled “METHOD, APPARATUS, AND SYSTEM FOR WIRELESS TRACKING WITH GRAPH-BASED PARTICLE FILTERING”, filed on May 10, 2020,
(y) U.S. patent application Ser. No. 16/871,004, entitled “METHOD, APPARATUS, AND SYSTEM FOR PEOPLE COUNTING AND RECOGNITION BASED ON RHYTHMIC MOTION MONITORING”, filed on May 10, 2020,
(z) U.S. patent application Ser. No. 16/871,006, entitled “METHOD, APPARATUS, AND SYSTEM FOR VITAL SIGNS N/IONITORING USING HIGH FREQUENCY WIRELESS SIGNALS”, filed on May 10, 2020,
(aa) U.S. Provisional Patent application 63/038,037, entitled “METHOD, APPARATUS, AND SYSTEM FOR MOTION LOCALIZATION, WALKING DETECTION AND DEVICE QUALIFICATION”, filed on Jun. 11, 2020.

### TECHNICAL FIELD

The present teaching generally relates to topology and architecture of a wireless sensing system, based on wireless channel information.

### BACKGROUND

A wireless mesh network (WMN) is a communications network made up of radio nodes organized in a mesh topology. It is also a form of wireless ad hoc network. A mesh refers to rich interconnection among devices or nodes. Wireless mesh networks often include mesh clients, mesh routers and gateways, Mobility of nodes is less frequent. If nodes constantly or frequently move, the mesh spends more time updating routes than delivering data. In a wireless mesh network, topology tends to be more static, so that routes computation can converge and delivery of data to their destinations can occur. Hence, this is a low-mobility centralized form of wireless ad hoc network. In addition, because it sometimes relies on static nodes to act as gateways, it is not a truly all-wireless ad hoc network.

Mesh clients are often laptops, cell phones, and other wireless devices. Mesh routers forward traffic to and from the gateways, which may, but need not, be connected to the Internet. The coverage area of all radio nodes working as a single network is sometimes called a mesh cloud. Access to this mesh cloud depends on the radio nodes working together to create a radio network. A mesh network is reliable and offers redundancy. When one node can no longer operate, the rest of the nodes can still communicate with each other, directly or through one or more intermediate nodes. Wireless mesh networks can self-form and self-heal. Wireless mesh networks work with different wireless technologies including 802.11, 802.15, 802.16, cellular technologies and need not be restricted to any one technology or protocol.

With the significant growth of the semiconductor industry, creating small devices with powerful processing ability and network capabilities are no longer a dream for engineers.

Currently, Internet of Things (IoT) has become one of the hottest topics in both industry and academia of wireless communication field. Today, most of the research of the IoT-enabled devices is mainly of the data collecting and processing units namely creating new sensors. However, the network that integrating the IoT devices to the Internet is usually left untouched by simply using existing computer network solutions such as WLAN or Bluetooth. These computer networks are not designed for low-powered devices such as remote sensors even these IoT devices are considered to be mini computers. The single point of failure nature of these networks makes the entire system extremely vulnerable when it comes to disasters or even difficult environment as the sensors may need to be deployed into sonic hardly reachable locations. In addition, the capacity of the central hub/router of the network can also limit the coverage of the service provided by IoT devices, and the range is also constrained by the same factors. As most of these remote IoT devices are small, and the devices are usually battery powered, so the power-hungry network options such as using cellular network or satellite are also not ideal for most of the remote scenarios in the IoT networks.

The distributed network nature of the wireless mesh network with its simple configuration is ideal for implementing the IbT networks to take advantage of its expanded range as well as keep the hardware design minimal using smaller network module. Such networks are also more robust in the harsh environment as the networks are distributed with no single central point of failure.

### SUMMARY

The present teaching generally relates to topology and architecture of a wireless sensing system. More specifically, the present teaching relates to analyzing and improving topology and architecture of a wireless sensing system based on wireless channel information.

In one embodiment, a method of a wireless sensing system is described. The method comprises: determining an interconnection structure of the wireless sensing system comprising a plurality of wireless devices in a venue to be a tree. Each of the plurality of wireless devices is at least one of: a Type A device having at least one wireless transmitter configured for transmitting wireless signals, or a Type A device having at least one wireless transceiver configured for both transmitting and receiving wireless signals. Each of the plurality of wireless devices is a node of the tree. Each Type A device is a leaf of the tree. Each Type B device is a leaf or a non-leaf of the tree. One Type B device is a root device of the tree. The plurality of wireless devices form at least one pairwise wireless link each being a branch of the tree and connecting a first device and a second device. The first device is at least one of: a Type A device or a non-root Type B device. The second device is a Type B device. The method further comprises: for each pairwise wireless link, transmitting, by the first device, a wireless signal through a wireless multipath channel of the venue to the second device, wherein the wireless multipath channel is impacted by an object motion of an object in the venue, receiving the wireless signal by the second device, obtaining a time series of channel information (CI) of the wireless multipath channel based on the wireless signal, monitoring the object motion based on the time series of CI (TSCI), and computing a. linkwise analytics related to the object motion based on the TSCI.

In another embodiment, a wireless sensing system is described. The wireless sensing system comprises a plurality of wireless devices in a venue. An interconnection structure of the plurality of wireless devices is a tree. Each of the plurality of wireless devices is at least one of: a Type A device having at least one wireless transmitter configured for transmitting wireless signals, or a Type B device having at least one wireless transceiver configured for both transmitting and receiving wireless signals. Each of the plurality of wireless devices is a node of the tree. Each Type A device is a leaf of the tree. Each Type B device is a leaf or a non-leaf of the tree. One Type B device is a root device of the tree. The plurality of wireless devices form at least one pairwise wireless link each being a branch of the tree and connecting a first device and a second device. The first device is at least one of: a Type A device or a non-root Type B device. The second device is a Type B device. For each pairwise wireless link, the first device is configured for transmitting a wireless signal through a wireless multipath channel of the venue to the second device, wherein the wireless multipath channel is impacted by an object motion of an object in the venue, and the second device is configured for: receiving the wireless signal from the first device, obtaining a time series of channel information (CI) of the wireless multipath channel based on the wireless signal, monitoring the object motion based on the time series of CI (TSCI), and computing a linkwise analytics related to the object motion based on the TSCI,

Other concepts relate to software for implementing the present teaching on analyzing and improving topology and architecture of a wireless sensing system. Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF DRAWINGS

The methods, systems, and/or devices described herein are further described in terms of exemplary embodiments. These exemplary embodiments are described in detail with reference to the drawings. These embodiments are non-limiting exemplary embodiments, in which like reference numerals represent similar structures throughout the several views of the drawings.

FIG. 1 shows an exemplary network topology of four devices, according to some embodiments of the present teaching.

FIG. 2 shows an exemplary network topology of three devices, according to some embodiments of the present teaching.

FIG. 3 shows exemplary flow chart and components of a Master Origin device, according to some embodiments of the present teaching.

FIG. 4 shows an exemplary network topology of six devices, according to some embodiments of the present teaching.

FIG. 5 shows an exemplary network topology of nine devices in the local area network, according to some embodiments of the present teaching.

FIG. 6 illustrates a flow chart of an exemplary method for analyzing and improving network topology, according to some embodiments of the present teaching.

FIG. 7 illustrates an exemplary diagram for a system of object motion detection, according to one embodiment of the present teaching.

FIG. 8 illustrates an exemplary diagram for a system of object motion detection, according to one embodiment of the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

In one embodiment, the present teaching discloses a method, apparatus, device, system, and/or software (method/apparatus/device/system/software) of a wireless monitoring system. A time series of channel information (CI) of a wireless multipath channel (channel) may be obtained (e.g. dynamically) using a processor, a memory communicatively coupled with the processor and a set of instructions stored in the memory. The time series of CI (TSCI) may be extracted from a wireless signal (signal) transmitted between a Type 1 heterogeneous wireless device (e.g. wireless transmitter, TX) and a Type 2 heterogeneous wireless device (e.g. wireless receiver, RX) in a venue through the channel. The channel may be impacted by an expression (e.g. motion, movement, expression, and/or change in position/pose/shape/expression) of an object in the venue. A characteristics and/or a spatial-temporal information (STI, e.g. motion information) of the object and/or of the motion of the object may be monitored based on the TSCI. A task may be performed based on the characteristics and/or STI. A presentation associated with the task may be generated in a user-interface (UI) on a device of a user. The TSCI may be a wireless signal stream. The TSCI or each CI may be preprocessed. A device may be a station (STA). The symbol “A/B” means “A and/or B” in the present teaching.

The expression may comprise placement, placement of moveable parts, location, position, orientation, identifiable place, region, spatial coordinate, presentation, state, static expression, size, length, width, height, angle, scale, shape, curve, surface, area, volume, pose, posture, manifestation, body language, dynamic expression, motion, motion sequence, gesture, extension, contraction, distortion, deformation, body expression (e.g. head, face, eye, mouth, tongue, hair, voice, neck, limbs, arm, hand, leg, foot, muscle, moveable parts), surface expression (e.g. shape, texture, material, color, electromagnetic (EM) characteristics, visual pattern, wetness, reflectance, translucency, flexibility), material property (e.g. living tissue, hair, fabric, metal, wood, leather, plastic, artificial material, solid, liquid, gas, temperature), movement, activity, behavior, change of expression, and/or some combination.

The wireless signal may comprise: transmitted/received signal, EM radiation, RF signal/transmission, signal in licensed/unlicensed/ISM band, bandlimited signal, baseband signal, wireless/mobile/cellular communication signal, wireless/mobile/cellular network signal, mesh signal, light signal,/communication, downlink/uplink signal, unicast/multicast/broadcast signal, standard (e.g. WLAN, WWAN, WPAN, WBAN, international, national, industry, defacto, IEEE, IEEE 802, 802.11/15/16, WiFi, 802.11n/ac/ax/be, 3G/4G/LTE/5G/6G/7G/8G, 3GPP, Bluetooth, BLE, Zigbee, RFID, UWB, WiMax) compliant signal, protocol signal, standard frame, beacon/pilot/probe/enquiry/acknowledgement/handshake/synchronization signal, management/control/data frame, management/control/data signal, standardized wireless/cellular communication protocol, reference signal, source signal, motion probe/detection/sensing signal, and/or series of signals. The wireless signal may comprise a line-of-sight (LOS), and/or a non-LOS component (or path/link). Each CI may be extracted/generated/computed/sensed at a layer (e.g. PHY/MAC layer in OSI model) of Type 2 device and may be obtained by an application (e.g. software, firmware, driver, app, wireless monitoring software/system)

The wireless multipath channel may comprise: a communication channel, analog frequency channel (e.g. with analog carrier frequency near 700/800/900 MHz, 1.8/1.8/2.4/3/5/6/27/60 GHz), coded channel (e.g. in CDMA), and/or channel of a wireless network/system (e.g. WLAN, WiFi, mesh, LTE, 4G/5G, Bluetooth, Zigbee, UWB, RFID, microwave). It may comprise more than one channel. The channels may be consecutive (e.g. with adjacent/overlapping bands) or non-consecutive channels (e.g. non-overlapping WiFi channels, one at 2.4 GHz and one at 5 GHz).

The TSCI may be extracted from the wireless signal at a layer of the Type 2 device (e.g. a layer of OSI reference model, physical layer, data link layer, logical link control layer, media access control (MAC) layer, network layer, transport layer, session layer, presentation layer, application layer, TCP/IP layer, internet layer, link layer). The TSCI may be extracted from a derived signal (e.g. baseband signal, motion detection signal, motion sensing signal) derived from the wireless signal (e.g. RF signal). It may be (wireless) measurements sensed by the communication protocol (e.g. standardized protocol) using existing mechanism (e.g. wireless/cellular communication standard/network, 3G/LTE/4G/5G/6G/7G/8G, WiFi, IEEE 802.11/15/16). The derived signal may comprise a packet with at least one of: a preamble, a header and a payload (e.g. for data/control/management in wireless links/networks). The TSCI may be extracted from a probe signal (e.g. training sequence, SIT, LTF, L-STF, HE-STF, HE-SIG-A, HE-SIG-B, CEF) in the packet. A motion detection/sensing signal may be recognized/identified base on the probe signal. The packet may be a standard-compliant protocol frame, management frame, control frame, data frame, sounding frame, excitation frame, illumination frame, null data frame, beacon frame, pilot frame, probe frame, request frame, response frame, association frame, reassociation frame, disassociation frame, authentication frame, action frame, report frame, poll frame, announcement frame, extension frame, enquiry frame, acknowledgement frame, RTS frame, CTS frame, QoS frame, CF-Poll frame, CF-Ack frame, block acknowledgement frame, reference frame, training frame, and/or synchronization frame.

The packet may comprise a control data and/or a motion detection probe. A data (e.g. ID/parameters/characteristics/settings/control signal/command/instruction/notification/broadcasting-related information of the Type 1 device) may be obtained from the payload. The wireless signal may be transmitted by the Type 1 device. It may be received by the Type 2 device. A database (e.g. in local server, hub device, cloud server, storage network) may be used to store the TSCI, characteristics, STI, signatures, patterns, behaviors, trends, parameters, analytics, output responses, identification information, user information, device information, channel information, venue (e.g. map, environmental model, network, proximity devices/networks) information, task information, class/category information, presentation (e.g. UI) information, and/or other information.

The Type 1/Type 2 device may comprise at least one of: electronics, circuitry, transmitter (TX)/receiver (RX)/transceiver, RF interface, “Origin Satellite”/“Tracker Bot”, unicast/multicast/broadcasting device, wireless source device, source/destination device, wireless node, hub device, target device, motion detection device, sensor device, remote/wireless sensor device, wireless communication device, wireless-enabled device, standard compliant device, and/or receiver. The Type 1 (or Type 2) device may be heterogeneous because, when there are more than one instances of Type 1 (or Type 2) device, they may have different circuitry, enclosure, structure, purpose, auxiliary functionality, chip/IC, processor, memory, software, firmware, network connectivity, antenna, brand, model, appearance, form, shape, color, material, and/or specification. The Type 1/Type 2 device may comprise: access point, router, mesh router, internet-of-things (IoT) device, wireless terminal, one or more radio/RF subsystem/wireless interface (e.g. 2.4 GHz radio, 5 GHz radio, front haul radio, backhaul radio), modem, RF front end, RF/radio chip or integrated circuit (IC).

At least one of: Type 1 device, Type 2 device, a link between them, the object, the characteristics, the STI, the monitoring of the motion, and the task may be associated with an identification (ID) such as UUID. The Type 1/Type 2/another device may obtain/store/retrieve/access/preprocess/condition/process/analyze/monitor/apply the TSCI. The Type 1 and Type 2 devices may communicate network traffic in another channel (e.g. Ethernet, HDMI, USB, Bluetooth, BLE, WiFi, LTE, other network, the wireless multipath channel) in parallel to the wireless signal. The Type 2 device may passively observe/monitor/receive the wireless signal from the Type 1 device in the wireless multipath channel without establishing connection (e.g. association/authentication) with, or requesting service from, the Type 1 device.

The transmitter (i.e. Type 1 device) may function as (play role of) receiver (i.e. Type 2 device) temporarily, sporadically, continuously, repeatedly, interchangeably, alternately, simultaneously, concurrently, and/or contemporaneously; and vice versa. A device may function as Type 1 device (transmitter) and/or Type 2 device (receiver) temporarily, sporadically, continuously, repeatedly, simultaneously, concurrently, and/or contemporaneously. There may be multiple wireless nodes each being Type 1 (TX) and/or Type 2 (RX) device. A TSCI may be obtained between every two nodes when they exchange/communicate wireless signals. The characteristics and/or STI of the object may be monitored individually based on a TSCI, or jointly based on two or more (e.g. all) TSCI. The motion of the object may be monitored actively (in that Type 1 device, Type 2 device, or both, are wearable of/associated with the object) and/or passively (in that both Type 1 and Type 2 devices are not wearable of/associated with the object) It may be passive because the object may not be associated with the Type 1 device and/or the Type 2 device. The object (e.g. user, an automated guided vehicle or AGV) may not need to carry/install any wearables/fixtures the Type 1 device and the Type 2 device are not wearable/attached devices that the object needs to carry in order perform the task). It may be active because the object may be associated with either the Type 1 device and/or the Type 2 device. The object may carry (or installed) a wearable/a fixture (e.g. the Type 1 device, the Type 2 device, a device communicatively coupled with either the Type 1 device or the Type 2 device).

The presentation may be visual, audio, image, video, animation, graphical presentation, text, etc. A computation of the task may be performed by a processor (or logic unit) of the Type 1 device, a processor (or logic unit) of an IC of the Type 1 device, a processor (or logic unit) of the Type 2 device, a processor of an IC of the Type 2 device, a local server, a cloud server, a data analysis subsystem, a signal analysis subsystem, and/or another processor. The task may be performed with/without reference to a wireless fingerprint or a baseline (e.g. collected, processed, computed, transmitted and/or stored in a training phase/survey/current survey/previous survey/recent survey/initial wireless survey, a passive fingerprint), a training, a profile, a trained profile, a static profile, a survey, an initial wireless survey, an initial setup, an installation, a re-training, an updating and a reset.

The Type 1 device (TX device) may comprise at least one heterogeneous wireless transmitter. The Type 2 device (RX device) may comprise at least one heterogeneous wireless receiver. The Type 1 device and the Type 2 device may be collocated. The Type 1 device and the Type 2 device may be the same device. Any device may have a data processing unit/apparatus, a computing unit/system, a network unit/system, a processor (e.g. logic unit), a memory communicatively coupled with the processor, and a set of instructions stored in the memory to be executed by the processor. Some processors, memories and sets of instructions may be coordinated. There may be multiple Type 1 devices interacting (e.g. communicating, exchange signal/control/notification/other data) with the same Type 2 device (or multiple Type 2 devices and/or there may be multiple Type 2 devices interacting with the same Type 1 device. The multiple Type 1 devices/Type 2 devices may be synchronized and/or asynchronous, with same/different window width/size and/or time shift, same/different synchronized start time, synchronized end time, etc. Wireless signals sent by the multiple Type 1 devices may be sporadic, temporary, continuous, repeated, synchronous, simultaneous, concurrent, and/or contemporaneous. The multiple Type 1 devices/Type 2 devices may operate independently and/or collaboratively. A Type 1 and/or Type 2 device may have/comprise/be heterogeneous hardware circuitry (e.g. a heterogeneous chip or a heterogeneous IC capable of generating/receiving the wireless signal, extracting CI from received signal, or making the CI available). They may be communicatively coupled to same or different servers (e.g. cloud server, edge server, local server, hub device).

Operation of one device may be based on operation, state, internal state, storage, processor, memory output, physical location, computing resources, network of another device. Difference devices may communicate directly, and/or via another device/server/hub device/cloud server. The devices may be associated with one or more users, with associated settings. The settings may be chosen once, pre-programmed, and/or changed (e.g. adjusted, varied, modified)/varied over time. There may be additional steps in the method. The steps and/or the additional steps of the method may be performed in the order shown or in another order. Any steps may be performed in parallel, iterated, or otherwise repeated or performed in another manner. A user may be human, adult, older adult, man, woman, juvenile, child, baby, pet, animal, creature, machine, computer module/software, etc.

In the case of one or multiple Type 1 devices interacting with one or multiple Type 2 devices, any processing (e.g. time domain, frequency domain) may be different for different devices. The processing may be based on locations, orientation, direction, roles, user-related characteristics, settings, configurations, available resources, available bandwidth, network connection, hardware, software, processor, co-processor, memory, battery life, available power, antennas, antenna types, directional/unidirectional characteristics of the antenna, power setting, and/or other parameters/characteristics of the devices.

The wireless receiver (e.g. Type 2 device) may receive the signal and/or another signal from the wireless transmitter (e.g. Type 1 device). The wireless receiver may receive another signal from another wireless transmitter (e.g. a second Type 1 device). The wireless transmitter may transmit the signal and/or another signal to another wireless receiver (e.g. a second Type 2 device). The wireless transmitter, wireless receiver, another wireless receiver and/or another wireless transmitter may be moving with the object and/or another object. The another object may be tracked.

The Type 1 and/or Type 2 device may be capable of wirelessly coupling with at least two Type 2 and/or Type 1 devices. The Type 1 device may be caused/controlled to switch/establish wireless coupling (e.g. association, authentication) from the Type 2 device to a second Type 2 device at another location in the venue. Similarly, the Type 2 device may be caused/controlled to switch/establish wireless coupling from the Type 1 device to a second Type 1 device at yet another location in the venue. The switching may be controlled by a server (or a hub device), the processor, the Type 1 device, the Type 2 device, and/or another device. The radio used before and after switching may be different. A second wireless signal (second signal) may be caused to be transmitted between the Type 1 device and the second Type 2 device (or between the Type 2 device and the second Type 1 device) through the channel. A second TSCI of the channel extracted from the second signal may be obtained. The second signal may be the first signal. The characteristics, STI and/or another quantity of the object may be monitored based on the second TSCI. The Type 1 device and the Type 2 device may be the same. The characteristics, STI and/or another quantity with different time stamps may form a waveform. The waveform may be displayed in the presentation.

The wireless signal and/or another signal may have data embedded. The wireless signal may be a series of probe signals (e.g. a repeated transmission of probe signals, a re-use of one or more probe signals). The probe signals may change/vary over time. A probe signal may be a standard compliant signal, protocol signal, standardized wireless protocol signal, control signal, data signal, wireless communication network signal, cellular network signal, WiFi signal, LTE/5G/6G/7G signal, reference signal, beacon signal, motion detection signal, and/or motion sensing signal. A probe signal may be formatted according to a wireless network standard (e.g. WiFi), a cellular network standard (e.g. LTE/5G/6G), or another standard. A probe signal may comprise a packet with a header and a payload. A probe signal may have data embedded. The payload may comprise data. A probe signal may be replaced by a data signal. The probe signal may be embedded in a data signal. The wireless receiver, wireless transmitter, another wireless receiver and/or another wireless transmitter may be associated with at least one processor, memory communicatively coupled with respective processor, and/or respective set of instructions stored in the memory which when executed cause the processor to perform any and/or all steps needed to determine the STI (e.g. motion information), initial STI, initial time, direction, instantaneous location, instantaneous angle, and/or speed, of the object. The processor, the memory and/or the set of instructions may be associated with the Type 1 device, one of the at least one Type 2 device, the object, a device associated with the object, another device associated with the venue, a cloud server, a hub device, and/or another server.

The Type 1 device may transmit the signal in a broadcasting manner to at least one Type 2 device(s) through the channel in the venue. The signal is transmitted without the Type 1 device establishing wireless connection (e.g. association, authentication) with any Type 2 device, and without any Type 2 device requesting services from the Type 1 device. The Type 1 device may transmit to a particular media access control (MAC) address common for more than one Type devices. Each Type 2. device may adjust its MAC address to the particular MAC address. The particular MAC address may be associated with the venue. The association may be recorded in an association table of an Association Server (e.g. hub device). The venue may be identified by the Type 1 device, a Type 2 device and/or another device based on the particular MAC address, the series of probe signals, and/or the at least one TSCI extracted from the probe signals. For example, a Type 2 device may be moved to a new location in the venue (e.g. from another venue). The Type 1 device may be newly set up in the venue such that the Type 1 and Type 2 devices are not aware of each other. During set up, the Type 1 device may be instructed/guided/caused/controlled (e.g. using dummy receiver, using hardware pin setting/connection, using stored setting, using local setting, using remote setting, using downloaded setting, using hub device, or using server) to send the series of probe signals to the particular MAC address. Upon power up, the Type 2 device may scan for probe signals according to a table of MAC addresses (e.g. stored in a designated source, server, hub device, cloud server) that may be used for broadcasting at different locations (e.g. different MAC address used for different venue such as house, office, enclosure, floor, multi-storey building, store, airport, mall, stadium, hall, station, subway, lot, area, zone, region, district, city, country, continent). When the Type 2 device detects the probe signals sent to the particular MAC address, the Type 2 device can use the table to identify the venue based on the MAC address. A location of a Type 2 device in the venue may be computed based on the particular MAC address, the series of probe signals, and/or the at least one TSCI obtained by the Type 2 device from the probe signals. The computing may be performed by the Type 2 device. The particular MAC address may be changed (e.g. adjusted, varied, modified) over time. It may be changed according to a time table, rule, policy, mode, condition, situation and/or change. The particular MAC address may be selected based on availability of the MAC address, a pre-selected list, collision pattern, traffic pattern, data traffic between the Type 1 device and another device, effective bandwidth, random selection, and/or a MAC address switching plan. The particular MAC address may be the MAC address of a second wireless device (e.g. a dummy receiver, or a receiver that serves as a dummy receiver).

The Type 1 device may transmit the probe signals in a channel selected from a set of channels. At least one CI of the selected channel may be obtained by a respective Type 2 device from the probe signal transmitted in the selected channel. The selected channel may be changed (e.g. adjusted, varied, modified) over time. The change may be according to a time table, rule, policy, mode, condition, situation, and/or change. The selected channel may be selected based on availability of channels, random selection, a pre-selected list, co-channel interference, inter-channel interference, channel traffic pattern, data traffic between the Type 1 device and another device, effective bandwidth associated with channels, security criterion, channel switching plan, a criterion, a quality criterion, a signal quality condition, and/or consideration.

The particular MAC address and/or an information of the selected channel may be communicated between the Type 1 device and a server (e.g. hub device) through a network. The particular MAC address and/or the information of the selected channel may also be communicated between a Type 2 device and a server (e.g. hub device) through another network. The Type 2 device may communicate the particular MAC address and/or the information of the selected channel to another Type 2 device (e.g. via mesh network, Bluetooth, WiFi, NFC, ZigBee, etc.). The particular MAC address and/or selected channel may be chosen by a server (e.g. hub device). The particular MAC address and/or selected channel may be signaled in an announcement channel by the Type 1 device, the Type 2 device and/or a server (e.g. hub device). Before being communicated, any information may be pre-processed.

Wireless connection (e.g. association, authentication) between the Type 1 device and another wireless device may be established (e.g. using a signal handshake). The Type 1 device may send a first handshake signal (e.g. sounding frame, probe signal, request-to-send RTS) to the another device. The another device may reply by sending a second handshake signal (e.g. a command, or a clear-to-send CTS) to the Type 1 device, triggering the Type 1 device to transmit the signal (e.g. series of probe signals) in the broadcasting manner to multiple Type 2 devices without establishing connection with any Type 2 device. The second handshake signals may be a response or an acknowledge (e.g. ACK) to the first handshake signal. The second handshake signal may contain a data with information of the venue, and/or the Type 1 device. The another device may be a dummy device with a purpose (e.g. primary purpose, secondary purpose) to establish the wireless connection with the Type 1 device, to receive the first signal, and/or to send the second signal. The another device may be physically attached to the Type 1 device.

In another example, the another device may send a third handshake signal to the Type 1 device triggering the Type 1 device to broadcast the signal (e.g. series of probe signals) to multiple Type 2. devices without establishing connection (e.g. association, authentication) with any Type 2 device. The Type 1 device may reply to the third special signal by transmitting a fourth handshake signal to the another device. The another device may be used to trigger more than one Type 1 devices to broadcast. The triggering may be sequential, partially sequential, partially parallel, or fully parallel. The another device may have more than one wireless circuitries to trigger multiple transmitters in parallel. Parallel trigger may also be achieved using at least one yet another device to perform the triggering (similar to what as the another device does) in parallel to the another device. The another device may not communicate (or suspend communication) with the Type 1 device after establishing connection with the Type 1 device. Suspended communication may be resumed. The another device may enter an inactive mode, hibernation mode, sleep mode, stand-by mode, low-power mode, OFF mode and/or power-down mode, after establishing the connection with the Type 1 device. The another device may have the particular MAC address so that the Type 1 device sends the signal to the particular MAC address. The Type 1 device and/or the another device may be controlled and/or coordinated by a first processor associated with the Type 1 device, a second processor associated with the another device, a third processor associated with a designated source and/or a fourth processor associated with another device. The first and second processors may coordinate with each other.

A first series of probe signals may be transmitted by a first antenna of the Type 1 device to at least one first Type 2 device through a first channel in a first venue. A second series of probe signals may be transmitted by a second antenna of the Type 1 device to at least one second Type 2 device through a second channel in a second venue. The first series and the second series may/may not be different. The at least one first Type 2 device may/may not be different from the at least one second Type 2 device. The first and/or second series of probe signals may be broadcasted without connection (e.g. association, authentication) established between the Type 1 device and any Type 2 device. The first and second antennas may be same/different. The two venues may have different sizes, shape, multipath characteristics. The first and second venues may overlap. The respective immediate areas around the first and second antennas may overlap. The first and second channels may be same/different. For example, the first one may be WiFi while the second may be LTE. Or, both may be WiFi, but the first one may be 2.4 GHz WiFi and the second may be 5 GHz WiFi. Or, both may be 2.4 GHz WiFi, but have different channel numbers, SSID names, and/or WiFi settings.

Each Type 2 device may obtain at least one TSCI from the respective series of probe signals, the CI being of the respective channel between the Type 2 device and the Type 1 device. Some first Type 2 device(s) and some second Type 2 device(s) may be the same. The first and second series of probe signals may be synchronous/asynchronous. A probe signal may be transmitted with data or replaced by a data signal. The first and second antennas may be the same. The first series of probe signals may be transmitted at a first rate (e.g. 30 Hz). The second series of probe signals may be transmitted at a second rate (e.g. 200 Hz). The first and second rates may be same/different. The first and/or second rate may be changed (e.g. adjusted, varied, modified) over time. The change may be according to a time table, rule, policy, mode, condition, situation, and/or change. Any rate may be changed (e.g. adjusted, varied, modified) over time. The first and/or second series of probe signals may be transmitted to a first MAC address and/or second MAC address respectively. The two MAC addresses may be same/different. The first series of probe signals may be transmitted in a first channel. The second series of probe signals may be transmitted in a second channel. The two channels may be same/different. The first or second MAC address, first or second channel may be changed over time. Any change may be according to a time table, rule, policy, mode, condition, situation, and/or change.

The Type 1 device and another device may be controlled and/or coordinated, physically attached, or may be of/in/of a common device. They may be controlled by/connected to a common data processor, or may be connected to a common bus interconnect/network/LAN/Bluetooth network/NFC network/BLE network/wired network/wireless network/mesh network/mobile network/cloud. They may share a common memory, or be associated with a common user, user device, profile, account, identity (ID), identifier, household, house, physical address, location, geographic coordinate, IP subnet, SSID, home device, office device, and/or manufacturing device. Each Type 1 device may be a signal source of a set of respective Type 2 devices it sends a respective signal (e.g. respective series of probe signals) to the set of respective Type 2 devices). Each respective Type 2 device chooses the Type 1 device from among all Type 1 devices as its signal source. Each Type 2 device may choose asynchronously. At least one TSCI may be obtained by each respective Type 2 device from the respective series of probe signals from the Type 1 device, the CI being of the channel between the Type 2 device and the Type 1 device. The respective Type 2 device chooses the Type 1 device from among all Type 1 devices as its signal source based on identity (ID) or identifier of Type 1/Type 2 device, task to be performed, past signal source, history (e.g. of past signal source; Type 1 device, another Type 1 device, respective Type 2 receiver, and/or another Type 2 receiver), threshold for switching signal source, and/or information of a user, account; access info, parameter, characteristics, and/or signal strength (e.g. associated with the Type 1 device and/or the respective Type 2 receiver). Initially, the Type 1 device may be signal source of a set of initial respective Type 2 devices (i.e. the Type 1 device sends a respective signal (series of probe signals) to the set of initial respective Type 2 devices) at an initial time. Each initial respective Type 2 device chooses the Type 1 device from among all Type 1 devices as its signal source.

The signal source (Type 1 device) of a particular Type 2 device may be changed (e.g. adjusted; varied, modified) when (1) time interval between two adjacent probe signals (e.g. between current probe signal and immediate past probe signal, or between next probe signal and current probe signal) received from current signal source of the Type 2 device exceeds a first threshold; (2) signal strength associated with current signal source of the Type 2 device is below a second threshold; (3) a processed signal strength associated with current signal source of the Type 2 device is below a third threshold, the signal strength processed with low pass filter, band pass filter, median filter, moving average filter, weighted averaging filter, linear filter and/or non-linear filter; and/or (4) signal strength (or processed signal strength) associated with current signal source of the Type 2 device is below a fourth threshold for a significant percentage of a recent time window (e.g. 70%, 80%, 90%). The percentage may exceed a fifth threshold. The first, second, third, fourth and/or fifth thresholds may be time varying.

Condition (1) may occur when the Type 1 device and the Type 2 device become progressively far away from each other, such that some probe signal from the Type 1 device becomes too weak and is not received by the Type 2 device. Conditions (2)-(4) may occur when the two devices become far from each other such that the signal strength becomes very weak.

The signal source of the Type 2 device may not change if other Type 1 devices have signal strength weaker than a factor (e.g, 1, 1.1, 1.2, or 1.5) of the current signal source. If the signal source is changed (e.g. adjusted, varied, modified), the new signal source may take effect at a near future time (e.g. the respective next time). The new signal source may be the Type 1 device with strongest signal strength, and/or processed signal strength. The current and new signal source may be same/different.

A list of available Type 1 devices may be initialized and maintained by each Type 2 device. The list may be updated by examining signal strength and/or processed signal strength associated with the respective set of Type 1 devices. A Type 2 device may choose between a first series of probe signals from a first Type 1 device and a second series of probe signals from a second Type 1 device based on: respective probe signal rate, MAC addresses, channels, characteristics/properties/states, task to be performed by the Type 2 device, signal strength of first and second series, and/or another consideration.

The series of probe signals may be transmitted at a regular rate (e.g. 100 Hz). The series of probe signals may be scheduled at a regular interval (e.g. 0.01 s for 100 Hz), but each probe signal may experience small time perturbation, perhaps due to timing requirement, timing control, network control, handshaking, message passing, collision avoidance, carrier sensing, congestion, availability of resources, and/or another consideration. The rate may be changed (e.g, adjusted, varied, modified). The change may be according to a time table (e.g, changed once every hour), rule, policy, mode, condition and/or change (e.g. changed whenever some event occur). For example, the rate may normally be 100 Hz, but changed to 1000 Hz in demanding situations, and to 1 Hz in low power/standby situation. The probe signals may be sent in burst.

The probe signal rate may change based on a task performed by the Type 1 device or Type 2 device (e.g. a task may need 100 Hz normally and 1000 Hz momentarily for 20 seconds). In one example, the transmitters (Type 1 devices), receivers (Type 2 device), and associated tasks may be associated adaptively (and/or dynamically) to classes (e.g. classes that are: low-priority, high-priority, emergency, critical, regular, privileged, non-subscription, subscription, paying, and/or non-paying). A rate (of a transmitter) may be adjusted for the sake of some class (e.g. high priority class). When the need of that class changes, the rate may be changed (e.g. adjusted, varied, modified). When a receiver has critically low power, the rate may be reduced to reduce power consumption of the receiver to respond to the probe signals. In one example, probe signals may be used to transfer power wirelessly to a receiver (Type 2 device), and the rate may be adjusted to control the amount of power transferred to the receiver.

The rate may be changed by (or based on): a server (e.g. hub device), the Type 1 device and/or the Type 2 device. Control signals may be communicated between them. The server may monitor, track, forecast and/or anticipate the needs of the Type 2 device and/or the tasks performed by the Type 2 device, and may control the Type 1 device to change the rate. The server may make scheduled changes to the rate according to a time table. The server may detect an emergency situation and change the rate immediately. The server may detect a developing condition and adjust the rate gradually. The characteristics and/or STI (e.g. motion information) may be monitored individually based on a TSCI associated with a particular Type 1 device and a particular Type 2 device, and/or monitored jointly based on any TSCI associated with the particular Type 1 device and any Type 2 device, and/or monitored jointly based on any TSCI associated with the particular Type 2 device and any Type 1 device, and/or monitored globally based on any TSCI associated with any Type 1 device and any Type 2 device. Any joint monitoring may be associated with: a user, user account, profile, household, map of venue, environmental model of the venue, and/or user history, etc,

A first channel between a Type 1 device and a Type 2 device may be different from a second channel between another Type 1 device and another Type 2 device. The two channels may be associated with different frequency bands, bandwidth, carrier frequency, modulation, wireless standards, coding, encryption, payload characteristics, networks, network ID, SSID, network characteristics, network settings, and/or network parameters, etc. The two channels may be associated with different kinds of wireless system (e.g. two of the following: WiFi, LTE, LTE-A, LTE-U, 2.5G-, 3G, 3.5G, 4G, beyond 4G, 5G, 6G, 7G, a cellular network standard, UMTS, 3GPP, GSM, EDGE, TDMA, FDMA, CDMA, WCDMA, TD-SCDMA, 802.11 system, 802.15 system, 802.16 system, mesh network, Zigbee, NFC, WiMax, Bluetooth, BLE, RFID, UWB, microwave system, radar like system). For example, one is WiFi and the other is LTE. The two channels may be associated with similar kinds of wireless system, but in different network. For example, the first channel may be associated with a WiFi network named “Pizza and Pizza” in the 2.4 GHz band with a bandwidth of 20 MHz while the second may be associated with a WiFi network with SSID of “StarBud hotspot” in the 5 GHz band with a bandwidth of 40 MHz. The two channels may be different channels in same network (e.g. the “StarBud hotspot” network).

In one embodiment, a wireless monitoring system may comprise training a classifier of multiple events in a venue based on training TSCI associated with the multiple events. A CI or TSCI associated with an event may be considered/may comprise a wireless sample/characteristics/fingerprint associated with the event (and/or the venue, the environment, the object, the motion of the object, a state/emotional state/mental state/condition/stage/gesture/gait/action/movement/activity/daily activity/history/event of the object, etc.). For each of the multiple known events happening in the venue in a respective training (e.g. surveying, wireless survey, initial wireless survey) time period associated with the known event, a respective training wireless signal (e.g. a respective series of training probe signals) may be transmitted by an antenna of a first Type 1 heterogeneous wireless device using a processor, a memory and a set of instructions of the first Type 1 device to at least one first Type 2 heterogeneous wireless device through a wireless multipath channel in the venue in the respective training time period.

At least one respective time series of training CI (training TSCI) may be obtained asynchronously by each of the at least one first Type 2 device from the (respective) training signal. The CI may be CI of the channel between the first Type 2 device and the first Type 1 device in the training time period associated with the known event. The at least one training TSCI may be preprocessed. The training may be a wireless survey (e.g. during installation of Type 1 device and/or Type 2 device).

For a current event happening in the venue in a current time period, a current wireless signal (e.g. a series of current probe signals) may be transmitted by an antenna of a second Type 1 heterogeneous wireless device using a processor, a memory and a set of instructions of the second Type 1 device to at least one second Type 2 heterogeneous wireless device through the channel in the venue in the current time period associated with the current event. At least one time series of current CI (current TSCI) may be obtained asynchronously by each of the at least one second Type 2 device from the current signal (e.g. the series of current probe signals). The CI may be CI of the channel between the second Type 2 device and the second Type 1 device in the current time period associated with the current event. The at least one current TSCI may be preprocessed.

The classifier may be applied to classify at least one current TSCI obtained from the series of current probe signals by the at least one second Type 2 device, to classify at least one portion of a particular current TSCI, and/or to classify a combination of the at least one portion of the particular current TSCI and another portion of another TSCI. The classifier may partition TSCI (or the characteristics/STI or other analytics or output responses) into clusters and associate the clusters to specific events/objects/subjects/locations/movements/activities. Labels/tags may be generated for the clusters. The clusters may be stored and retrieved. The classifier may be applied to associate the current TSCI (or characteristics/STI or the other analytics/output response, perhaps associated with a current event) with: a cluster, a known/specific event, a class/category/group/grouping/list/cluster/set of known events/subjects/locations/movements/activities, an unknown event, a class/category/group/grouping/list/cluster/set of unknown events/subjects/locations/movements/activities, and/or another event/subject/location/movement/activity/class/category/group/grouping/list/cluster/set. Each TSCI may comprise at least one CI each associated with a respective timestamp. Two TSCI associated with two Type 2 devices may be different with different: starting time, duration, stopping time, amount of CI, sampling frequency, sampling period. Their CI may have different features. The first and second Type 1 devices may be at same location in the venue. They may be the same device. The at least one second Type 2 device (or their locations) may be a permutation of the at least one first Type 2 device (or their locations). A particular second Type 2 device and a particular first Type 2 device may be the same device. A subset of the first Type 2 device and a subset of the second Type 2 device may be the same. The at least one second Type 2 device and/or a subset of the at least one second Type 2 device may be a subset of the at least one first Type 2 device. The at least one first Type 2 device and/or a subset of the at least one first Type 2 device may be a permutation of a subset of the at least one second Type 2 device. The at least one second Type 2 device and/or a subset of the at least one second Type 2 device may be a permutation of a subset of the at least one first Type 2 device. The at least one second Type 2 device and/or a subset of the at least one second Type 2 device may be at same respective location as a subset of the at least one first Type 2 device. The at least one first Type 2 device and/or a subset of the at least one first Type 2 device may be at same respective location as a subset of the at least one second Type 2 device.

The antenna of the Type 1 device and the antenna of the second Type 1 device may be at same location in the venue Antenna(s) of the at least one second Type 2 device and/or antenna(s) of a subset of the at least one second Type 2 device may be at same respective location as respective antenna(s) of a subset of the at least one first Type 2 device. Antenna(s) of the at least one first Type 2 device and/or antenna(s) of a subset of the at least one first Type 2 device may be at same respective location(s as respective antenna(s) of a subset of the at least one second Type 2 device.

A first section of a first time duration of the first TSCI and a second section of a second time duration of the second section of the second TSCI may be aligned. A map between items of the first section and items of the second section may be computed. The first section may comprise a first segment (e.g. subset) of the first TSCI with a first starting/ending time, and/or another segment (e.g, subset) of a processed first TSCI. The processed first TSCI may be the first TSCI processed by a first operation. The second section may comprise a second segment (e.g. subset) of the second TSCI with a second starting time and a second ending time, and another segment (e.g. subset) of a processed second TSCI. The processed second TSCI may be the second TSCI processed by a second operation. The first operation and/or the second operation may comprise: subsampling, re-sampling, interpolation, filtering, transformation, feature extraction, pre-processing, and/or another operation.

A first item of the first section may be mapped to a second item of the second section. The first item of the first section may also be mapped to another item of the second section. Another item of the first section may also be mapped to the second item of the second section. The mapping may be one-to-one, one-to-many, many-to-one, many-to-many. At least one function of at least one of: the first item of the first section of the first TSCI, another item of the first TSCI, timestamp of the first item, time difference of the first item, time differential of the first item, neighboring timestamp of the first item, another timestamp associated with the first item, the second item of the second section of the second TSCI, another item of the second TSCI, timestamp of the second item, time difference of the second item, time differential of the second item, neighboring timestamp of the second item, and another timestamp associated with the second item, may satisfy at least one constraint.

One constraint may be that a difference between the timestamp of the first item and the timestamp of the second item may be upper-bounded by an adaptive (and/or dynamically adjusted) upper threshold and lower-bounded by an adaptive lower threshold.

The first section may be the entire first TSCI. The second section may be the entire second TSCI. The first time duration may be equal to the second time duration. A section of a time duration of a TSCI may be determined adaptively (and/or dynamically). A tentative section of the TSCI may be computed. A starting time and an ending time of a section (e.g. the tentative section, the section) may be determined. The section may be determined by removing a beginning portion and an ending portion of the tentative section. A beginning portion of a tentative section may be determined as follows. Iteratively, items of the tentative section with increasing timestamp may be considered as a current item, one item at a time.

In each iteration, at least one activity measure/index may be computed and/or considered. The at least one activity measure may be associated with at least one of: the current item associated with a current timestamp, past items of the tentative section with timestamps not larger than the current timestamp, and/or future items of the tentative section with timestamps not smaller than the current timestamp. The current item may be added to the beginning portion of the tentative section if at least one criterion (e.g. quality criterion, signal quality condition) associated with the at least one activity measure is satisfied.

The at least one criterion associated with the activity measure may comprise at least one of: (a) the activity measure is smaller than an adaptive (e.g, dynamically adjusted) upper threshold, (b) the activity measure is larger than an adaptive lower threshold, (c) the activity measure is smaller than an adaptive upper threshold consecutively for at least a predetermined amount of consecutive timestamps, (d) the activity measure is larger than an adaptive lower threshold consecutively for at least another predetermined amount of consecutive timestamps, (e) the activity measure is smaller than an adaptive upper threshold consecutively for at least a predetermined percentage of the predetermined amount of consecutive timestamps, (f) the activity measure is larger than an adaptive lower threshold consecutively for at least another predetermined percentage of the another predetermined amount of consecutive timestamps, (g) another activity measure associated with another timestamp associated with the current timestamp is smaller than another adaptive upper threshold and larger than another adaptive lower threshold, (h) at least one activity measure associated with at least one respective timestamp associated with the current timestamp is smaller than respective upper threshold and larger than respective lower threshold, (i) percentage of timestamps with associated activity measure smaller than respective upper threshold and larger than respective lower threshold in a set of timestamps associated with the current timestamp exceeds a threshold, and (j) another criterion (e.g. a quality criterion, signal quality condition).

An activity measure/index associated with an item at time T1 may comprise at least one of: (1) a first function of the item at time T1 and an item at time T1-D1, wherein D1 is a pre-determined positive quantity (e.g. a constant time offset), (2) a second function of the item at time T1 and an item at time T1+D1, (3) a third function of the item at time T1 and an item at time T2, wherein T2 is a pre-determined quantity (e.g. a fixed initial reference time; T2 may be changed (e.g. adjusted, varied, modified) over time; T2 may be updated periodically; T2 may be the beginning of a time period and T1 may be a sliding time in the time period), and (4) a fourth function of the item at time T1 and another item.

At least one of: the first function, the second function, the third function, and/or the fourth function may be a function (e.g. F(X, Y, . . . )) with at least two arguments: X and Y. The two arguments may be scalars. The function (e.g. F) may be a function of at least one of: X, Y, (X-Y), (Y-X), abs(X-Y), X\hat{ }a, Y\hat{ }b, abs(X\hat{ }a-Y\hat{ }b) (X-Y)\hat{ }a, (X-Y), (X+a)/(Y+b), (X\hat{ }Y\hat{ }b), and ((X/Y)\hat{ }a-b), wherein a and b are may be some predetermined quantities. For example, the function may simply be abs(X-Y), or (X-Y)\hat{ }2, (X-Y)\hat{ }4. The function may be a robust function. For example, the function may be (X-Y)\hat{ }2 when abs (X-Y) is less than a threshold T, and (X-Y)+a when abs(X-Y) is larger than T. Alternatively, the function may be a constant when abs(X-Y) is larger than T. The function may also be bounded by a slowly increasing function when abs(X-y) is larger than T, so that outliers cannot severely affect the result. Another example of the function may be (abs(X/Y)-a), where a=1. In this way, if X=Y (i.e. no change or no activity), the function will give a value of 0. If X is larger than Y, (X/Y) will be larger than 1 (assuming X and Y are positive) and the function will be positive. And if X is less than Y, (X/Y) will be smaller than 1 and the function will be negative. In another example, both arguments X and Y may be n-tuples such that X=(x_1, x_2, . . . x_n) and Y=(y_1, y_2, . . . , y_n). The function may be a function of at least one of: x_i, y_i), (x_i-y_i), (y_i-x_i), abs(x_i-y_i), x_i\hat{ }a, y_i\hat{ }b, abs(x_i\hat{ }a-y_i\hat{ }b), (x_i-y_i)\hat{ }a, (x_i/y_i), (x_i+a)/(y_i+b), (x_i\hat{ }a/y_i\hat{ }b), and ((x_i/y_i)\hat{ }a-b), wherein i is a component index of the n-tuple X and Y, and 1<=i<=n. E.g. component index of x_1 is i=1, component index of x_2 is i=2. The function may comprise a component-by-component summation of another function of at least one of the following: x_i, y_i, (x_i-y_i), (y_i-x_i), abs(x_i-y_i), x_i\hat{ }a, y_i\hat{ }b, abs(x_i-y_i\hat{ }b), (x_i-y_i)\hat{ }a, (x_i/y_i), (x_i+a)/(y_i+b, (x_i\hat{ }a/y_i\hat{ }b), and ((x_i/y_i)\hat{ }a-b), wherein i is the component index of the n-tuple X and Y. For example, the function may be in a form of sum_{i=1}\hat{ }n (abs(x_i/y_i)-1)/n, or sum_{i=1}\hat{ }n w_i*(abs(x_i/y_i)-1), where w_i is some weight for component i.

The map may be computed using dynamic time warping (DTW). The DTW may, comprise a constraint on at least one of: the map, the items of the first TSCI, the items of the second TSCI, the first time duration, the second time duration, the first section, and/or the second section. Suppose in the map, the i\hat{ }{th} domain item is mapped to the j\hat{ }{th} range item. The constraint may be on admissible combination of i and j (constraint on relationship between i and j). Mismatch cost between a first section of a first time duration of a first TSCI and a second section of a second time duration of a second TSCI may be computed.

The first section and the second section may be aligned such that a map comprising more than one links may be established between first items of the first TSCI and second items of the second TSCI. With each link, one of the first items with a first timestamp may be associated with one of the second items with a second timestamp. A mismatch cost between the aligned first section and the aligned second section may be computed. The mismatch cost may comprise a function of: an item-wise cost between a first item and a second item associated by a particular link of the map, and a link-wise cost associated with the particular link of the map.

The aligned first section and the aligned second section may be represented respectively as a first vector and a second vector of same vector length. The mismatch cost may comprise at least one of: an inner product, inner-product-like quantity, quantity based on correlation, correlation indicator, quantity based on covariance, discriminating score, distance, Euclidean distance, absolute distance, Lk distance (e.g. L1, L2, . . . ), weighted distance, distance-like quantity and/or another similarity value, between the first vector and the second vector. The mismatch cost may be normalized by the respective vector length.

A parameter derived from the mismatch cost between the first section of the first time duration of the first TSCI and the second section of the second time duration of the second TSCI may be modeled with a statistical distribution. At least one of: a scale parameter, location parameter and/or another parameter, of the statistical distribution may be estimated. The first section of the first time duration of the first TSCI may be a sliding section of the first TSCI. The second section of the second time duration of the second TSCI may be a sliding section of the second TSCI. A first sliding window may be applied to the first TSCI and a corresponding second sliding window may be applied to the second TSCI. The first sliding window of the first TSCI and the corresponding second sliding window of the second TSCI may be aligned.

Mismatch cost between the aligned first sliding window of the first TSCI and the corresponding aligned second sliding window of the second TSCI may be computed. The current event may be associated with at least one of: the known event, the unknown event and/or the another event, based on the mismatch cost.

The classifier may be applied to at least one of: each first section of the first time duration of the first TSCI, and/or each second section of the second time duration of the second TSCI, to obtain at least one tentative classification results. Each tentative classification result may be associated with a respective first section and a respective second section.

The current event may be associated with at least one of: the known event, the unknown event, a class/category/group/grouping/list/set of unknown events, and/or the another event, based on the mismatch cost. The current event may be associated with at least one of: the known event, the unknown event and/or the another event, based on a largest number of tentative classification results in more than one sections of the first TSCI and corresponding more than sections of the second TSCI. For example, the current event may be associated with a particular known event if the mismatch cost points to the particular known event for N consecutive times (e.g. N=10). In another example, the current event may be associated with a particular known event if the percentage of mismatch cost within the immediate past N consecutive N pointing to the particular known event exceeds a certain threshold (e.g. >80%). In another example, the current event may be associated with a known event that achieves smallest mismatch cost for the most times within a time period. The current event may be associated with a known event that achieves smallest overall mismatch cost, which is a weighted average of at least one mismatch cost associated with the at least one first sections. The current event may be associated with a particular known event that achieves smallest of another overall cost. The current event may be associated with the “unknown event” if none of the known events achieve mismatch cost lower than a first threshold T1 in a sufficient percentage of the at least one first section. The current event may also be associated with the “unknown event” if none of the events achieve an overall mismatch cost lower than a second threshold T2. The current event may be associated with at least one of: the known event, the unknown event and/or the another event, based on the mismatch cost and additional mismatch cost associated with at least one additional section of the first TSCI and at least one additional section of the second TSCI. The known events may comprise at least one of: a door closed event, door open event, window closed event, window open event, multi-state event, on-state event, off-state event, intermediate state event, continuous state event, discrete state event, human-present event, human-absent event, sign-of-life-present event, and/or a sign-of-life-absent event.

A projection for each CI may be trained using a dimension reduction method based on the training TSCI. The dimension reduction method may comprise at least one of: principal component analysis (PCA), PCA with different kernel, independent component analysis (ICA), Fisher linear discriminant, vector quantization, supervised learning, unsupervised learning, self-organizing maps, auto-encoder, neural network, deep neural network, and/or another method. The projection may be applied to at least one of: the training TSCI associated with the at least one event, and/or the current TSCI, for the classifier. The classifier of the at least one event may be trained based on the projection and the training TSCI associated with the at least one event. The at least one current TSCI may be classified/categorized based on the projection and the current TSCI. The projection may be re-trained using at least one of: the dimension reduction method, and another dimension reduction method, based on at least one of: the training TSCI, at least one current TSCI before retraining the projection, and/or additional training TSCI. The another dimension reduction method may comprise at least one of: principal component analysis (PCA), PCA with different kernels, independent component analysis (ICA), Fisher linear discriminant, vector quantization, supervised learning, unsupervised learning, self-organizing maps, auto-encoder, neural network, deep neural network, and/or yet another method. The classifier of the at least one event may be re-trained based on at least one of: the re-trained projection, the training TSCI associated with the at least one events, and/or at least one current TSCI. The at least one current TSCI may be classified based on: the re-trained projection, the re-trained classifier, and/or the current TSCI:.

Each CI may comprise a vector of complex values. Each complex value may be preprocessed to give the magnitude of the complex value. Each CI may be preprocessed to give a vector of non-negative real numbers comprising the magnitude of corresponding complex values. Each training TSCI may be weighted in the training of the projection. The projection may comprise more than one projected components. The projection may comprise at least one most significant projected component. The projection may comprise at least one projected component that may be beneficial for the classifier.

The channel information (CI) may be associated with/may comprise signal strength, signal amplitude, signal phase, spectral power measurement, modem parameters (e.g. used in relation to modulation/demodulation in digital communication systems such as WiFi, 4G/LTE), dynamic beamforming, information, transfer function components, radio state (e.g. used in digital communication systems to decode digital data, baseband processing state, RF processing state, etc.), measurable variables, sensed data, coarse-grained/fine-grained information of a layer (e.g. physical layer, data link layer, MAC layer, etc.), digital setting, gain setting, RE filter setting, RF front end switch setting, DC offset setting, DC correction setting, IQ compensation setting, effect(s) on the wireless signal by the environment (e.g. venue) during propagation, transformation of an input signal (the wireless signal transmitted by the Type 1 device) to an output signal (the wireless signal received by the Type 2 device), a stable behavior of the environment, a state profile, wireless channel measurements, received signal strength indicator (RSSI), channel state information (CSI), channel impulse response (CTR), channel frequency response (CFR), characteristics of frequency components (e.g. subcarriers) in a bandwidth, channel characteristics, channel filter response, timestamp, auxiliary information, data, meta data, user data, account data, access data, security data, session data, status data, supervisory data, household data, identity (ID), identifier, device data, network data, neighborhood data, environment data, real-time data, sensor data, stored data, encrypted data, compressed data, protected data, and/or another channel information. Each CI may be associated with a time stamp, and/or an arrival time. A CSI can be used to equalize/undo/minimize/reduce the multipath channel effect (of the transmission channel) to demodulate a signal similar to the one transmitted by the transmitter through the multipath channel. The CI may be associated with information associated with a frequency band, frequency signature, frequency phase, frequency amplitude, frequency trend, frequency characteristics, frequency-like characteristics, time domain element, frequency domain element, time-frequency domain element, orthogonal decomposition characteristics, and/or non-orthogonal decomposition characteristics of the signal through the channel. The TSCI may be a stream of wireless signals (e.g. CI).

The CI may be preprocessed, processed, postprocessed, stored (e.g. in local memory, portable/mobile memory, removable memory, storage network, cloud memory, in a volatile manner, in a non-volatile manner), retrieved, transmitted and/or received. One or more modem parameters and/or radio state parameters may be held constant. The modem parameters may be applied to a radio subsystem. The modem parameters may represent a radio state. A motion detection signal (e.g. baseband signal, and/or packet decoded/demodulated from the baseband signal, etc.) may be obtained by processing (e.g. down-converting) the first wireless signal (e.g. RF/WiFi/LTE/5G signal) by the radio subsystem using the radio state represented by the stored modem parameters. The modem parameters/radio state may be updated (e.g. using previous modem parameters or previous radio state). Both the previous and updated modem parameters/radio states may be applied in the radio subsystem in the digital communication system. Both the previous and updated modem parameters/radio states may be compared/analyzed/processed/monitored in the task.

The channel information may also be modem parameters (e.g. stored or freshly computed) used to process the wireless signal. The wireless signal may comprise a plurality of probe signals. The same modem parameters may be used to process more than one probe signals. The same modern parameters may also be used to process more than one wireless signals. The modem parameters may comprise parameters that indicate settings or an overall configuration for the operation of a radio subsystem or a baseband subsystem of a wireless sensor device (or both). The modem parameters may include one or more of: a gain setting, an RF filter setting, an RF front end switch setting, a DC offset setting, or an IQ compensation setting for a radio subsystem, or a digital DC correction setting, a digital gain setting, and/or a digital filtering setting (e.g. for a baseband subsystem). The CI may also be associated with information associated with a time period, time signature, timestamp, time amplitude, time phase, time trend, and/or time characteristics of the signal. The CI may be associated with information associated with a time-frequency partition, signature, amplitude, phase, trend, and/or characteristics of the signal. The CI may be associated with a decomposition of the signal. The CI may be associated with information associated with a direction, angle of arrival (AoA), angle of a directional antenna, and/or a phase of the signal through the channel. The CI may be associated with attenuation patterns of the signal through the channel. Each CI may be associated with a Type 1 device and a Type 2 device. Each CI may be associated with an antenna of the Type 1 device and an antenna of the Type 2 device.

The CI may be obtained from a communication hardware (e.g. of Type 2 device, or Type 1 device) that is capable of providing the CI. The communication hardware may be a WiFi-capable chip/IC (integrated circuit), chip compliant with a 802.11 or 802.16 or another wireless/radio standard, next generation WiFi-capable chip, LTE-capable chip, 5G-capable chip, 6G/7G/8G-capable chip, Bluetooth-enabled chip, NFC (near field communication)-enabled chip, BLE (Bluetooth low power)-enabled chip, UWB chip, another communication chip (e.g. Zigbee, WiMax, mesh network), etc. The communication hardware computes the CI and stores the CI in a buffer memory and make the CI available for extraction. The CI may comprise data and/or at least one matrices related to channel state information (CSI). The at least one matrices may be used for channel equalization, and/or beam forming, etc. The channel may be associated with a venue. The attenuation may be due to signal propagation in the venue, signal propagating/reflection/refraction/diffraction through/at/around air (e.g. air of venue), refraction medium/reflection surface such as wall, doors, furniture, obstacles and/or barriers, etc. The attenuation may be due to reflection at surfaces and obstacles (e.g. reflection surface, obstacle) such as floor, ceiling, furniture, fixtures, objects, people, pets, etc. Each CI may be associated with a timestamp, Each CI may comprise N1 components (e.g. N1 frequency domain components in CFR, N1 time domain components in CM, or N1 decomposition components). Each component may be associated with a component index. Each component may be a real, imaginary, or complex quantity, magnitude, phase, flag, and/or set. Each CI may comprise a vector or matrix of complex numbers, a set of mixed quantities, and/or a multi-dimensional collection of at least one complex numbers.

Components of a TSCI associated with a particular component index may form a respective component time series associated with the respective index, A TSCI may be divided into N1 component time series. Each respective component time series is associated with a respective component index. The characteristics/STI of the motion of the object may be monitored based on the component time series. In one example, one or more ranges of CI components (e.g. one range being from component 11 to component 23, a second range being from component 44 to component 50, and a third range having only one component) may be selected based on some criteria/cost function/signal quality metric (e.g. based on signal-to-noise ratio, and/or interference level) for further processing.

A component-wise characteristic of a component-feature time series of a TSCI may be computed. The component-wise characteristics may be a scalar (e.g. energy) or a function with a domain and a range (e.g. an autocorrelation function, transform, inverse transform). The characteristics/STI of the motion of the object may be monitored based on the component-wise characteristics. A total characteristics (e.g. aggregate characteristics) of the TSCI may be computed based on the component-wise characteristics of each component time series of the TSCI. The total characteristics may be a weighted average of the component-wise characteristics. The characteristics/STI of the motion of the object may be monitored based on the total characteristics. An aggregate quantity may be a weighted average of individual quantities.

The Type 1 device and Type 2 device may support WiFi, WiMax, 3G/beyond 3G, 4G/beyond 4G, LTE, LTE-A, 5G, 6G, 7G, Bluetooth, NFC, BLE, Zigbee, UWB, UMTS, 3GPP, GSM, EDGE, TDMA, FDMA, CDMA, WCDMA, TD-SCDMA, mesh network, proprietary wireless system, IEEE 802.11 standard, 802.15 standard, 802.16 standard, 3GPP standard, and/or another wireless system.

A common wireless system and/or a common wireless channel may be shared by the Type 1 transceiver and/or the at least one Type 2 transceiver. The at least one Type 2 transceiver may transmit respective signal contemporaneously (or: asynchronously, synchronously, sporadically, continuously, repeatedly, concurrently, simultaneously and/or temporarily) using the common wireless system and/or the common wireless channel. The Type 1 transceiver may transmit a signal to the at least one Type 2 transceiver using the common wireless system and/or the common wireless channel.

Each Type 1 device and Type 2 device may have at least one transmitting/receiving antenna. Each CI may be associated with one of the transmitting antenna of the Type 1 device and one of the receiving antenna of the Type 2 device. Each pair of a transmitting antenna and a receiving antenna may be associated with a link, a path, a communication path, signal hardware path, etc. For example, if the Type 1 device has M (e.g. 3) transmitting antennas, and the Type 2 device has N (e.g. 2) receiving antennas, there may be M×N (e.g. 3×2=6) links or paths. Each link or path may be associated with a TSCI.

The at least one TSCI may correspond to various antenna pairs between the Type 1 device and the Type 2 device. The Type 1 device may have at least one antenna. The Type 2 device may also have at least one antenna. Each TSCI may be associated with an antenna of the Type 1 device and an antenna of the Type 2 device. Averaging or weighted averaging over antenna links may be performed. The averaging or weighted averaging may be over the at least one TSCI. The averaging may optionally be performed on a subset of the at least one TSCI corresponding to a subset of the antenna pairs.

Timestamps of CI of a portion of a TSCI may be irregular and may be corrected so that corrected timestamps of time-corrected CI may be uniformly spaced in time. In the case of multiple Type 1 devices and/or multiple Type 2 devices, the corrected timestamp may be with respect to the same or different clock. An original timestamp associated with each of the CI may be determined. The original timestamp may not be uniformly spaced in time. Original timestamps of all CI of the particular portion of the particular TSCI in the current sliding time window may be corrected so that corrected timestamps of time-corrected CI may be uniformly spaced in time.

The characteristics and/or STI (e.g. motion information) may comprise: location, location coordinate, change in location, position (e.g. initial position, new position), position on map, height, horizontal location, vertical location, distance, displacement, speed, acceleration, rotational speed, rotational acceleration, direction, angle of motion, azimuth, direction of motion, rotation, path, deformation, transformation, shrinking, expanding, gait, gait cycle, head motion, repeated motion, periodic motion, pseudo-periodic motion, impulsive motion, sudden motion, fall-down motion, transient motion, behavior, transient behavior, period of motion, frequency of motion, time trend, temporal profile, temporal characteristics, occurrence, change, temporal change, change of CI, change in frequency, change in timing, change of gait cycle, timing, starting time, initiating time, ending time, duration, history of motion, motion type, motion classification, frequency, frequency spectrum, frequency characteristics, presence, absence, proximity, approaching, receding, identity/identifier of the object, composition of the object, head motion rate, head motion direction, mouth-related rate, eye-related rate, breathing rate, heart rate, tidal volume, depth of breath, inhale time, exhale time, inhale time to exhale time ratio, airflow rate, heart heat-to-beat interval, heart rate variability, hand motion rate, hand motion direction, leg motion, body motion, walking rate, hand motion rate, positional characteristics, characteristics associated with movement (e.g. change in position/location) of the object, tool motion, machine motion, complex motion, and/or combination of multiple motions, event, signal statistics, signal dynamics, anomaly, motion statistics, motion parameter, indication of motion detection, motion magnitude, motion phase, similarity score, distance score, Euclidean distance, weighted distance, L_1 norm, L_2 norm, L_k norm for k>2, statistical distance, correlation, correlation indicator, auto-correlation, covariance, auto-covariance, cross-covariance, inner product, outer product, motion signal transformation, motion feature, presence of motion, absence of motion, motion localization, motion identification, motion recognition, presence of object, absence of object, entrance of object, exit of object, a change of object, motion cycle, motion count, gait cycle, motion rhythm, deformation motion, gesture, handwriting, head motion, mouth motion, heart motion, internal organ motion, motion trend, size, length, area, volume, capacity, shape, form, tag, starting/initiating location, ending location, starting/initiating quantity, ending quantity, event, fall-down event, security event, accident event, home event, office event, factory event, warehouse event, manufacturing event, assembly line event, maintenance event, car-related event, navigation event, tracking event, door event, door-open event, door-close event, window event, window-open event, window-close event, repeatable event, one-time event, consumed quantity, unconsumed quantity, state, physical state, health state, well-being state, emotional state, mental state, another event, analytics, output responses, and/or another information. The characteristics and/or STI may be computed/monitored based on a feature computed from a CI or a TSCI (e.g. feature computation/extraction). A static segment or profile (and/or a dynamic segment/profile) may be identified/computed/analyzed/monitored/extracted/obtained/marked/presented/indicated/highlighted/stored/communicated based on an analysis of the feature. The analysis may comprise a motion detection/movement assessment/presence detection. Computational workload may be shared among the Type 1 device, the Type 2 device and another processor.

The Type 1 device and/or Type 2 device may be a local device. The local device may be: a smart phone, smart device, TV, sound bar, set-top box, access point, router, repeater, wireless signal repeater/extender, remote control, speaker, fan, refrigerator, microwave, oven, coffee machine, hot water pot, utensil, table, chair, light, lamp, door lock, camera, microphone, motion sensor, security device, fire hydrant, garage door, switch, power adapter, computer, dongle, computer peripheral, electronic pad, sofa, tile, accessory, home device, vehicle device, office device, building device, manufacturing device, watch, glasses, clock, television, oven, air-conditioner, accessory, utility, appliance, smart machine, smart vehicle, internet-of-thing (IoT) device, internet-enabled device, computer, portable computer, tablet, smart house, smart office, smart building, smart parking lot, smart system, and/or another device.

Each Type 1 device may be associated with a respective identifier (e.g. ID). Each Type 2 device may also be associated with a respective identify (ID). The ID may comprise: numeral, combination of text and numbers, name, password, account, account ID, web link, web address, index to some information, and/or another ID. The ID may be assigned. The ID may be assigned by hardware (e.g, hardwired, via dongle and/or other hardware), software and/or firmware. The ID may be stored (e.g. in database, in memory, in server (e.g. hub device), in the cloud, stored locally, stored remotely, stored permanently, stored temporarily) and may be retrieved. The ID may be associated with at least one record, account, user, household, address, phone number, social security number, customer number, another ID, another identifier, timestamp, and/or collection of data. The ID and/or part of the ID of a Type 1 device may be made available to a Type 2 device. The ID may be used for registration, initialization, communication, identification, verification, detection, recognition, authentication, access control, cloud access, networking, social networking, logging, recording, cataloging, classification, tagging, association, pairing, transaction, electronic transaction, and/or intellectual property control, by the Type 1 device and/or the Type 2 device.

The object may be person, user, subject, passenger, child, older person, baby, sleeping baby, baby in vehicle, patient, worker, high-value worker, expert, specialist, waiter, customer in mall, traveler in airport/train station/bus terminal/shipping terminals, staff/worker/customer service personnel in factory/mall/supermarket/office/workplace, serviceman in sewage/air ventilation system/lift well, lifts in lift wells, elevator, inmate, people to be tracked/monitored, animal, plant, living object, pet, dog, cat, smart phone, phone accessory, computer, tablet, portable computer, dongle, computing accessory, networked devices, WiFi devices, IoT devices, smart watch, smart glasses, smart devices, speaker, keys, smart key, wallet, purse, handbag, backpack, goods, cargo, luggage, equipment, motor, machine, air conditioner, fan, air conditioning equipment, light fixture, moveable light, television, camera, audio and/or video equipment, stationary, surveillance equipment, parts, signage, tool, cart, ticket, parking ticket, toll ticket, airplane ticket, credit card, plastic card, access card, food packaging, utensil, table, chair, cleaning equipment/tool, vehicle, car, cars in parking facilities, merchandise in warehouse/store/supermarket/distribution center, boat, bicycle, airplane, drone, remote control car/plane/boat, robot, manufacturing device, assembly line, material/unfinished part/robot/wagon/transports on factory floor, object to be tracked in airport/shopping mart/supermarket, non-object, absence of an object, presence of an object, object with form, object with changing form, object with no form, mass of fluid, mass of liquid, mass of gas/smoke, fire, flame, electromagnetic (EM) source, EM medium, and/or another object. The object itself may be communicatively coupled with some network, such as WiFi, MiFi, 3G/4G/LTE/5G/6G/7G, Bluetooth, NFC, BLE, WiMax, Zigbee, UMTS, 3GPP, GSM, EDGE, TDMA, FDMA, CDMA, WCDMA, TD-SCDMA, mesh network, adhoc network, and/or other network. The object itself may be bulky with AC power supply, but is moved during installation, cleaning, maintenance, renovation, etc. It may also be installed in moveable platform such as lift, pad; movable, platform, elevator, conveyor belt, robot, drone, forklift, car, boat, vehicle, etc. The object may have multiple parts, each part with different movement (e.g, change in position/location), For example, the object may be a person walking forward. While walking, his left hand and right hand may move in different direction, with different instantaneous speed, acceleration, motion, etc.

The wireless transmitter (e.g. Type 1 device), the wireless receiver (e.g. Type 2 device), another wireless transmitter and/or another wireless receiver may move with the object and/or another object (e.g. in prior movement, current movement and/or future movement. They may be communicatively coupled to one or more nearby device. They may transmit TSCI and/or information associated with the TSCI to the nearby device, and/or each other. They may be with the nearby device. The wireless transmitter and/or the wireless receiver may be part of a small (e.g. coin-size, cigarette box size, or even smaller), light-weight portable device. The portable device may be wirelessly coupled with a nearby device.

The nearby device may be smart phone, iPhone, Android phone, smart device, smart appliance, smart vehicle, smart gadget, smart TV, smart refrigerator, smart speaker, smart watch, smart glasses, smart pad, iPad, computer, wearable computer, notebook computer, gateway. The nearby device may be connected to a cloud server, local server (e.g. hub device) and/or other server via internet, wired internet connection and/or wireless internet connection. The nearby, device may be portable. The portable device, the nearby device, a local server (e.g. hub device) and/or a cloud server may share the computation and/or storage for a task (e.g. obtain TSCI, determine characteristics/STI of the object associated with the movement (e.g. change in position/location) of the object, computation of time series of power (e.g. signal strength) information, determining/computing the particular function, searching for local extremum, classification, identifying particular value of time offset, de-noising, processing, simplification, cleaning, wireless smart sensing task, extract CI from signal, switching, segmentation, estimate trajectory/path/track, process the map, processing trajectory/path/track based on environment models/constraints/limitations, correction, corrective adjustment, adjustment, map-based (or model-based) correction, detecting error, checking for boundary hitting, thresholding) and information (e.g. TSCI). The nearby device may/may not move with the object. The nearby device may be portable/not portable/moveable/non-moveable. The nearby device may use battery power, solar power, AC power and/or other power source. The nearby device may have replaceable/non-replaceable battery, and/or rechargeable/non-rechargeable battery. The nearby device may be similar to the object. The nearby device may have identical (and/or similar) hardware and/or software to the object. The nearby device may be a smart device, network enabled device, device with connection to WiFi/3G/4G/5G/6G/Zigbee/Bluetooth/NFC/UMTS/3GPP/GSM/EDGE/TDMA/FDMA/CDMA/WCDMA/TD-SCDMA/adhoc network/other network, smart speaker, smart watch, smart clock, smart appliance, smart machine, smart equipment, smart tool, smart vehicle, internet-of-thing (IoT) device, Internet-enabled device, computer, portable computer, tablet, and another device. The nearby device and/or at least one processor associated with the wireless receiver, the wireless transmitter, the another wireless receiver, the another wireless transmitter and/or a cloud server (in the cloud) may determine the initial STI of the object. Two or more of them may determine the initial spatial-temporal info jointly. Two or more of them may share intermediate information in the determination of the initial STI (e.g. initial position).

In one example, the wireless transmitter (e.g. Type 1 device, or Tracker Bot) may move with the object. The wireless transmitter may send the signal to the wireless receiver (e.g. Type 2 device, or Origin Register) or determining the initial STI (e.g. initial position) of the object. The wireless transmitter may also send the signal and/or another signal to another wireless receiver (e.g. another Type 2 device, or another Origin Register) for the monitoring of the motion (spatial-temporal info) of the object. The wireless receiver may also receive the signal and/or another signal from the wireless transmitter and/or the another wireless transmitter for monitoring the motion of the object. The location of the wireless receiver and/or the another wireless receiver may be known. In another example, the wireless receiver (e.g. Type 2 device, or Tracker Bot) may move with the object. The wireless receiver may receive the signal transmitted from the wireless transmitter (e.g. Type 1 device, or Origin Register) for determining the initial spatial-temporal info (e.g. initial position) of the object. The wireless receiver may also receive the signal and/or another signal from another wireless transmitter (e.g. another Type 1 device, or another Origin Register) for the monitoring of the current motion (e.g. spatial-temporal info) of the object. The wireless transmitter may also transmit the signal and/or another signal to the wireless receiver and/or the another wireless receiver (e.g. another Type 2 device, or another Tracker Bot) for monitoring the motion of the object. The location of the wireless transmitter and/or the another wireless transmitter may be known.

The venue may be a space such as a sensing area, room, house, office, property, workplace, hallway, walkway, lift, lift well, escalator, elevator, sewage system, air ventilations system, staircase, gathering area, duct, air duct, pipe, tube, enclosed space, enclosed structure, semi-enclosed structure, enclosed area, area with at least one wall, plant, machine, engine, structure with wood, structure with glass, structure with metal, structure with walls, structure with doors, structure with gaps, structure with reflection surface, structure with fluid, building, roof top, store, factory, assembly line, hotel room, museum, classroom, school, university, government building, warehouse, garage, mall, airport, train station, bus terminal, hub, transportation hub, shipping terminal, government facility, public facility, school, university, entertainment facility, recreational facility, hospital, pediatric/neonatal wards, seniors home, elderly care facility, geriatric facility, community center, stadium, playground, park, field, sports facility, swimming facility, track and/or field, basketball court, tennis court, soccer stadium, baseball stadium, gymnasium, hall, garage, shopping mart, mall, supermarket, manufacturing facility, parking facility, construction site, mining facility, transportation facility, highway, road, valley, forest, wood, terrain, landscape, den, patio, land, path, amusement park, urban area, rural area, suburban area, metropolitan area, garden, square, plaza, music hall, downtown facility, over-air facility, semi-open facility, closed area, train platform, train station, distribution center, warehouse, store, distribution center, storage facility, underground facility, space (e.g. above ground, outer-space) facility, floating facility, cavern, tunnel facility, indoor facility, open-air facility, outdoor facility with some walls/doors/reflective barriers, open facility, semi-open facility, car, truck, bus, van, container, ship/boat, submersible, train, tram, airplane, vehicle, mobile home, cave, tunnel, pipe, channel, metropolitan area, downtown area with relatively tall buildings, valley, well, duct, pathway, gas line, oil line, water pipe, network of interconnecting pathways/alleys/roads/tubes/cavities/caves/pipe-like structure/air space/fluid space, human body, animal body, body cavity, organ, bone, teeth, soft tissue, hard tissue, rigid tissue, non-rigid tissue, blood/body fluid vessel, windpipe, air duct, den, etc. The venue may be indoor space, outdoor space. The venue may include both the inside and outside of the space. For example, the venue may include both the inside of a building and the outside of the building. For example, the venue can be a building that has one floor or multiple floors, and a portion of the building can be underground. The shape of the building can be, e.g., round, square, rectangular, triangle, or irregular-shaped. These are merely examples. The disclosure can be used to detect events in other types of venue or spaces.

The wireless transmitter (e.g. Type 1 device) and/or the wireless receiver (e.g. Type 2 device) may be embedded in a portable device (e.g. a module, or a device with the module) that may move with the object (e.g. in prior movement and/or current movement). The portable device may be communicatively coupled with the object using a wired connection (e.g. through USB, microUSB, Firewire, serial port, parallel port, and other connectors) and/or a connection (e.g. Bluetooth, Bluetooth Low Energy (BLE), WiFi, LTE, NFC, ZigBee). The portable device may be a lightweight device. The portable may be powered by battery, rechargeable battery and/or AC power. The portable device may be very small (e.g. at sub-millimeter scale and/or sub-centimeter scale), and/or small (e.g. coin-size, card-size, pocket-size, or larger). The portable device may be large, sizable, and/or bulky (e.g. heavy machinery to be installed). The portable device may be a WiFi hotspot, access point, mobile WiFi (MiFi), dongle with USB/micro USB/Firewire/other connector, smartphone, portable computer, computer, tablet, smart device, internet-of-thing (IoT) device, WiFi-enabled device, LTE-enabled device, a smart watch, smart glass, smart mirror, smart antenna, smart battery, smart light, smart pen, smart ring, smart door, smart window, smart clock, small battery, smart wallet, smart belt, smart handbag, smart clothing/garment, smart ornament, smart packaging, smart paper/book/magazine/poster/printed matter/signage/display/lighted system/lighting system, smart key/tool, smart bracelet/chain/necklace/wearable/accessory, smart pad/cushion, smart tile/block/brick/building material/other material, smart garbage can/waste container, smart food carriage/storage, smart ball/racket, smart chair/sofa/bed, smart shoe/footwear/carpet/mat/shoe rack, smart glove/hand wear/ring/hand ware, smart hat/headwear/makeup/sticker/tattoo, smart mirror, smart toy, smart pill, smart utensil, smart bottle/food container, smart tool, smart device, IoT device, WiFi enabled device, network enabled device, 3G/4G/5G/6G enabled device, UMTS devices, 3GPP devices, GSM devices, EDGE devices, TDMA devices, TDMA devices, CDMA devices, WCDMA devices, TD-SCDMA devices, embeddable device, implantable device, air conditioner, refrigerator, heater, furnace, furniture, oven, cooking device, television/set-top box (STB)/DVD player/audio player/video player/remote control, hi-fi, audio device, speaker, lamp/light, wall, door, window, roof, roof tile/shingle/structure/attic structure/device/feature/installation/fixtures, lawn mower/garden tools/yard tools/mechanics tools/garage tools/, garbage can/container, 20-ft/40-ft container, storage container, factory/manufacturing/production device, repair tools, fluid container, machine, machinery to be installed, vehicle, cart, wagon, warehouse vehicle, car, bicycle, motorcycle, boat, vessel, airplane, basket/box/bag/bucket/container, smart plate/cup/bowl/pot/mat/utensils/kitchen tools/kitchen devices/kitchen accessories/cabinets/tables/chairs/tiles/lights/water pipes/taps/gas range/oven/dishwashing machine/etc. The portable device may have a battery that may be replaceable, irreplaceable, rechargeable, and/or non-rechargeable. The portable device may be wirelessly charged. The portable device may be a smart payment card. The portable device may be a payment card used in parking lots, highways, entertainment parks, or other venues/facilities that need payment. The portable device may have an identity (1D)/identifier as described above.

An event may be monitored based on the TSCI. The event may be an object related event, such as fall-down of the object (e.g. an person and/or a sick person), rotation, hesitation, pause, impact (e.g. a person hitting a sandbag, door, window, bed, chair, table, desk, cabinet, box, another person, animal, bird, fly, table, chair, ball, bowling ball, tennis ball, football, soccer ball, baseball, basketball, volley ball), two-body action (e.g. a person letting go a balloon, catching a fish, molding a clay, writing a paper, person typing on a computer), car moving in a garage, person carrying a smart phone and walking around an airport/mall/government building/office/etc., autonomous moveable object/machine moving around (e.g. vacuum cleaner, utility vehicle, car, drone, self-driving car). The task or the wireless smart sensing task may comprise: object detection, presence detection, proximity detection, object recognition, activity recognition, object verification, object counting, daily activity monitoring, well-being monitoring, vital sign monitoring, health condition monitoring, baby monitoring, elderly monitoring, sleep monitoring, sleep stage monitoring, walking monitoring, exercise monitoring, tool detection, tool recognition, tool verification, patient detection, patient monitoring, patient verification, machine detection, machine recognition, machine verification, human detection, human recognition, human verification, baby detection, baby recognition, baby verification, human breathing detection, human breathing recognition, human breathing estimation, human breathing verification, human heart beat detection, human heart beat recognition, human heart beat estimation, human heart beat verification, fall-down detection, fall-down recognition, fall-down estimation, hill-down verification, emotion detection, emotion recognition, emotion estimation, emotion verification, motion detection, motion degree estimation, motion recognition, motion estimation, motion verification, periodic motion detection, periodic motion recognition, periodic motion estimation, periodic motion verification, repeated motion detection, repeated motion recognition, repeated motion estimation, repeated motion verification, stationary motion detection, stationary motion recognition, stationary motion estimation, stationary motion verification, cyclo-stationary motion detection, cyclo-stationary motion recognition, cyclo-stationary motion estimation, cyclo-stationary motion verification, transient motion detection, transient motion recognition, transient motion estimation, transient motion verification, trend detection, trend recognition, trend estimation, trend verification, breathing detection, breathing recognition, breathing estimation, breathing estimation, human biometrics detection, human biometric recognition, human biometrics estimation, human biometrics verification, environment informatics detection, environment informatics recognition, environment informatics estimation, environment informatics verification, gait detection, gait recognition, gait estimation, gait verification, gesture detection, gesture recognition, gesture estimation, gesture verification, machine learning, supervised learning, unsupervised learning, semi-supervised learning, clustering, feature extraction, featuring training, principal component analysis, eigen-decomposition, frequency decomposition, time decomposition, time-frequency decomposition, functional decomposition, other decomposition, training, discriminative training, supervised training, unsupervised training, semi-supervised training, neural network, sudden motion detection, fall-down detection, danger detection, life-threat detection, regular motion detection, stationary motion detection, cyclo-stationary motion detection, intrusion detection, suspicious motion detection, security, safety monitoring, navigation, guidance, map-based processing, map-based correction, model-based processing/correction, irregularity detection, locationing, room sensing, tracking, multiple object tracking, indoor tracking, indoor position, indoor navigation, energy management, power transfer, wireless power transfer, object counting, car tracking in parking garage, activating a device/system (e.g. security system, access system, alarm, siren, speaker, television, entertaining system, camera, heater/air-conditioning (HVAC) system, ventilation system, lighting system, gaming system, coffee machine, cooking device, cleaning device, housekeeping device), geometry estimation, augmented reality, wireless communication, data communication, signal broadcasting, networking, coordination, administration, encryption, protection, cloud computing, other processing and/or other task. The task may be performed by the Type 1 device, the Type 2 device, another Type 1 device, another Type 2 device, a nearby device, a local server (e.g. hub device), edge server, a cloud server, and/or another device. The task may be based on TSCI between any pair of Type 1 device and Type 2 device. A Type 2 device may be a Type 1 device, and vice versa. A Type 2 device may play/perform the role (e.g. functionality) of Type 1 device temporarily, continuously, sporadically, simultaneously, and/or contemporaneously, and vice versa. A first part of the task may comprise at least one of: preprocessing, processing, signal conditioning, signal processing, post-processing, processing sporadically/continuously/simultaneously/contemporaneously/dynamically/adaptive/on-demand/as-needed, calibrating, denoising, feature extraction, coding, encryption, transformation, mapping, motion detection, motion estimation, motion change detection, motion pattern detection, motion pattern estimation, motion pattern recognition, vital sign detection, vital sign estimation, vital sign recognition, periodic motion detection, periodic motion estimation, repeated motion detection/estimation, breathing rate detection, breathing rate estimation, breathing pattern detection, breathing pattern estimation, breathing pattern recognition, heart beat detection, heart beat estimation, heart pattern detection, heart pattern estimation, heart pattern recognition, gesture detection, gesture estimation, gesture recognition, speed detection, speed estimation, object locationing, object tracking, navigation, acceleration estimation, acceleration detection, fall-down detection, change detection, intruder (and/or illegal action) detection, baby detection, baby monitoring, patient monitoring, object recognition, wireless power transfer, and/or wireless charging.

A second part of the task may comprise at least one of: a smart home task, smart office task, smart building task, smart factory task (e.g. manufacturing using a machine or an assembly line), smart internet-of-thing (IoT) task, smart system task, smart home operation, smart office operation, smart building operation, smart manufacturing operation (e.g. moving supplies/parts/raw material to a machine/an assembly line), IoT operation, smart system operation, turning on a light, turning off the light, controlling the light in at least one of: a room, region, and/or the venue, playing a sound clip, playing the sound clip in at least one of: the room, the region, and/or the venue, playing the sound clip of at least one of: a welcome, greeting, farewell, first message, and/or a second message associated with the first part of the task, turning on an appliance, turning off the appliance, controlling the appliance in at least one of: the room, the region, and/or the venue, turning on an electrical system, turning off the electrical system, controlling the electrical system in at least one of: the room, the region, and/or the venue, turning on a security system, turning off the security system, controlling the security system in at least one of: the room, the region, and/or the venue, turning on a mechanical system, turning off a mechanical system, controlling the mechanical system in at least one of: the room, the region, and/or the venue, and/or controlling at least one of: an air conditioning system, heating system, ventilation system, lighting system, heating device, stove, entertainment system, door, fence, window, garage, computer system, networked device, networked system, home appliance, office equipment, lighting device, robot (e.g. robotic arm), smart vehicle, smart machine, assembly line, smart device, internet-of-thing (IoT) device, smart home device, and/or a smart office device.

A sensing-initiating device (e.g. the Type 1 device, the Type 2 device, another Type 1 device, another Type 2 device, a server, a client device, and/or a user device) may initiate a pair-wise “sensing session” by using standard-compliant/protocol-compliant signaling to request (e.g. a point-to-point request using a control frame compliant with a standard such as WiFi) a sensing-responding device to perform a standard-compliant/protocol-compliant sounding task to support or enable one or more sensing tasks (e.g. the task). The sounding task includes transmitting the wireless signal (e.g. a series of probe signals) at a certain rate (sounding rate) from the Type 1 device to the Type 2 device through a wireless multipath channel of the venue, and generating the TSCI from the received wireless signal in the session. Between the sensing-initiating device and the sensing-responding device, one may function as the Type 1 device to transmit the wireless signal and the other as the Type 2 device to receive the wireless signal and extract TSCI for performing the task. Computation for the task may be performed in the initiating device, the responding device, or another device. The TSCI may need to be communicated to the task-computing device, which may need considerable data bandwidth. Alternatively, intermediate statistics/features needed for the task may be computed locally based on the ISO. (e.g. in the Type 2 device or a local device) and communicated to the task-computing device, which require less data bandwidth. The qualification test may be performed for the initiating device and/or the responding device (e.g. before or after the request).

For example, the initiating device may be “paired” with the responding device by a user using some pairing procedure (e.g. the user may use an app (application software) in a mobile phone or tablet or computer to connect locally to one of the devices and to establish communication linkage with a cloud server. The user may instruct the device to search for and pair with the other device. The user may press a button on the other device for the pairing). Both devices may be qualified during the pairing. A tentative sounding task setting for the task may be obtained.

In another example, the initiating device may be qualified long time ago (e.g. in design phase or manufacturing phase or in factory setting). The user may purchase it and install it in his/her home by setting it up to connect to internet, and to a cloud server through the internet. To find out any compatible sensing-responding devices in the home (e.g. perhaps upon the user pressing a button on the device or in some app on his/her smart device), the device may send out a wireless signal (e.g. a control frame based on a standard or a protocol) to search for any compatible sensing-responding devices and wait for any reply. Upon the sensing-responding device replying, pairing may be established between the two devices. The qualification test may be performed on the responding device. The two devices may exchange sounding/sensing capability and negotiate/handshake/arrange/obtain an appropriate sounding/sensing setting that both devices can support. They may decide which device would serve as the Type 1 device and which as the Type 2 device. The user may start a sensing session and start the sensing task (e.g. immediately by pressing a button or by setting up a time table for scheduled sensing), pause the task (pausing the session), terminate the task (ending the session), change sensing setting, add a new task (e.g, starting another sensing session, or in the same sensing session), end an existing task, etc.

In another example, the initiating device may not function as a Type 1 device or a Type 2 device. Instead, it may serve as a server and initiate a pair-wise sensing session between two responding devices. It may send one or two requests (e.g. one or two control frames compliant to standard or protocol) to the two devices, with one to serve as Type 1 device to transmit the wireless signal (e.g. a series of sounding signals or probe signals) and the other as Type 2 device to receive the wireless signal and to extract the TSCI from the received signal. The one or two requests may contain identifications of the two responding devices (e.g. one field in the control frame for ID of each responding device), and an indication (e.g. a bit in the control frame) of which one being the Type 1 device and which one being the Type 2 device.

In yet another example, the initiating device may initiating a “group” sensing session by requesting (e.g. using one or more control frames compliant to a standard such as WiFi) a group of N sensing-responding devices to perform the sounding task and/or sensing task in a group. In one example, the initiating device may initiate pair-wise sensing session individually/separately with each of the group of N responding devices, each session comprising the initiating device and one responding device. In particular, the initiating device may send one request (e.g. using a control frame for each responding device) to each of the group of N responding devices (i.e. N individual requests for N devices). The request may contain an identification of the respective responding device and/or the respective sensing session. The initiating device may negotiate with each responding device to determine sounding/sensing settings including wireless signal setting and TSCI extraction setting (e.g. using control frames compliant to standard or protocol). Among the multiple pair-wise sensing session, the initiating device may coordinate/control/manage the transmission and/or reception (e.g. timing) of the wireless signals (e.g. series of probe signals), and extracting of TSCI from the wireless signals and any sharing of TSCI.

Alternatively, the initiating device may not function as a Type 1 device or a Type 2 device. Instead, it may function as a server and may initiate N pair-wise sensing sessions by sending N requests or 2N requests (e.g. control frame compliant to standard or protocol) separately/individually to N pairs of responding devices. Each request may include identification of the pair of devices (e.g. one field of a control frame for ID of one device) and an indication (e.g. a field or a bit of the control frame) of which device is the Type 1 device, and which is the Type 2. The request may include some sensing/sounding settings.

In another example, the initiating device may send a group request (e.g. one or more control frames compliant to standard or protocol) to the group of responding devices (i.e. one combined request for N devices). The group request (e.g. fields of the control frames in particular) may include identification information of each of the responding devices, and/or an ordering of any transmission among the responding devices. In the case that each of the responding devices need to transmit a respective wireless signal through the wireless multipath channel (or to send a respective CI or a respective TSCI), they may follow the specified order. All the wireless signals (e.g, each being a series of probe signals) may/may not have the same sounding rate. Their transmission order may be controlled/scheduled by the initiating device. The initiating device may further send triggering signal (e.g. control frame compliant to standard or protocol) to trigger/initiate respective transmission from respective responding device. The first responding device to respond may transmit immediately and may not need a triggering signal.

Alternatively, the initiating device may not function as a Type 1 device or a Type 2 device. Instead, it may function as a server and may send a group request (e.g. control frame compliant to standard or protocol) to N pairs of responding devices (one combined request for 2N devices). The group request (e.g. fields of the control frame) may include identification information of each pair of responding devices, an indication of which one in the pair to serve as Type 1 device and which as Type 2 device, and an ordering of transmission from the pair. The request may include some sensing/sounding settings. The initiating device may inform each pair of devices about the task and a requirement of the task (e.g. minimum sounding rate), and may, instruct the two devices to negotiate to a commonly supported sensing/sounding setting that satisfy the task requirement. The initiating device may control/manage/coordinate other aspects of the sensing session (e.g. timing, TSCI format, TSCI sharing/preprocessing/processing, different algorithms to achieve the same task) by sending standard-compliant control frames.

The task may include: detect a user returning home, detect a user leaving home, detect a user moving from one room to another, detect/control/lock/unlock/open/close/partially open a window/door/garage door/blind/curtain/panel/solar panel/sun shade, detect a pet, detect/monitor a user doing something (e.g. sleeping on sofa, sleeping in bedroom, running on treadmill, cooking, sitting on sofa, watching TV, eating in kitchen, eating in dining room, going upstairs/downstairs, going outside/coming back, in the rest room), monitor/detect location of a user/pet, do something (e,g. send a message, notify/report to someone) automatically upon detection, do something for the user automatically upon detecting the user, turn on/off/dim a light, turn on/off music/radio/home entertainment system, turn on/off/adjust/control TV/HiFi/set-top-box (STB)/home entertainment system/smart speaker/smart device, turn on/off/adjust air conditioning system, turn on/off/adjust ventilation system, turn on/off/adjust heating system, adjust/control curtains/light shades, turn on/off/wake a computer, turn on/off/pre-heat/control coffee machine/hot water pot, turn on/off/control/preheat cooker/oven/microwave oven/another cooking device, check/adjust temperature, check weather forecast, check telephone message box, check mail, do a system check, control/adjust a system, check/control/arm/disarm security system/baby monitor, check/control refrigerator, give a report (e.g. through a speaker such as Google home, Amazon Echo, on a display/screen, via a webpage/email/messaging system/notification system).

For example, when a user arrives home in his car, the task may be to, automatically, detect the user or his car approaching, open the garage door upon detection, turn on the driveway/garage light as the user approaches the garage, turn on air conditioner/heater/fan, etc. As the user enters the house, the task may be to, automatically, turn on the entrance light, turn off driveway/garage light, play a greeting message to welcome the user, turn on the music, turn on the radio and tuning to the user's favorite radio news channel, open the curtain/blind, monitor the user's mood, adjust the lighting and sound environment according to the user's mood or the current/imminent event (e.g. do romantic lighting and music because the user is scheduled to eat dinner with girlfriend in 1 hour) on the user's daily calendar, warm the food in microwave that the user prepared in the morning, do a diagnostic check of all systems in the house, check weather forecast for tomorrow's work, check news of interest to the user, check user's calendar and to-do list and play reminder, check telephone answer system/messaging system/email and give a verbal report using dialog system/speech synthesis, remind (e.g. using audible tool such as speakers/HiFi/speech synthesis/sound/voice/music/song/sound field/background sound field/dialog system, using visual tool such as TV/entertainment system/computer/notebook/smart pad/display/light/color/brightness/patterns/symbols, using haptic tool/virtual reality tool/gesture/tool, using a smart device/appliance/material/furniture/fixture, using web tool/server/hub device/cloud server/fog server/edge server/home network/mesh network, using messaging tool/notification tool/communication tool/scheduling tool/email, using user interface/GUI, using scent/smell/fragrance/taste, using neural tool/nervous system tool, using a combination) the user of his mother's birthday and to call her, prepare a report, and give the report (e.g. using a tool for reminding as discussed above). The task may turn on the air conditioner/heater/ventilation system in advance, or adjust temperature setting of smart thermostat in advance, etc. As the user moves from the entrance to the living room, the task may be to turn on the living room light, open the living room curtain, open the window, turn off the entrance light behind the user, turn on the TV and set-top box, set TV to the user's favorite channel, adjust an appliance according to the user's preference and conditions/states (e.g. adjust lighting and choose/play music to build a romantic atmosphere), etc.

Another example may be: When the user wakes up in the morning, the task may be to detect the user moving around in the bedroom, open the blind/curtain, open the window, turn off the alarm clock, adjust indoor temperature from night-time temperature profile to day-time temperature profile, turn on the bedroom light, turn on the restroom light as the user approaches the restroom, check radio or streaming channel and play morning news, turn on the coffee machine and preheat the water, turn off security system, etc. When the user walks from bedroom to kitchen, the task may be to turn on the kitchen and hallway lights, turn off the bedroom and restroom lights, move the music/message/reminder from the bedroom to the kitchen, turn on the kitchen TV, change TV to morning news channel, lower the kitchen blind and open the kitchen window to bring in fresh air, unlock backdoor for the user to check the backyard, adjust temperature setting for the kitchen, etc. Another example may be: When the user leaves home for work, the task may be to detect the user leaving, play a farewell and/or have-a-good-day message, open/close garage door, turn on/off garage light and driveway light, turn off/dim lights to save energy (just in case the user forgets), close/lock all windows/doors (just in case the user forgets), turn off appliance (especially stove, oven, microwave oven), turn on/arm the home security system to guard the home against any intruder, adjust air conditioning/heating/ventilation systems to “away-from-home” profile to save energy, send alerts/reports/updates to the user's smart phone, etc.

A motion may comprise at least one of: a no-motion, resting motion, non-moving motion, movement, change in position/location, deterministic motion, transient motion, fall-down motion, repeating motion, periodic motion, pseudo-periodic motion, periodic/repeated motion associated with breathing, periodic/repeated motion associated with heartbeat, periodic/repeated motion associated with living object, periodic/repeated motion associated with machine, periodic/repeated motion associated with man-made Object, periodic/repeated motion associated with nature, complex motion with transient element and periodic element, repetitive motion, non-deterministic motion, probabilistic motion, chaotic motion, random motion, complex motion with non-deterministic element and deterministic element, stationary random motion, pseudo-stationary random motion, cyclo-stationary random motion, non-stationary random motion, stationary random motion with periodic autocorrelation function (ACF), random motion with periodic ACF for period of time, random motion that is pseudo-stationary for a period of time, random motion of which an instantaneous ACF has a pseudo-periodic/repeating element for a period of time, machine motion, mechanical motion, vehicle motion, drone motion, air-related motion, wind-related motion; weather-related motion, water-related motion, fluid-related motion, ground-related motion, change in electro-magnetic characteristics, sub-surface motion, seismic motion, plant motion, animal motion, human motion, normal motion, abnormal motion, dangerous motion, warning motion, suspicious motion, rain, tire, flood, tsunami, explosion, collision, imminent collision, human body motion, head motion, facial motion, eye motion, mouth motion, tongue motion, neck motion, finger motion, hand motion, arm motion, shoulder motion, body motion, chest motion, abdominal motion, hip motion, leg motion, foot motion, body joint motion, knee motion, elbow motion, upper body motion, lower body motion, skin motion, below-skin motion, subcutaneous tissue motion, blood vessel motion, intravenous motion, organ motion, heart motion, lung motion; stomach motion, intestine motion, bowel motion, eating motion, breathing motion, facial expression, eye expression, mouth expression, talking motion, singing motion, eating motion, gesture, hand gesture, arm gesture, keystroke, typing stroke, user-interface gesture, man-machine interaction, gait, dancing movement, coordinated movement, and/or coordinated body movement.

The heterogeneous IC of the Type 1 device and/or any Type 2 receiver may comprise low-noise amplifier (LNA), power amplifier, transmit-receive switch, media access controller, baseband radio, 2.4 GHz radio; 3.65 GHz radio, 4.9 GHz radio, 5 GHz radio, 5.9 GHz radio, below 6GHz radio, below 60 GHz radio and/or another radio. The heterogeneous IC may comprise a processor; a memory communicatively coupled with the processor; and a set of instructions stored in the memory to be executed by the processor. The IC and/or any processor may comprise at least one of: general purpose processor, special purpose processor, microprocessor, multi-processor, multi-core processor, parallel processor, CISC processor, RISC processor, microcontroller, central processing unit (CPU), graphical processor unit (GPU), digital signal processor (DSP), application specific integrated circuit (ASIC), field programmable gate array (FPGA), embedded processor (e.g. ARM), logic circuit, other programmable logic device; discrete logic, and/or a combination. The heterogeneous IC may support broadband network, wireless network, mobile network, mesh network, cellular network, wireless local area network (WLAN), wide area network (WAN), and metropolitan area network (MAN), WLAN standard, WiFi, LTE, LTE-A, LTE-U, 802.11 standard, 802.11a, 802.11b, 802.11g, 802.11n, 802.11a.c, 802.11ad, 802.11af, 802.11ah, 802.11ax, 802.11ay, mesh network standard, 802.15 standard, 802.16 standard, cellular network standard, 3G, 3.5G, 4G, beyond 4G, 4.5G, 5G, 6G, 7G, 8G, 9G, UMTS, 3GPP, GSM, EDGE, TDMA, FDMA, CDMA, WCDMA, TD-SCDMA, Bluetooth, Bluetooth Low-Energy (BLE), NFC, Zigbee, WiMax, and/or another wireless network protocol.

The processor may comprise general purpose processor, special purpose processor, microprocessor, microcontroller, embedded processor, digital signal processor, central processing unit (CPU), graphical processing unit (GPU), multi-processor, multi-core processor, and/or processor with graphics capability, and/or a combination. The memory may be volatile, non-volatile, random access memory (RAM), Read Only Memory (ROM), Electrically Programmable ROM (EPROM), Electrically Erasable Programmable ROM (EEPROM), hard disk, flash memory, CD-ROM, DVD-ROM, magnetic storage, optical storage, organic storage, storage system, storage network, network storage, cloud storage, edge storage, local storage, external storage, internal storage, or other form of non-transitory storage medium known in the art. The set of instructions (machine executable code) corresponding to the method steps may be embodied directly in hardware, in software, in firmware, or in combinations thereof. The set of instructions may be embedded, pre-loaded, loaded upon boot up, loaded on the fly, loaded on demand, pre-installed, installed, and/or downloaded.

The presentation may be a presentation in an audio-visual way (e.g. using combination of visual, graphics, text, symbols, color, shades, video, animation, sound, speech, audio, etc.), graphical way (e.g. using GUI, animation, video), textual way (e.g. webpage with text, message, animated text), symbolic way (e.g. emoticon, signs, hand gesture), or mechanical way (e.g. vibration, actuator movement, haptics, etc.).

Computational workload associated with the method is shared among the processor, the Type 1 heterogeneous wireless device, the Type 2 heterogeneous wireless device, a local server (e.g. hub device), a cloud server, and another processor.

An operation, pre-processing, processing and/or postprocessing may be applied to data (e.g. TSCI, autocorrelation, features of TSCI). An operation may be preprocessing, processing and/or postprocessing. The preprocessing, processing and/or postprocessing may be an operation. An operation may comprise preprocessing, processing, post-processing, scaling, computing a confidence factor, computing a line-of-sight (LOS) quantity, computing a non-LOS (NLOS) quantity, a quantity comprising LOS and NLOS, computing a single link (e.g. path, communication path, link between a transmitting antenna and a receiving antenna) quantity, computing a quantity comprising multiple links, computing a function of the operands, filtering, linear filtering, nonlinear filtering, folding, grouping, energy computation, lowpass filtering, bandpass filtering, highpass filtering, median filtering, rank filtering, quartile filtering, percentile filtering, mode filtering, finite impulse response (FIR) filtering, infinite impulse response (IIR) filtering, moving average (MA) filtering, autoregressive (AR) filtering, autoregressive moving averaging (ARMA) filtering, selective filtering, adaptive filtering, interpolation, decimation, subsampling, upsampling, resampling, time correction, time base correction, phase correction, magnitude correction, phase cleaning, magnitude cleaning, matched filtering, enhancement, restoration, denoising, smoothing, signal conditioning, enhancement, restoration, spectral analysis, linear transform, nonlinear transform, inverse transform, frequency transform, inverse frequency transform, Fourier transform (FT), discrete time FT (DTFT), discrete FT (DFT), fast FT (FFT), wavelet transform, Laplace transform, Hilbert transform, Hadamard transform, trigonometric transform, sine transform, cosine transform, DCT, power-of-2 transform, sparse transform, graph-based transform, graph signal processing, fast transform, a transform combined with zero padding, cyclic padding, padding, zero padding, feature extraction, decomposition, projection, orthogonal projection, non-orthogonal projection, over-complete projection, eigen-decomposition, singular value decomposition (SVD), principle component analysis (PCA), independent component analysis (ICA), grouping, sorting, thresholding, soft thresholding, hard thresholding, clipping, soft clipping, first derivative, second order derivative, high order derivative, convolution, multiplication, division, addition, subtraction, integration, maximization, minimization, least mean square error, recursive least square, constrained least square, batch least square, least absolute error, least mean square deviation, least absolute deviation, local maximization, local minimization, optimization of a cost function, neural network, recognition, labeling, training, clustering, machine learning, supervised learning, unsupervised learning, semi-supervised learning, comparison with another TSCI, similarity score computation, quantization, vector quantization, matching pursuit, compression, encryption, coding, storing, transmitting, normalization, temporal normalization, frequency domain normalization, classification, clustering, labeling, tagging, learning, detection, estimation, learning network, mapping, remapping, expansion, storing, retrieving, transmitting, receiving, representing, merging, combining, splitting, tracking, monitoring, matched filtering, Kalman filtering, particle filter, intrapolation, extrapolation, histogram estimation, importance sampling, Monte Carlo sampling, compressive sensing, representing, merging, combining, splitting, scrambling, error protection, forward error correction, doing nothing, time varying processing, conditioning averaging, weighted averaging, arithmetic mean, geometric mean, harmonic mean, averaging over selected frequency, averaging over antenna links, logical operation, permutation, combination, sorting, AND, OR, XOR, union, intersection, vector addition, vector subtraction, vector multiplication, vector division, inverse, norm, distance, and/or another operation. The operation may be the preprocessing, processing, and/or post-processing. Operations may be applied jointly on multiple time series or functions.

The function (e.g. function of operands) may comprise: scalar function, vector function, discrete function, continuous function, polynomial function, characteristics, feature, magnitude, phase, exponential function, logarithmic function, trigonometric function, transcendental function, logical function, linear function, algebraic function, nonlinear function, piecewise linear function, real function, complex function, vector-valued function, inverse function, derivative of function, integration of function, circular function, function of another function, one-to-one function, one-to-many function, many-to-one function, many-to-many function, zero crossing, absolute function, indicator function, mean, mode, median, range, statistics, histogram, variance, standard deviation, measure of variation, spread, dispersion, deviation, divergence, range, interquartile range, total variation, absolute deviation, total deviation, arithmetic mean, geometric mean, harmonic mean, trimmed mean, percentile, square, cube, root, power, sine, cosine, tangent, cotangent, secant, cosecant, elliptical function, parabolic function, hyperbolic function, game function, zeta function, absolute value, thresholding, limiting function, floor function, rounding function, sign function, quantization, piecewise constant function, composite function, function of function, time function processed with an operation (e.g. filtering), probabilistic function, stochastic function, random function, ergodic function, stationary function, deterministic function, periodic function, repeated function, transformation, frequency transform, inverse frequency transform, discrete time transform, Laplace transform, Hilbert transform, sine transform, cosine transform, triangular transform, wavelet transform, integer transform, power-of-2 transform, sparse transform, projection, decomposition, principle component analysis (PCA), independent component analysis (ICA), neural network, feature extraction, moving function, function of moving window of neighboring items of time series, filtering function, convolution, mean function, histogram, variance/standard deviation function, statistical function, short-time transform, discrete transform, discrete Fourier transform, discrete cosine transform, discrete sine transform, Hadamard transform, eigen-decomposition, eigenvalue, singular value decomposition (SVD), singular value, orthogonal decomposition, matching pursuit, sparse transform, sparse approximation, any decomposition, graph-based processing, graph-based transform, graph signal processing, classification, identifying a class/group/category, labeling, learning, machine learning, detection, estimation, feature extraction, learning network, feature extraction, denoising, signal enhancement, coding, encryption, mapping, remapping, vector quantization, lowpass filtering, highpass filtering, bandpass filtering, matched filtering, Kalman filtering, preprocessing, postprocessing, particle filter, FIR filtering, IIR filtering, autoregressive (AR) filtering, adaptive filtering, first order derivative, high order derivative, integration, zero crossing, smoothing, median filtering, mode filtering, sampling, random sampling, resampling function, downsampling, down-converting, upsampling, up-converting, interpolation, extrapolation, importance sampling, Monte Carlo sampling, compressive sensing, statistics, short term statistics, long term statistics, autocorrelation function, cross correlation, moment generating function, time averaging, weighted averaging, special function, Bessel function, error function, complementary error function, Beta function, Gamma function, integral function, Gaussian function, Poisson function, etc. Machine learning, training, discriminative training, deep learning, neural network, continuous time processing, distributed computing, distributed storage, acceleration using GPU/DSP/coprocessor/multicore/multiprocessing may be applied to a step (or each step) of this disclosure.

A frequency transform may include Fourier transform, Laplace transform, Hadamard transform, Hilbert transform, sine transform, cosine transform, triangular transform, wavelet transform, integer transform, power-of-2 transform, combined zero padding and transform, Fourier transform with zero padding, and/or another transform. Fast versions and/or approximated versions of the transform may be performed. The transform may be performed using floating point, and/or fixed point arithmetic.

An inverse frequency transform may include inverse Fourier transform, inverse Laplace transform, inverse Hadamard transform, inverse Hilbert transform, inverse sine transform, inverse cosine transform, inverse triangular transform, inverse wavelet transform, inverse integer transform, inverse power-of-2 transform, combined zero padding and transform, inverse Fourier transform with zero padding, and/or another transform. Fast versions and/or approximated versions of the transform may be performed. The transform may be performed using floating point, and/or fixed point arithmetic.

A quantity/feature from a TSCI may be computed. The quantity may comprise statistic of at least one of: motion, location, map coordinate, height, speed, acceleration, movement angle, rotation, size, volume, time trend, pattern, one-time pattern, repeating pattern, evolving pattern, time pattern, mutually excluding patterns, related/correlated patterns, cause-and-effect, correlation, short-term/long-term correlation, tendency, inclination, statistics, typical behavior, atypical behavior, time trend, time profile, periodic motion, repeated motion, repetition, tendency, change, abrupt change, gradual change, frequency, transient, breathing, gait, action, event, suspicious event, dangerous event, alarming event, warning, belief, proximity, collision, power, signal, signal power, signal strength, signal intensity, received signal strength indicator (RSSI), signal amplitude, signal phase, signal frequency component, signal frequency band component, channel state information (CSI), map, time, frequency, time-frequency, decomposition, orthogonal decomposition, non-orthogonal decomposition, tracking, breathing, heart beat, statistical parameters, cardiopulmonary statistics/analytics (e.g. output responses), daily activity statistics/analytics, chronic disease statistics/analytics, medical statistics/analytics, an early (or instantaneous or contemporaneous or delayed) indication/suggestion/sign/indicator/verifier/detection/symptom of a disease/condition/situation, biometric, baby, patient, machine, device, temperature, vehicle, parking lot, venue, lift, elevator, spatial, road, fluid flow, home, room, office, house, building, warehouse, storage, system, ventilation, fan, pipe, duct, people, human, car, boat, truck, airplane, drone, downtown, crowd, impulsive event, cyclo-stationary, environment, vibration, material, surface, 3-dimensional, 2-dimensional, local, global, presence, and/or another measurable quantity/variable.

Sliding time window may have time varying window width. It may be smaller at the beginning to enable fast acquisition and may increase over time to a steady-state size. The steady-state size may be related to the frequency, repeated motion, transient motion, and/or STI to be monitored. Even in steady state, the window size may be adaptively (and/or dynamically) changed (e.g. adjusted, varied, modified) based on battery life, power consumption, available computing power, change in amount of targets; the nature of motion to be monitored, etc.

The time shift between two sliding time windows at adjacent time instance may be constant/variable/locally adaptive/dynamically adjusted over time. When shorter time shift is used, the update of any monitoring may be more frequent which may be used for fast changing situations, object motions, and/or objects. Longer time shift may be used for slower situations, object motions, and/or objects. The window width/size and/or time shift may be changed (e.g. adjusted, varied, modified) upon a user request/choice. The time shift may be changed automatically (e.g. as controlled by processor/computer/server/hub device/cloud server) and/or adaptively (and/or dynamically).

At least one characteristics (e.g. characteristic value, or characteristic point) of a function (e.g. auto-correlation function, auto-covariance function, cross-correlation function, cross-covariance function, power spectral density, time function, frequency domain function, frequency transform) may be determined (e.g. by an object tracking server, the processor, the Type 1 heterogeneous device, the Type 2 heterogeneous device, and/or another device). The at least one characteristics of the function may include: a maximum, minimum; extremum, local maximum, local minimum, local extremum, local extremum with positive time offset, first local extremum with positive time offset, n\hat{ }th local extremum with positive time offset, local extremum with negative time offset, first local extremum with negative time offset, n\hat{ }th local extremum with negative time offset, constrained maximum, constrained minimum, constrained extremum, significant maximum, significant minimum, significant extremum, slope, derivative, higher order derivative, maximum slope, minimum slope, local maximum slope, local maximum slope with positive time offset, local minimum slope, constrained maximum slope, constrained minimum slope, maximum higher order derivative, minimum higher order derivative, constrained higher order derivative, zero-crossing, zero crossing with positive time offset, nth zero crossing with positive time offset, zero crossing with negative time offset, n\hat{ }th zero crossing with negative time offset, constrained zero-crossing, zero-crossing of slope, zero-crossing of higher order derivative, and/or another characteristics. At least one argument of the function associated with the at least one characteristics of the function may be identified. Some quantity (e.g. spatial-temporal information of the object) be determined based on the at least one argument of the function.

A characteristics (e.g. characteristics of motion of an object in the venue) may comprise at least one of: an instantaneous characteristics, short-term characteristics, repetitive characteristics, recurring characteristics, history, incremental characteristics, changing characteristics, deviational characteristics; phase, magnitude, degree, time characteristics, frequency characteristics, time-frequency characteristics, decomposition characteristics, orthogonal decomposition characteristics, non-orthogonal decomposition characteristics, deterministic characteristics, probabilistic characteristics, stochastic characteristics, autocorrelation function (ACF), mean, variance, standard deviation, measure of variation, spread, dispersion, deviation, divergence, range, interquartile range, total variation, absolute deviation, total deviation, statistics, duration, timing, trend, periodic characteristics, repetition characteristics, long-term characteristics, historical characteristics, average characteristics; current characteristics, past characteristics, future characteristics, predicted characteristics, location, distance, height, speed, direction, velocity, acceleration, change of the acceleration, angle, angular speed, angular velocity, angular acceleration of the object, change of the angular acceleration, orientation of the object, angular of rotation, deformation of the object, shape of the object, change of shape of the object, change of size of the object, change of structure of the object, and/or change of characteristics of the object.

At least one local maximum and at least one local minimum of the function may be identified. At least one local signal-to-noise-ratio-like (SNR-like) parameter may be computed for each pair of adjacent local maximum and local minimum. The SNR-like parameter may be a function (e.g. linear, log, exponential function, monotonic function) of a fraction of a quantity (e.g. power, magnitude) of the local maximum over the same quantity of the local minimum. It may also be the function of a difference between the quantity of the local maximum and the same quantity of the local minimum. Significant local peaks may be identified or selected. Each significant local peak may be a local maximum with SNR-like parameter greater than a threshold T1 and/or a local maximum with amplitude greater than a threshold T2. The at least one local minimum and the at least one local minimum in the frequency domain may be identified/computed using a persistence-based approach.

A set of selected significant local peaks may be selected from the set of identified significant local peaks based on a selection criterion (e.g. a quality criterion, a signal quality condition). The characteristics/STI of the object may be computed based on the set of selected significant local peaks and frequency values associated with the set of selected significant local peaks. In one example, the selection criterion may always correspond to select the strongest peaks in a range. While the strongest peaks may be selected, the unselected peaks may still be significant (rather strong).

Unselected significant peaks may be stored and/or monitored as “reserved” peaks for use in future selection in future sliding time windows. As an example, there may be a particular peak (at a particular frequency) appearing consistently over time. Initially, it may be significant but not selected (as other peaks may be stronger). But in later time, the peak may become stronger and more dominant and may be selected. When it became “selected”, it may be back-traced in time and made “selected” in the earlier time when it was significant but not selected. In such case, the back-traced peak may replace a previously selected peak in an early time. The replaced peak may be the relatively weakest, or a peak that appear in isolation in time (i.e. appearing only briefly in time).

In another example, the selection criterion may not correspond to select the strongest peaks in the range. instead, it may consider not only the “strength” of the peak, but the “trace” of the peak peaks that may have happened in the past, especially those peaks that have been identified for a long time. For example, if a finite state machine (FSM) is used, it may select the peak(s) based on the state of the FSM. Decision thresholds may be computed adaptively (and/or dynamically) based on the state of the FSM.

A similarity score and/or component similarity score may be computed (e.g, by a server (e.g. hub device), the processor, the Type 1 device, the Type 2 device, a local server, a cloud server, and/or another device) based on a pair of temporally adjacent CI of a TSCI. The pair may come from the same sliding window or two different sliding windows. The similarity score may also be based on a pair of, temporally adjacent or not so adjacent, CT from two different TSCI The similarity score and/or component similar score may be/comprise: time reversal resonating strength (TRRS), correlation, cross-correlation, auto-correlation, correlation indicator, covariance, cross-covariance, auto-covariance, inner product of two vectors, distance score, norm, metric, quality metric, signal quality condition, statistical characteristics, discrimination score, neural network, deep learning network, machine learning, training, discrimination, weighted averaging, preprocessing, denoising, signal conditioning, filtering, time correction, timing compensation, phase offset compensation, transformation, component-wise operation, feature extraction, finite state machine, and/or another score. The characteristics and/or STI may be determined/computed based on the similarity score.

Any threshold may be pre-determined, adaptively (and/or dynamically) determined and/or determined by a finite state machine. The adaptive determination may be based on time, space, location, antenna, path, link, state, battery life, remaining battery life, available power, available computational resources, available network bandwidth, etc.

A threshold to be applied to a test statistics to differentiate two events (or two conditions, or two situations, or two states), A and B, may be determined. Data (e.g. CI, channel state information (CSI), power parameter) may be collected under A and/or under B in a training situation. The test statistics may be computed based on the data. Distributions of the test statistics under A may be compared with distributions of the test statistics under B (reference distribution), and the threshold may be chosen according to some criteria. The criteria may comprise: maximum likelihood (NIL), maximum aposterior probability (MAP), discriminative training, minimum Type 1 error for a given Type 2 error, minimum Type 2 error for a given Type 1 error, and/or other criteria (e.g. a quality criterion, signal quality condition). The threshold may be adjusted to achieve different sensitivity to the A, B and/or another event/condition/situation/state. The threshold adjustment may be automatic, semi-automatic and/or manual. The threshold adjustment may be applied once, sometimes, often, periodically, repeatedly, occasionally, sporadically, and/or on demand. The threshold adjustment may be adaptive (and/or dynamically adjusted). The threshold adjustment may depend on the object, object movement/location/direction/action, object characteristics/STI/size/property/trait/habit/behavior, the venue, feature/fixture/furniture/barrier/material/machine/living thing/thing/object/boundary/surface/medium that is in/at/of the venue, map, constraint of the map (or environmental model), the event/state/situation/condition, time, timing, duration, current state, past history, user, and/or a personal preference, etc.

A stopping criterion (or skipping or bypassing or blocking or pausing or passing or rejecting criterion) of an iterative algorithm may be that change of a current parameter (e.g. offset value) in the updating in an iteration is less than a threshold. The threshold may be 0.5, 1, 1.5, 2, or another number. The threshold may be adaptive (and/or dynamically adjusted). It may change as the iteration progresses. For the offset value, the adaptive threshold may be determined based on the task, particular value of the first time, the current time offset value, the regression window, the regression analysis, the regression function, the regression error, the convexity of the regression function, and/or an iteration number.

The local extremum may be determined as the corresponding extremum of the regression function in the regression window. The local extremum may be determined based on a set of time offset values in the regression window and a set of associated regression function values. Each of the set of associated regression function values associated with the set of time offset values may be within a range from the corresponding extremum of the regression function in the regression window.

The searching for a local extremum may comprise robust search, minimization, maximization, optimization, statistical optimization, dual optimization, constraint optimization, convex optimization, global optimization, local optimization an energy minimization, linear regression, quadratic regression, higher order regression, linear programming, nonlinear programming, stochastic programming, combinatorial optimization, constraint programming, constraint satisfaction, calculus of variations, optimal control, dynamic programming, mathematical programming, multi-objective optimization, multi-modal optimization, disjunctive programming, space mapping, infinite-dimensional optimization, heuristics, metaheuristics, convex programming, semidefinite programming, conic programming, cone programming, integer programming, quadratic programming, fractional programming, numerical analysis, simplex algorithm, iterative method, gradient descent, subgradient method, coordinate descent, conjugate gradient method, Newton's algorithm, sequential quadratic programming, interior point method, ellipsoid method, reduced gradient method, quasi-Newton method, simultaneous perturbation stochastic approximation, interpolation method, pattern search method, line search, non-differentiable optimization, genetic algorithm, evolutionary algorithm, dynamic relaxation, hill climbing, particle swarm optimization, gravitation search algorithm, simulated annealing, memetic algorithm, differential evolution, dynamic relaxation, stochastic tunneling, Tabu search, reactive search optimization, curve fitting, least square; simulation based optimization, variational calculus, and/or variant. The search for local extremum may be associated with an objective function, loss function, cost function, utility function, fitness function, energy function, and/or an energy function.

Regression may be performed using regression function to fit sampled data (e.g. CI, feature of CI, component of CI) or another function (e.g. autocorrelation function) in a regression window, in at least one iteration, a length of the regression window and/or a location of the regression window may change. The regression function may be linear function, quadratic function, cubic function, polynomial function, and/or another function. The regression analysis may minimize at least one of: error, aggregate error, component error, error in projection domain, error in selected axes, error in selected orthogonal axes, absolute error, square error, absolute deviation, square deviation, higher order error (e.g. third order, fourth order), robust error (e.g. square error for smaller error magnitude and absolute error for larger error magnitude, or first kind of error for smaller error magnitude and second kind of error for larger error magnitude), another error, weighted sum (or weighted mean) of absolute/square error (e.g. for wireless transmitter with multiple antennas and wireless receiver with multiple antennas, each pair of transmitter antenna and receiver antenna form a link), mean absolute error, mean square error, mean absolute deviation, and/or mean square deviation. Error associated with different links may have different weights. One possibility is that some links and/or some components with larger noise or lower signal quality metric may have smaller or bigger weight), weighted sum of square error, weighted sum of higher order error, weighted sum of robust error, weighted sum of the another error, absolute cost, square cost, higher order cost, robust cost, another cost, weighted sum of absolute cost, weighted sum of square cost, weighted sum of higher order cost, weighted sum of robust cost, and/or weighted sum of another cost. The regression error determined may be an absolute error, square error, higher order error, robust error, yet another error, weighted sum of absolute error, weighted sum of square error, weighted sum of higher order error, weighted sum of robust error, and/or weighted sum of the yet another error.

The time offset associated with maximum regression error (or minimum regression error) of the regression function with respect to the particular function in the regression window may become the updated current time offset in the iteration.

A local extremum may be searched based on a quantity comprising a difference of two different errors (e.g, a difference between absolute error and square error). Each of the two different errors may comprise an absolute error, square error, higher order error, robust error, another error, weighted sum of absolute error, weighted sum of square error, weighted sum of higher order error, weighted sum of robust error, and/or weighted sum of the another error.

The quantity may be compared with a reference data or a reference distribution, such as an F-distribution, central F-distribution, another statistical distribution, threshold, threshold associated with probability/histogram, threshold associated with probability/histogram of finding false peak, threshold associated with the F-distribution, threshold associated the central F-distribution, and/or threshold associated with the another statistical distribution.

The regression window may be determined based on at least one of: the movement (e.g. change in position/location) of the object, quantity associated with the object, the at least one characteristics and/or STI of the object associated with the movement of the object, estimated location of the local extremum, noise characteristics, estimated noise characteristics, signal quality metric, F-distribution, central F-distribution, another statistical distribution, threshold, preset threshold, threshold associated with probability/histogram, threshold associated with desired probability, threshold associated with probability of finding false peak, threshold associated with the F-distribution, threshold associated the central F-distribution, threshold associated with the another statistical distribution, condition that quantity at the window center is largest within the regression window; condition that the quantity at the window center is largest within the regression window, condition that there is only one of the local extremum of the particular function for the particular value of the first time in the regression window; another regression window, and/or another condition.

The width of the regression window may be determined based on the particular local extremum to be searched. The local extremum may comprise first local maximum, second local maximum, higher order local maximum, first local maximum with positive time offset value, second local maximum with positive time offset value, higher local maximum with positive time offset value, first local maximum with negative time offset value, second local maximum with negative time offset value, higher local maximum with negative time offset value; first local minimum, second local minimum, higher local minimum, first local minimum with positive time offset value, second local minimum with positive time offset value; higher local minimum with positive time offset value, first local minimum with negative time offset value, second local minimum with negative time offset value, higher local minimum with negative time offset value, first local extremum, second local extremum, higher local extremum, first local extremum with positive time offset value, second local extremum with positive time offset value, higher local extremum with positive time offset value, first local extremum with negative time offset value, second local extremum with negative time offset value, and/or higher local extremum with negative time offset value.

A current parameter (e.g. time offset value) may be initialized based on a target value, target profile, trend, past trend, current trend, target speed, speed profile; target speed profile, past speed trend, the motion or movement (e.g. change in position/location) of the object, at least one characteristics and/or STI of the object associated with the movement of object, positional quantity of the object, initial speed of the object associated with the movement of the object, predefined value, initial width of the regression window, time duration, value based on carrier frequency of the signal, value based on subcarrier frequency of the signal, bandwidth of the signal, amount of antennas associated with the channel, noise characteristics, signal h metric, and/or an adaptive (and/or dynamically adjusted) value. The current time offset may be at the center, on the left side, on the right side, and/or at another fixed relative location, of the regression window.

In the presentation, information may be displayed with a map (or environmental model) of the venue. The information may comprise: location, zone, region, area, coverage area, corrected location, approximate location, location with respect to (w.r.t.) a map of the venue, location w.r.t. a segmentation of the venue, direction, path, path w.r.t. the map and/or the segmentation, trace (e.g. location within a time window such as the past 5 seconds, or past 10 seconds; the time window duration may be adjusted adaptively (and/or dynamically); the time window duration may be adaptively (and/or dynamically) adjusted w.r.t. speed, acceleration, etc.), history of a path, approximate regions/zones along a path, history/summary of past locations, history of past locations of interest, frequently-visited areas, customer traffic, crowd distribution, crowd behavior, crowd control information, speed, acceleration, motion statistics, breathing rate, heart rate, presence/absence of motion, presence/absence of people or pets or object, presence/absence of vital sign, gesture, gesture control (control of devices using gesture), location-based gesture control, information of a location-based operation, identity (ID) or identifier of the respect object (e.g. pet, person, self-guided machine/device, vehicle, drone, car; boat, bicycle, self-guided vehicle, machine with fan, air-conditioner, TV, machine with movable part), identification of a user (e.g. person), information of the user, location/speed/acceleration/direction/motion/gesture/gesture control/motion trace of the user, ID or identifier of the user, activity of the user, state of the user, sleeping/resting characteristics of the user, emotional state of the user, vital sign of the user, environment information of the venue, weather information of the venue, earthquake, explosion, storm, rain, fire, temperature, collision, impact, vibration, event, door-open event, door-close event, window-open event, window-close event, fall-down event, burning event, freezing event, water-related event, wind-related event, air-movement event, accident event, pseudo-periodic event (e.g. running on treadmill, jumping up and down, skipping rope, somersault, etc.), repeated event, crowd event, vehicle event, gesture of the user (e.g, hand gesture, arm gesture, foot gesture, leg gesture, body gesture, head gesture, face gesture, mouth gesture, eye gesture, etc.). The location may be 2-dimensional (e.g. with 2D coordinates), 3-dimensional (e.g. with 3D coordinates). The location may be relative (e.g. w.r.t. a map or environmental model) or relational (e.g. halfway between point A and point B, around a corner, up the stairs, on top of table, at the ceiling, on the floor, on a sofa, close to point A, a distance R from point A, within a radius of R from point A, etc.). The location may be expressed in rectangular coordinate, polar coordinate, and/or another representation.

The information (e.g. location) may be marked with at least one symbol. The symbol may be time varying. The symbol may be flashing and/or pulsating with or without changing color/intensity. The size may change over time. The orientation of the symbol may change over time. The symbol may be a number that reflects an instantaneous quantity (e.g. vital sign/breathing rate/heart rate/gesture/state/status/action/motion of a user, temperature, network traffic, network connectivity, status of a device/machine, remaining power of a device, status of the device, etc.). The rate of change, the size, the orientation, the color, the intensity and/or the symbol may reflect the respective motion. The information may be presented visually and/or described verbally (e.g. using pre-recorded voice, or voice synthesis). The information may be described in text. The information may also be presented in a mechanical way (e.g. an animated gadget, a movement of a movable part).

The user-interface (UI) device may be a smart phone (e.g. iPhone, Android phone), tablet (e.g. iPad), laptop (e.g. notebook computer), personal computer (PC), device with graphical user interface (GUI), smart speaker, device with voice/audio/speaker capability, virtual reality (VR) device, augmented reality (AR) device, smart car, display in the car, voice assistant, voice assistant in a car, etc. The map (or environmental model) may be 2-dimensional, 3-dimensional and/or higher-dimensional. (e.g. a time varying 2D/3D snap/environmental model) Walls, windows, doors, entrances, exits, forbidden areas may be marked on the map or the model, The map may comprise floor plan of a facility. The map or model may have one or more layers (overlays). The map/model may be a maintenance map/model comprising water pipes, gas pipes, wiring, cabling, air ducts, crawl-space, ceiling layout, and/or underground layout. The venue may be segmented/subdivided/zoned/grouped into multiple zones/regions/geographic regions/sectors/sections/territories/districts/precincts/localities/neighborhoods/areas/stretches/expanse such as bedroom, living room, storage room, walkway, kitchen, dining room, foyer, garage, first floor, second floor, rest room, offices, conference room, reception area, various office areas, various warehouse regions, various facility areas, etc. The segments/regions/areas may be presented in a map/model. Different regions may be color-coded. Different regions may be presented with a characteristic (e.g. color, brightness, color intensity, texture, animation, flashing, flashing rate, etc.). Logical segmentation of the venue may be done using the at least one heterogeneous Type 2 device, or a server (e.g. hub device), or a cloud server, etc.

Here is an example of the disclosed system, apparatus, and method. Stephen and his family want to install the disclosed wireless motion detection system to detect motion in their 2000 sqft two-storey town house in Seattle, Wash. Because his house has two storeys, Stephen decided to use one Type 2 device (named A) and two Type 1 devices (named B and C) in the ground floor. His ground floor has predominantly three rooms: kitchen, dining room and living room arranged in a straight line, with the dining room in the middle. The kitchen and the living rooms are on opposite end of the house. He put the Type 2 device (A) in the dining room, and put one Type 1 device (B) in the kitchen and the other Type 1 device (C) in the living room. With this placement of the devices, he is practically partitioning the ground floor into 3 zones (dining room, living room and kitchen) using the motion detection system. When motion is detected by the AB pair and the AC pair, the system would analyze the motion information and associate the motion with one of the 3 zones.

When Stephen and his family go out on weekends (e.g. to go for a camp during a long weekend), Stephen would use a mobile phone app (e.g. Android phone app or iPhone app) to turn on the motion detection system. When the system detects motion, a warning signal is sent to Stephen (e.g. an SMS text message, an email, a push message to the mobile phone app, etc.). If Stephen pays a monthly fee (e.g. $10/month), a service company (e.g. security company) will receive the warning signal through wired network (e.g, broadband) or wireless network (e.g. home WiFi, LTE, 3G, 2.5G, etc.) and perform a security procedure for Stephen (e.g. call him to verify any problem, send someone to check on the house, contact the police on behalf of Stephen, etc.). Stephen loves his aging mother and cares about her well-being when she is alone in the house. When the mother is alone in the house while the rest of the family is out (e.g. go to work, or shopping, or go on vacation), Stephen would turn on the motion detection system using his mobile app to ensure the mother is ok. He then uses the mobile app to monitor his mother's movement in the house, When Stephen uses the mobile app to see that the mother is moving around the house among the 3 regions, according to her daily routine, Stephen knows that his mother is doing ok. Stephen is thankful that the motion detection system can help him monitor his mother's well-being while he is away from the house.

On a typical day, the mother would wake up at around 7 AM. She would cook her breakfast in the kitchen for about 20 minutes. Then she would eat the breakfast in the dining room for about 30 minutes. Then she would do her daily exercise in the living room, before sitting down on the sofa in the living room to watch her favorite TV show. The motion detection system enables Stephen to see the timing of the movement in each of the 3 regions of the house. When the motion agrees with the daily routine, Stephen knows roughly that the mother should be doing fine. But when the motion pattern appears abnormal (e.g. there is no motion until 10 AM, or she stayed in the kitchen for too long, or she remains motionless for too long, etc.), Stephen suspects something is wrong and would call the mother to check on her. Stephen may even get someone (e.g. a family member, a neighbor, a paid personnel, a friend, a social worker, a service provider) to check on his mother.

At some time, Stephen feels like repositioning the Type 2 device. He simply unplugs the device from the original AC power plug and plug it into another AC power plug. He is happy that the wireless motion detection system is plug-and-play and the repositioning does not affect the operation of the system. Upon powering up, it works right away, Sometime later, Stephen is convinced that the disclosed wireless motion detection system can really detect motion with very high accuracy and very low alarm, and he really can use the mobile app to monitor the motion in the ground floor. He decides to install a similar setup (i.e. one Type 2 device and two Type 1 devices) in the second floor to monitor the bedrooms in the second floor. Once again, he finds that the system set up is extremely easy as he simply needs to plug the Type 2 device and the Type 1 devices into the AC power plug in the second floor, No special installation is needed. And he can use the same mobile app to monitor motion in the ground floor and the second floor. Each Type 2 device in the ground floor/second floor can interact with all the Type 1 devices in both the ground floor and the second floor. Stephen is happy to see that, as he doubles his investment in the Type 1 and Type 2 devices, he has more than double the capability of the combined systems.

According to various embodiments, each CI (CI) may comprise at least one of: channel state information (C SI), frequency domain CSI, frequency representation of CSI, frequency domain CSI associated with at least one sub-band, time domain CSI, CSI in domain, channel response, estimated channel response, channel impulse response (CIR), channel frequency response (CFR), channel characteristics, channel filter response, CSI of the wireless multipath channel, information of the wireless multipath channel, timestamp, auxiliary information, data, meta data, user data, account data, access data, security data, session data, status data, supervisory data, household data, identity (ID), identifier, device data, network data, neighborhood data, environment data, real-time data, sensor data, stored data, encrypted data, compressed data, protected data, and/or another CI. In one embodiment, the disclosed system has hardware components (e.g. wireless transmitter/receiver with antenna, analog circuitry, power supply, processor, memory) and corresponding software components. According to various embodiments of the present teaching, the disclosed system includes Bot (referred to as a Type 1 device) and Origin (referred to as a Type 2 device) for vital sign detection and monitoring. Each device comprises a transceiver, a processor and a memory.

The disclosed system can be applied in many cases. In one example, the Type 1 device (transmitter) may be a small WiFi-enabled device resting on the table. It may also be a WiFi-enabled television (TV), set-top box (STB), a smart speaker (e.g. Amazon echo), a smart refrigerator, a smart microwave oven, a mesh network router, a mesh network satellite, a smart phone, a computer, a tablet, a smart plug, etc, In one example, the Type 2 (receiver) may be a WiFi-enabled device resting on the table. It may also be a WiFi-enabled television (TV), set-top box (STB), a smart speaker (e.g. Amazon echo), a smart refrigerator, a smart microwave oven, a mesh network router, a mesh network satellite, a smart phone, a computer, a tablet, a smart plug, etc. The Type 1 device and Type 2 devices may be placed in/near a conference room to count people. The Type 1 device and Type 2 devices may be in a well-being monitoring system for older adults to monitor their daily activities and any sign of symptoms (e.g. dementia, Alzheimer's disease). The Type 1 device and Type 2 device may be used in baby monitors to monitor the vital signs (breathing) of a living baby. The Type 1 device and Type 2 devices may be placed in bedrooms to monitor quality of sleep and any sleep apnea. The Type 1 device and Type 2 devices may be placed in cars to monitor well-being of passengers and driver, detect any, sleeping of driver and detect any babies left in a car. The Type 1 device and Type 2 devices may be used in logistics to prevent human trafficking by monitoring any human hidden in trucks and containers. The Type 1 device and Type 2 devices may be deployed by emergency service at disaster area to search for trapped victims in debris. The Type 1 device and Type 2 devices may be deployed in an area to detect breathing of any intruders. There are numerous applications of wireless breathing monitoring without wearables.

Hardware modules may be constructed to contain the Type 1 transceiver and/or the Type 2 transceiver. The hardware modules may be sold to/used by variable brands to design, build and sell final commercial products. Products using the disclosed system and/or method may be home/office security products, sleep monitoring products, WiFi products, mesh products, TV, STB, entertainment system, HiFi, speaker, home appliance, lamps, stoves, oven, microwave oven, table, chair, bed, shelves, tools, utensils, torches, vacuum cleaner, smoke detector, sofa, piano, fan, door, window, door/window handle, locks, smoke detectors, car accessories, computing devices, office devices, air conditioner, heater, pipes, connectors, surveillance camera, access point, computing devices, mobile devices, LTE devices, 3G/4G/5G/6G devices, UMTS devices, 3GPP devices, GSM devices, EDGE devices, TDMA devices, FDMA devices, CDMA devices, WCDMA devices, TD-SCDMA devices, gaming devices, eyeglasses, glass panels, VR goggles, necklace, watch, waist band, belt, wallet, pen, hat, wearables, implantable device, tags, parking tickets, smart phones, etc.

The summary may comprise: analytics, output response, selected time window, subsampling, transform, and/or projection. The presenting may comprise presenting at least one of: monthly/weekly/daily view, simplified/detailed view, cross-sectional view, small/large form-factor view, color-coded view, comparative view, summary view, animation, web view, voice announcement, and another presentation related to the periodic/repetition characteristics of the repeating motion.

A Type 1/Type 2 device may be an antenna, a device with antenna, a device with a housing (e.g. for radio, antenna, data/signal processing unit, wireless IC, circuits), device that has interface to attach/connect to/link antenna, device that is interfaced to/attached to/connected to/linked to another device/system/computer/phone/network/data aggregator, device with a user interface(UI)/graphical UI/display, device with wireless transceiver, device with wireless transmitter, device with wireless receiver, internet-of-thing (IoT) device, device with wireless network, device with both wired networking and wireless networking capability, device with wireless integrated circuit (IC), Wi-Fi device, device with Wi-Fi chip (e.g. 802.11a/b/g/n/ac/ax standard compliant), Wi-Fi access point (AP), Wi-Fi. client, Wi-Fi router, Wi-Fi. repeater, Wi-Fi hub, Wi-Fi mesh network router/hub/AP, wireless mesh network router, adhoc network device, wireless mesh network device, mobile device (e.g. 2G/2.5G/3G/3.5G/4G/LTE/5G/6G/7G, UMTS, 3GPP, GSM, EDGE, TDMA, FDMA, CDMA, WCDMA, TD-SCDMA), cellular device, base station, mobile network base station, mobile network hub, mobile network compatible device, LTE device, device with LIE module, mobile module (e.g. circuit board with mobile-enabling chip (IC) such as Wi-Fi chip, LTE chip, BLE chip), Wi-Fi chip (IC), LTE chip, BLE chip, device with mobile module, smart phone, companion device (e.g. dongle, attachment, plugin) for smart phones, dedicated device, plug-in device, AC-powered device, battery-powered device, device with processor/memory/set of instructions, smart device/gadget/items: clock, stationary, pen, user-interface, paper, mat, camera, television (TV), set-top-box, microphone, speaker, refrigerator, oven, machine, phone, wallet, furniture, door, window, ceiling, floor, wall, table, chair, bed, night-stand, air-conditioner, heater, pipe, duct, cable, carpet, decoration, gadget, USB device, plug, dongle, lamp/light, tile, ornament, bottle, vehicle, car, AGV, drone, robot, laptop, tablet, computer, harddisk, network card, instrument, racket, ball, shoe, wearable, clothing, glasses, hat, necklace, food, pill, small device that moves in the body of creature (e.g. in blood vessels, in lymph fluid, digestive system), and/or another device. The Type 1 device and/or Type 2 device may be communicatively coupled with: the internet, another device with access to internet (e.g, smart phone), cloud server (e.g. hub device), edge server, local server, and/or storage. The Type 1 device and/or the Type 2 device may operate with local control, can be controlled by another device via a wired/wireless connection, can operate automatically, or can be controlled by a central system that is remote (e.g. away from home).

In one embodiment, a Type B device may be a transceiver that may perform as both Origin (a Type 2 device, a Rx device) and Bot (a Type 1 device, a Tx device), i.e., a Type B device may be both Type 1 (Tx) and Type 2 (Rx) devices (e.g. simultaneously or alternately), for example, mesh devices, a mesh router, etc. In one embodiment, a Type A device may be a transceiver that may only function as Bot (a Tx device), i.e., Type 1 device only or Tx only, e.g., simple IoT devices. It may have the capability of Origin (Type 2 device, Rx device), but somehow it is functioning only as Bot in the embodiment. All the Type A and Type B devices form a tree structure. The root may be a Type B device with network (e.g. internet) access. For example, it may be connected to broadband service through a wired connection (e.g. Ethernet, cable modem, ADSL/HDSL modem) connection or a wireless connection (e.g. LTE, 3G/4G/5G, WiFi, Bluetooth, microwave link, satellite link, etc.), in one embodiment, all the Type A devices are leaf node. Each Type B device may be the root node, non-leaf node, or leaf node.

Type 1 device (transmitter, or Tx) and Type 2 device (receiver, or Rx) may be on same device (e.g. RF chip/IC) or simply the same device. The devices may operate at high frequency band, such as 28 GHz, 60 GHz, 77 GHz, etc. The RF chip may have dedicated Tx antennas (e.g. 32 antennas) and dedicated Rx antennas (e.g. another 32 antennas).

One Tx antenna may transmit a wireless signal (e.g. a series of probe signal, perhaps at 100 Hz). Alternatively, all Tx antennas may be used to transmit the wireless signal with beamforming (in Tx), such that the wireless signal is focused in certain direction (e.g. for energy efficiency or boosting the signal to noise ratio in that direction, or low power operation when “scanning” that direction, or low power operation if object is known to be in that direction).

The wireless signal hits an object (e.g. a living human lying on a bed 4 feet away from the Tx/Rx antennas, with breathing and heart beat) in a venue (e.g. a room). The object motion (e.g. lung movement according to breathing rate, or blood-vessel movement according to heart beat) may impact/modulate the wireless signal. All Rx antennas may be used to receive the wireless signal.

Beamforming Rx and/or Tx) may be applied (digitally) to “scan” different directions. Many directions can be scanned or monitored simultaneously. With beamforming, “sectors” (e.g. directions, orientations, bearings, zones, regions, segments) may be defined related to the Type 2 device (e.g. relative to center location of antenna array). For each probe signal (e.g. a pulse, an ACK, a control packet, etc.), a channel information or CI (e.g. channel impulse response/CIR, CSI, CFR) is obtained/computed for each sector (e.g. from the RF chip). In breathing detection, one may collect CIR in a sliding window (e.g. 30 sec, and with 100 Hz sounding/probing rate, one may have 3000 CIR over 30 sec).

The CIR may have many taps (e.g. N1 components/taps). Each tap may be associated with a time lag, or a time-of-flight (tof, e.g. time to hit the human 4 feet away and back). When a person is breathing in a certain direction at a certain distance (e.g. 4 ft), one may search for the CIR in the “certain direction”. Then one may search for the tap corresponding to the “certain distance”. Then one may compute the breathing rate and heart rate from that tap of that CIR.

One may consider each tap in the sliding window e.g. 30 second window of “component time series”) as a time function (e.g. a “tap function”, the “component time series”). One may examine each tap function in search of a strong periodic behavior (e.g. corresponds to breathing, perhaps in the range of 10 bpm to 40 bpm).

The Type 1 device and/or the Type 2 device may have external connections/links and/or internal connections/links. The external connections (e.g. connection 1110) may be associated with 2G/2.5G/3G/3.5G/4G/LTE/5G/6G/7G/NBIoT, UWB, WiMax, Zigbee, 802.16 etc. The internal connections (e.g., 1114A and 1114B, 1116, 1118, 1120) may be associated with WiFi, an IEEE 802.11 standard, 802.11a/b/g/n/ac/ad/af/ag/ah/ai/aj/aq/ax/ay, Bluetooth, Bluetooth 1.0/1.1/1.2/2.0/2.1/3.0/4.0/4.1/4.2/5, BLE, mesh network, an IEEE 802.16/1/1a/1b/2/2a/a/b/c/d/e/f/g/h/i/j/k/l/m/n/o/p/standard.

The Type 1 device and/or Type 2 device may be powered by battery (e.g. AA battery, AAA battery, coin cell battery, button cell battery, miniature battery, bank of batteries, power bank, car battery, hybrid battery, vehicle battery, container battery, non-rechargeable battery, rechargeable battery, NiCd battery, NiMH battery, Lithium ion battery, Zinc carbon battery, Zinc chloride battery, lead acid battery, alkaline battery, battery with wireless charger, smart battery, solar battery, boat battery, plane battery, other battery, temporary energy storage device, capacitor, fly wheel).

Any device may be powered by DC or direct current (e g. from battery as described above, power generator, power convertor, solar panel, rectifier, DC-DC converter, with various voltages such as 1.2V, 1.5V, 3V, 5V, 6V, 9V, 12V, 24V, 40V, 42V, 48V, 110V, 220V, 380V, etc.) and may thus have a DC connector or a connector with at least one pin for DC power.

Any device may be powered by AC or alternating current (e.g. wall socket in a home, transformer, invertor, shorepower, with various voltages such as 100V, 110V, 120V, 100-127V, 200V, 220V, 230V, 240V, 220-240V, 100-240V, 250V, 380V, 50 Hz, 60 Hz, etc.) and thus may have an AC connector or a connector with at least one pin for AC power. The Type 1 device and/or the Type 2 device may be positioned (e.g. installed, placed, moved to) in the venue or outside the venue.

For example, in a vehicle (e.g. a car, truck, lorry, bus, special vehicle, tractor, digger, excavator, teleporter, bulldozer, crane, forklift, electric trolley, AGV, emergency vehicle, freight, wagon, trailer, container, boat, terry, ship, submersible, airplane, air-ship, lift, mono-rail, train, tram, rail-vehicle, railcar, etc.), the Type 1 device and/or Type 2 device may be an embedded device embedded in the vehicle, or an add-on device (e.g. aftermarket device) plugged into a port in the vehicle (e.g. OBD port/socket, USB port/socket, accessory port/socket, 12V auxiliary power outlet, and/or 12V cigarette lighter port/socket).

For example, one device (e.g. Type 2 device) may be plugged into 12V cigarette lighter/accessory port or OBD port or the USB port (e.g. of a car/truck/vehicle) while the other device (e.g. Type 1 device) may be plugged into 12V cigarette lighter/accessory port or the OBD port or the USB port. The OBD port and/or USB port can provide power, signaling and/or network (of the car/truck/vehicle). The two devices may jointly monitor the passengers including children/babies in the car. They may be used to count the passengers, recognize the driver, detect presence of passenger in a particular seat/position in the vehicle.

In another example, one device may be plugged into 12V cigarette lighter/accessory port or OBD port or the USB port of a car/truck/vehicle while the other device may be plugged into 12V cigarette lighter/accessory port or OBD port or the USI3 port of another car/truck/vehicle.

In another example, there may be many devices of the same type A (e.g. Type 1 or Type 2) in many heterogeneous vehicles/portable devices/smart gadgets (e.g. automated guided vehicle/AGV, shopping/luggage/moving cart, parking ticket, golf cart, bicycle, smart phone, tablet, camera, recording device, smart watch, roller skate, shoes, jackets, goggle, hat, eye-wear, wearable, Segway, scooter, luggage tag, cleaning machine, vacuum cleaner, pet tag/collar/wearable/implant), each device either plugged into 12V accessory port/OBD port/USB port of a vehicle or embedded in a vehicle. There may be one or more device of the other type B (e.g. B is Type 1 if A is Type 2, or B is Type 2 if A is Type 1) installed at locations such as gas stations, street lamp post, street corners, tunnels, multi-storey parking facility, scattered locations to cover a big area such as factory/stadium/train station/shopping mall/construction site. The Type A device may be located, tracked or monitored based on the TSCI.

The area/venue may have no local connectivity, e.g., broadband services, WiFi, etc. The Type 1 and/or Type 2 device may be portable. The Type 1 and/or Type 2 device may support plug and play.

Pairwise wireless links may be established between many pairs of devices, forming the tree structure. In each pair (and the associated link), a device (second device) may be a non-leaf (Type B). The other device (first device) may be a leaf (Type A or Type B) or non-leaf (Type B). In the link, the first device functions as a bot (Type 1 device or a Tx device) to send a wireless signal (e.g. probe signal) through the wireless multipath channel to the second device. The second device may function as an Origin (Type 2 device or Rx device) to receive the wireless signal, obtain the TSCI and compute a “linkwise analytics” based on the TSCI.

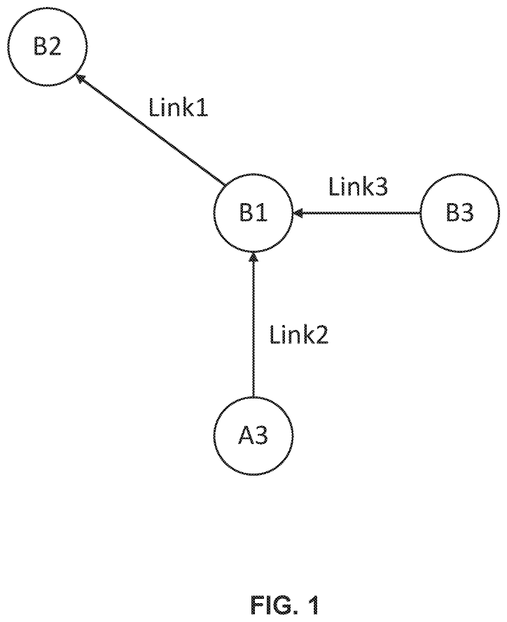

When a pairwise link Link1 comprises of two Type B devices (i.e. when both the first device and the second device are Type B devices), something special happened, as shown in FIG. 1. Let B1 be the first device (Tx, transmit probe signal) and B2 be the second device (Rx, obtain TSCI, compute linkwise analytics) in the current link. In addition to the current link, B1 may be in addition links (e.g. a Link2 connecting B1 to a Type A device called A3, a Link3 connecting B1 to another Type B device called B3 ).

In Link-2, A3 is Tx and transmits probe signal while B1 is Rx and computes linkwise analytics. This linkwise analytics will be transmitted from B1 to B2 in Link1.

In Link3, B3 is Tx and transmits probe signal while B1 is Rx and computes linkwise analytics. This linkwise analytics will be transmitted from B1 to B2 in Link1. Furthermore, B3 may have obtained some linkwise analytics and may transmit/pass along to B1 in Link3. These linkwise analytics may be sent from B1 to B2 in Link1.

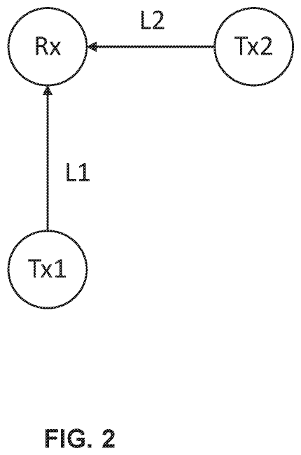

Another exemplary system (mesh network) topology is shown in FIG. 2, Two Type 1 devices (transmitter, or Tx, or Bot) are linked to one Type 2 device (receiver, or Rx, or Origin) via some radio interface links L1 and L2. The routing format may be like “TxID:iframe:hwaddr”, where “TxId” is the identifier (that may be unique) of the device, “ifname” is the interface name, and “hwaddr” is the MAC address used for communication. Then, the routing table for the topology shown in FIG. 1 may be routing={Tx1:L1:Tx1_mac, Tx2:L2:Tx2_mac}.

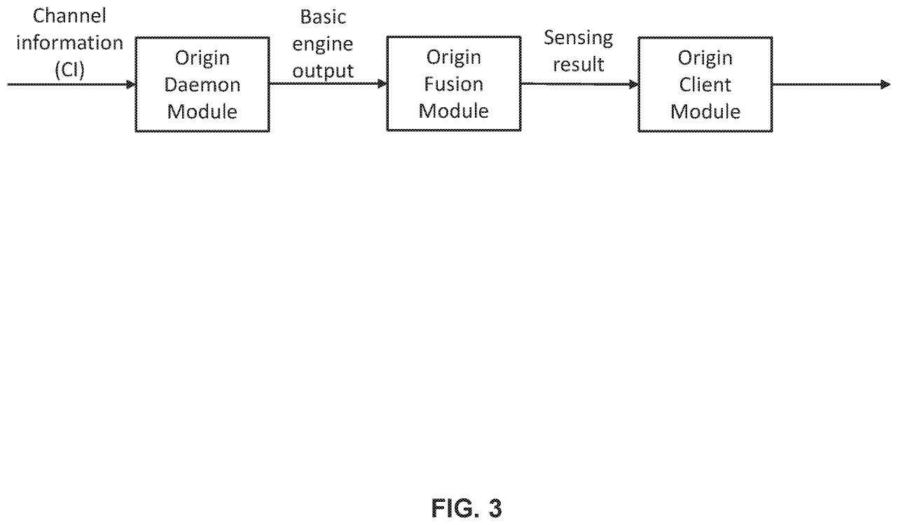

Additional functionalities may be associated with the Rx in order to pass the sensing outputs to the cloud. In this case, the Rx may be a “Master Origin”. For example, in FIG. 3, the Master Origin (MO) may be composed of a daemon module, a fusion module, and a client module. The daemon module may receive channel state information (CSI)/channel information (CI) sent from other devices, e.g., Bots, for sensing. The MOs may consist of basic engines that support different applications, such as motion engine, breathing engine, etc., which may output motion statistics, breathing rates, etc. These outputs may also be called “radio analytics”, because they are analytics calculated based on the CSI extracted from radio signals. These outputs are then fed into the fusion module for the different applications, such as home security, sleep monitoring, wellbeing monitoring, child presence detection, etc. Final results may be determined in the fusion module, and fed into the client module to be sent to the cloud via Ethernet connection through a hub. Another cloud fusion module may be run in the cloud.

FIG. 2 shows an example of only one daemon module existing in the mesh network. In certain cases, more than one daemon module may be required to boost calculation capability. The reason for multiple origin daemon is to perform basic engine sensing on the links that do not have direct link to the master origin (MO). One needs to have Origin daemon module to receive the channel state information (CSI) from the local wireless LAN (WLAN) driver and calculate the basic engine output that consumes CSI. One may do the fusion of the basic engine results in the Origin fusion module in a MO.

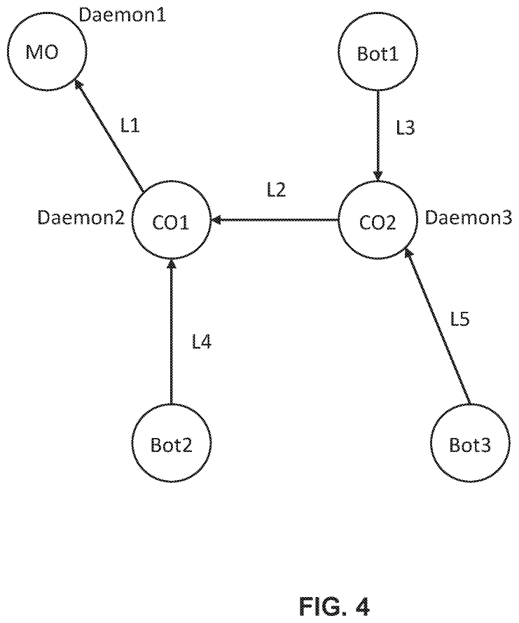

Another example with more than one daemon module is shown in FIG. 4. There is one Master Origin (MO), two Child Origins (CO), and three Bots. Different from the MO, the CO may not have the fusion and client modules, and include only the daemon module. The MO connects every local device to cloud through a client module. Here, L1, L2, L3, L4, L5 are radio interface links connecting two devices. Routing format may be like “TxID:origindaemon_IP:ifname:hwaddr”, where “TxId” is the identifier (that should be unique) of the transmitting device, “origindaemon_IP” is the local area network (LAN) IP address of the receiving node running the local origin daemon, “ifname” is the interface name of the radio link to the TxID device, and “hwaddr” is the MAC address used to identify the device in the wireless LAN (WLAN) driver. The routing table for this topology becomes {CO1:MO_IP:L1:CO1_mac, CO2:CO1_IP:L2:CO2 mac, B1:CO2_IP:L3:B1 mac, B2:CO1_IP:L4:B2 mac, B3:CO2_IP:L5:B3_mac}. The IP addresses may be used to open UDP socket connections between the MO and all daemon modules on the local LAN.

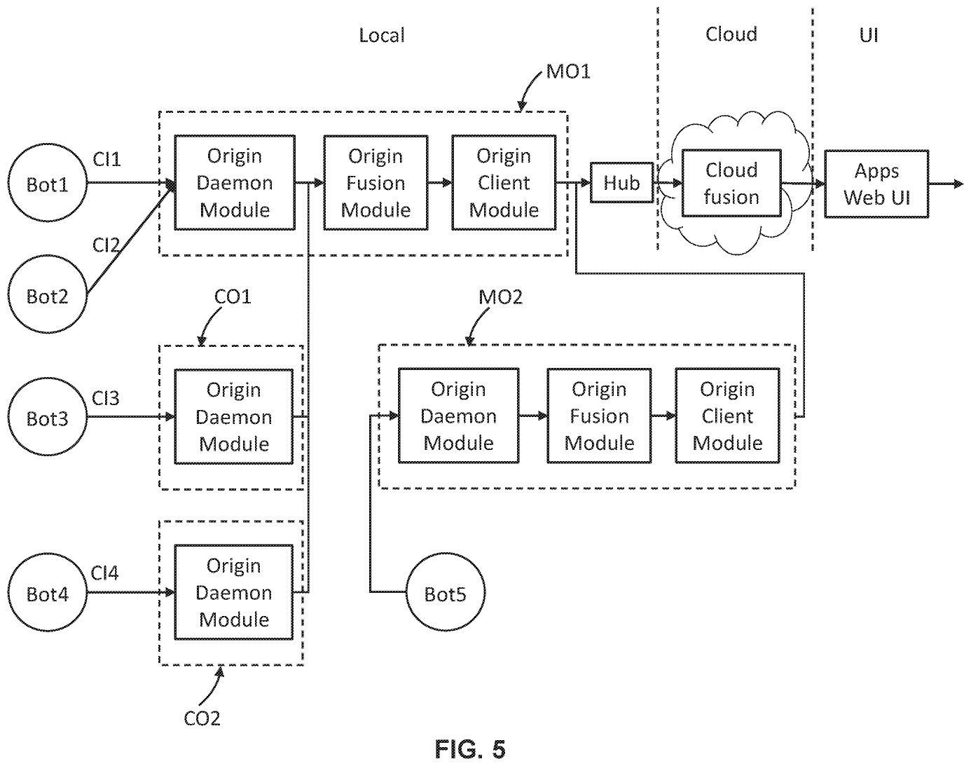

Another exemplary topology is shown in FIG. 5, where there are two MOs {MO1, MO2}, two COs {CO1, CO2}, and five Bots B1-B5. Both MO1 and MO2 may send final results to the cloud through the hub. The output from the cloud may be sent to some user interface (UI) in user apps or web UI.

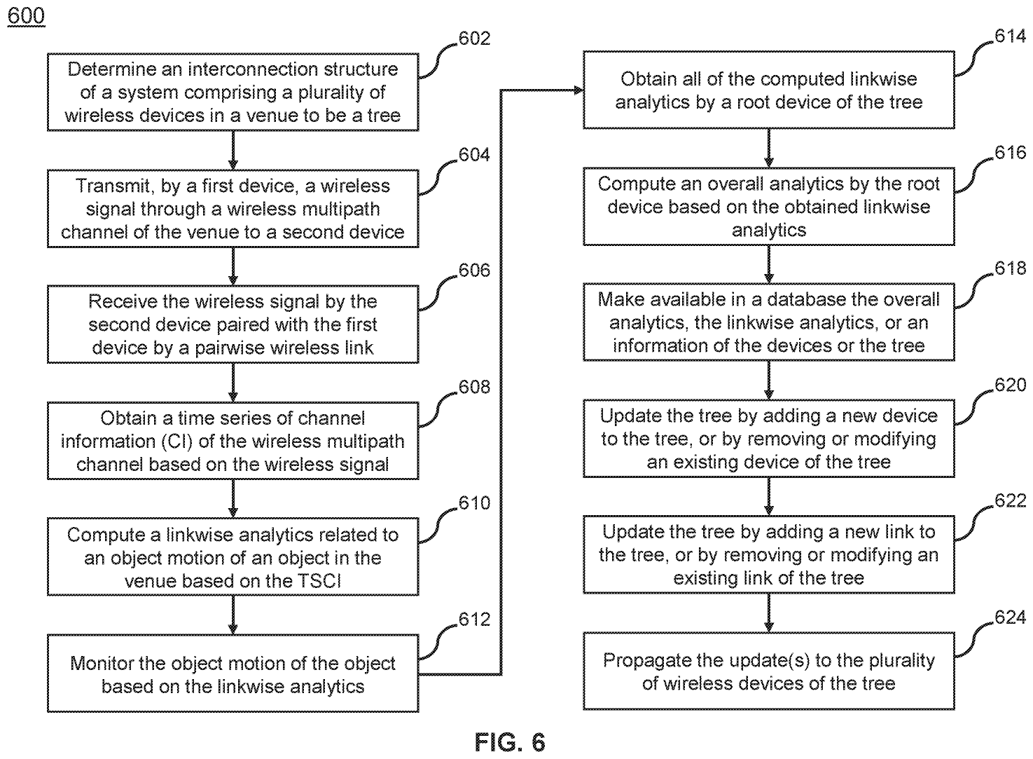

FIG. 6 illustrates a flow chart of an exemplary method 600 for analyzing and improving network topology, according to some embodiments of the present teaching. At operation 602, an interconnection structure of a wireless sensing system comprising a plurality of wireless devices in a venue is determined to be a tree. At operation 604, a wireless signal is transmitted by a first device through a wireless multipath channel of the venue to a second device. At operation 606, the wireless signal is received by the second device paired with the first device by a pairwise wireless link. At operation 608, a time series of channel information (CI) of the wireless multipath channel is obtained based on the wireless signal. At operation 610, a linkwise analytics related to an object motion of an object in the venue is computed based on the TSCI. At operation 612, the object motion of the object is monitored based on the linkwise analytics.

At operation 614, all of the computed linkwise analytics are obtained by a root device of the tree. At operation 616, an overall analytics is computed by the root device based on the obtained linkwise analytics. At operation 618, the overall analytics, the linkwise analytics, or an information of the devices or the tree is made available in a database. Optionally at operation 620, the tree is updated by adding a new device to the tree, or by removing or modifying an existing device of the tree. Optionally at operation 622, the tree is updated by adding a new link to the tree, or by removing or modifying an existing link of the tree. At operation 624, the update(s) are propagated to the plurality of wireless devices of the tree. The order of the operations in FIG. 6 may be changed in various embodiments of the present teaching.

In various embodiments of the present teaching, an exemplary method for analyzing and improving topology and architecture of a wireless sensing system is disclosed in the following clauses.

This emphasizes the tree structure and computation of linkwise analytics, but not movement of the linkwise analytics. In another embodiment, it emphasizes the movement of linkwise analytics are computed in Type B devices and sent towards the root.

Clause 1. A method of a tree-structured wireless sensing system, comprising: determining that there are a plurality of wireless devices in a venue, each device being at least one of: a Type A heterogeneous wireless device and a Type B heterogeneous wireless device, wherein each Type A device has at least one wireless transmitter capable of transmitting RF signals, wherein each Type B device has at least one wireless transceiver capable of both transmitting and receiving RF signals; determining a tree interconnection structure of the plurality of wireless devices comprising of: all wireless devices being nodes of the tree with each Type A device being a leaf of the tree, and each Type B device being either a leaf or a non-leaf of the tree, a Type B device being the root of the tree, and at least one pairwise wireless link each being a branch of the tree, wherein each wireless link connects a pair of the wireless devices at least one of which being a Type B device; storing an information of the plurality of wireless devices and the tree interconnection structure in a database; in each pairwise wireless link connecting a first device and a second device, wherein the first device is at least one of: a Type A device and a non-root Type B device, and the second device is a Type B device: transmitting a wireless signal through a wireless multipath channel of the venue to the second device by the first device using a processor, a memory and a set of instructions of the first device, wherein the wireless multipath channel is impacted by an object motion of an object in the venue, receiving the wireless signal by the second device using a processor, a memory and a set of instruction of the second device, obtaining a time series of channel information (CI) of the wireless multipath channel from the wireless signal, monitoring the object motion based on the time series of CI (TSCI), and computing a linkwise analytics related to the object motion based on the TSCI.

In another embodiment, the root device may have network access (e.g. internet access)

Clause 2. The method of the tree-structured wireless sensing system of clause 1: wherein the root Type B device is a gateway device with network access through at least one of: a wired network connection and a wireless network connection; wherein the network access comprises access to at least one of: internet, PAN, LAN, WLAN, CAN, MAN, WAN, SAN, and another network; wherein the wired network connection comprises at least one of: an Ethernet, a token ring, an FDDI, an optical fiber, a cable modem, a DSL modem, an ADSL modem; a HDSL modem, and another wired network connection; wherein the wireless network connection comprises at least one of: WiFi, LTE, 3G, 4G, 5G, 6G, Bluetooth, BLE, RFID, microwave link, satellite link and another wireless network connection.

In another embodiment, the tree structure (including, routing table) may be maintained (stored and updated) by a server.

Clause 3. The method of the tree-structured wireless sensing system of clause 1, further comprising: storing the information of the plurality of wireless devices and the tree interconnection structure in the database in a server; and updating the database in the server, wherein the server is at least one of: one of the plurality of wireless devices, a local device, a cloud device, a dedicated device, and another device.

In another embodiment, the tree structure(including routing table) may be maintained (stored and updated) by a server.

Clause 4. The method of the tree-structured wireless sensing system of clause 1: wherein the information of the plurality of wireless devices and the tree interconnection structure in the database to comprise at least one of: an identifier (ID) of the tree, an address of the tree, a setting of the tree, an attribute of the tree, a structure of the tree, an identifier (ID) of the venue associated with the tree, a physical location of the venue associated with the tree, an address of the venue associated with the tree, a cost associated with the tree, another association of the tree, an identifier (ID) of each of the plurality of wireless devices, an address of each wireless device comprising at least one of: an IP address, a MAC address and another address, a setting of each wireless device, an attribute of each wireless device, a physical location of the venue associated with each wireless device, a region of the venue associated with each wireless device, a cost associated with each wireless device, another association of each wireless device, an ID of a root device, a description of each pairwise wireless link comprising at least one of: an identifier (ID) of the link, a setting of the link, an attribute of the link, a physical location of the venue associated with the link, a physical region of the venue associated with the link, an event associated with the link, a cost associated with the link, another association of the link, a Type 1 heterogeneous wireless device, a transmitting wireless device, a Tx device, an ID of the transmitting wireless device, and a Type 2 heterogeneous wireless device, a receiving wireless device, an Rx device, an ID of the receiving wireless device, a MAC address of the receiving wireless device, and a routing table comprising at least one of: the description of the pairwise wireless links, a routing of data from a wireless device towards another wireless device through the pairwise wireless links, and a routing of linkwise analytics towards at least one of: a destination device, a root device, a local server and a cloud server, a distance of each wireless device to the root device, and a count of pairwise wireless links between each wireless device and a destination device.

In another embodiment, the routing table may be updated.

Clause 5. The method of the tree-structured wireless sensing system of clause 1, further comprises: updating at least one of: the information and a routing table.

In another embodiment, the routing table may be used to find an optimal path.

Clause 6. The method of the tree-structured wireless sensing system of clause 1, further comprises: finding a path to send data through the nodes of the tree towards a destination device based on at least one of: the information, a routing table, a requirement and a criterion.

In another embodiment, the path may be changed, e.g. due to traffic jam, device malfunction, device unavailable, bad performance of a link, updated tree/routing table/information, change in destination, change in requirement, change in selection criterion, etc.

Clause 7. The method of the tree-structured wireless sensing system of clause 6, further comprises: changing the path based on at least one of: updated destination, updated information, updated routing table, updated requirement and updated criterion.

In another embodiment, the routing table may be used to route the linkwise analytics towards the root device (e.g. to be analyzed or to be send to cloud). “Routing” may mean the use of a particular path (e.g. a sequence of pairwise wireless links). Routing may comprise controlling, directing, communicating, sending, transmitting, etc.

Clause 8. The method of the tree-structured wireless sensing system of clause 1, further comprises: routing a linkwise analytics towards the root device of the tree based on at least one of: a routing table, and the information of the plurality of wireless devices and the tree interconnection structure.

In another embodiment, rerouting may be needed, e.g. due to traffic jam, device malfunction, device unavailable, bad performance of a link, updated tree/routing table/information, change in destination, change in requirement, change in selection criterion, etc. Updating may comprise: modifying, changing, adjusting, etc.

Clause 9. The method of the tree-structured wireless sensing system of clause 8, further comprises: updating the routing based on at least one of: updated destination, updated information, updated routing table, updated requirement and updated criterion.

Clause 10. The method of the tree-structured wireless sensing system of clause 1, further comprises: transmitting a link-wise analytics through a number of nodes of the tree to the root device of the tree based on at least one of: a routing table, and the information of the plurality of wireless devices and the tree interconnection structure.

In another embodiment, the pairwise link may be associated with location, region, object motion, trajectory Updating the routing table.

Clause 11. The method of the tree-structured wireless sensing system of clause 1, further comprises: identifying at least one pairwise wireless link of the tree is associated with a target region of the venue based on at least one of: the information and a routing table.

In another embodiment, one may find links that are associated with object motion (e.g. find links associated with regions in or near which object motion occurs),e.g. find links associated with regions that are near where some event (e.g. fall down, presence, motion, activity) occurs.

Clause 12. The method of the tree-structured wireless sensing system of clause 1, further comprises: identifying at least one pairwise wireless link of the tree is associated with the object motion of the object in the venue based on at least one of: the information and a routing table.

In another embodiment, one may find pairwise wireless links that are associated with object's motion path/trajectory, e.g. in trajectory planning for an object (e.g. person, customer to pick up multiple items in different locations of a store/facility, emergency personnel, car, vehicle), the links associated with the planned trajectory will be especially monitored to monitor the object.

Clause 13. The method of the tree-structured wireless sensing system of clause 1, further comprises: identifying at least one pairwise wireless link of the tree is associated with a trajectory of the object moving through the venue based on at least one of: the information and a routing table.

In another embodiment, one may be forwarding/sending of linkwise analytics in links with two Type B devices, and the linkwise analytics may be moved across the tree among the Type B devices (internal branches) towards the root.

Clause 14. The method of the tree-structured wireless sensing system of clause 1, further comprising: in each pairwise wireless link connecting a first wireless device and a second wireless device, wherein both the first device and second device are Type B devices: transmitting at least one linkwise analytics related to the object motion of the object in the venue by the first device to the second device, receiving the at least one linkwise analytics by the second device, and monitoring the object motion based on the at least one linkwise analytics.

The link-wise analytics may be sent in the same direction as the wireless signal.

Clause 15. The method of the tree-structured wireless sensing system of clause 1: wherein a wireless signal is transmitted by the first device to the second device.

linkwise analytics may be sent in the opposite direction as the wireless signal.

Clause 16. The method of the tree-structured wireless sensing system of clause 1: wherein a wireless signal is transmitted by the second device to the first device.

Root device operations may comprise: compute overall analytics, share results with cloud server/user device, root device may receive all linkwise analytics, analyze and summarize (compute overall analytics)

Clause 17. The method of the tree-structured wireless sensing system of clause 1, further comprising: obtaining all the linkwise analytics by the root device, monitoring the object motion by the root device based on all the linkwise analytics, and computing at least one overall analytics by the root device based on all the linkwise analytics.

Some linkwise analytics may be computed by root device.

Clause 18. The method of the tree-structured wireless sensing system of clause 17, further comprising: receiving at least one wireless signal by the root device from at least one of the plurality of wireless devices, obtaining at least one TSCI by the root device from the at least one wireless signal, and computing at least one linkwise analytics by the root device based on the at least one TSCI.

Root device may share/upload overall/linkwise analytics.

Clause 19. The method of the tree-structured wireless sensing system of clause 17, further comprising: making at least one of: an overall analytics, an linkwise analytics, and a portion of the information of the plurality of wireless devices and the tree interconnection structure in the database available through a network by the root device.

Root device may message user device.

Clause 20. The method of the tree-structured wireless sensing system of clause 1, further comprising: transmitting a message by the root device to a user device through a network based on the overall analytics, the linkwise analytics, and the information of the plurality of wireless devices and the tree interconnection structure in the database.

A Type A device may have Type B device capability.

Clause 21. The method of the tree-structured wireless sensing system of clause 1: wherein a Type A device has at least one wireless receiver.

A Type B device may be active in two links (transmitting in one and receiving in another) simultaneously.

Clause 22. The method of the tree-structured wireless sensing system of clause 1: wherein a Type B device receives a first wireless signal from a first wireless device and transmits a second wireless signal to a second wireless device in at least one of: simultaneous manner, concurrent manner, alternative manner, contemporaneous manner, and asynchronous manner.

A Type B device may have two radios so that it can transmit and receive simultaneously.

Clause 23. The method of the tree-structured wireless sensing system of clause 1: wherein a Type B device has at least two radios such that it uses a first radio to receive a first wireless signal from a first wireless device and uses a second radio to transmit a second wireless signal to a second wireless device simultaneously and asynchronously.

A device (Type A or Type B, leaf node or non-leaf node) may send probing signal to two Type B devices.

Clause 24. The method of the tree-structured wireless sensing system of clause 1: wherein one of the plurality of wireless devices is in more than one pairwise wireless links; wherein the device sends a first wireless signal to a first Type B device in a first link; wherein the device sends a second wireless signal to a second Type B device in a second link; wherein each of the first and second Type B devices receives the respective wireless signal, obtains a respective TSCI from the respective wireless signal; and computes a respective linkwise analytics based on the respective TSCI.

A device (Type A or Type B, leaf node or non-leaf node) may send probing signal to two Type B devices.

Clause 25. The method of the tree-structured wireless sensing system of clause 24: wherein the device sends at least one pairwise analytics to at least one of: the first Type B device and the second Type B device.

A device (Type A or Type B, leaf node or non-leaf node) may broadcast a probing signal to two Type B devices in a broadcasting manner.

Clause 26. The method of the tree-structured wireless sensing system of clause 1: wherein one of the plurality of wireless devices is in more than one pairwise wireless links; wherein the device sends a wireless signal in a broadcasting manner to the more than one respective Type B devices associated with the more than one pairwise wireless links; wherein each of the more than one Type B devices receives the wireless signal, obtains a respective TSCI from the wireless signal, and computes a respective linkwise analytics based on the respective TSCI.

A device (Type A or Type B, leaf node or non-leaf node) may send probing signal to two Type B devices.

Clause 27. The method of the tree-structured wireless sensing system of clause 26: wherein the device sends at least one pairwise analytics to at least one of the more than one Type B devices.

One may modify the tree structure. Basic operations may comprise: add/remove device, rearrange/add/remove link (with/without adding or removing devices) modify the tree by changing the pairwise links among the wireless devices, without changing (i.e. without adding/subtracting) the wireless devices.

Clause 28. The method of the tree-structured wireless sensing system of clause 1, further comprising: modifying the tree by modifying the pairwise wireless links without adding any new wireless device or removing any existing wireless device; updating the information of the plurality of the wireless device and the tree interconnection structure in the database.

Clause 29. The method of the tree-structured wireless sensing system of clause 1, further comprising: modifying the tree by rearranging the pairwise wireless links among the set of the plurality of wireless devices, while keeping the composition of the set unchanged; updating the information of the plurality of the wireless device and the tree interconnection structure in the database.

One may modify the tree by changing the pairwise links among the wireless devices, without changing (i.e. without adding/subtracting) the wireless devices.

Clause 30. The method of the tree-structured wireless sensing system of clause 1, further comprising: modifying the tree by at least one of: adding a new wireless device, and removing an existing wireless device, wherein the new wireless device is at least one of: a Type A device and a Type B device, a leaf node, a non-leaf node and a root node, wherein the existing wireless device is at least one of: a Type A device and a Type B device, a leaf node, a non-leaf node and a root node; updating the information of the plurality of the wireless device and the tree interconnection structure in the database.

One may modify the tree by changing the root device.

Clause 31. The method of the tree-structured wireless sensing system of clause 1, further comprising: modifying the tree by changing the root device, and replacing it by another of the plurality of wireless devices; updating the information of the plurality of the wireless device and the tree interconnection structure in the database.

One may modify the tree by choosing a new root device. Same as previous claim, with different wording.

Clause 32. The method of the tree-structured wireless sensing system of clause 1, further comprising: modifying the tree by choosing a new root device from among the plurality of wireless devices and changing at least one pairwise wireless links; updating the information of the plurality of the wireless device and the tree interconnection structure in the database.

One may modify the tree by changing the pairwise links among the wireless devices, without changing (i.e. without adding/subtracting) the wireless devices.

Clause 33. The method of the tree-structured wireless sensing system of clause 1, further comprising: modifying the tree by at least one of: adding a new pairwise wireless link, and removing an existing pairwise wireless link; updating the information of the plurality of the wireless device and the tree interconnection structure in the database.

One may remove an existing link without removing any device.

Clause 34. The method of the tree-structured wireless sensing system of clause 33, further comprising: modifying the tree by removing an existing pairwise wireless link of the tree without removing any wireless device of the tree; and updating the information of the plurality of the wireless device and the tree interconnection structure in the database.

One may remove an existing link by removing a device.

Clause 35. The method of the tree-structured wireless sensing system of clause 33, further comprising: modifying the tree by removing an existing pairwise wireless link of the tree by removing a wireless device of the tree; and updating the information of the plurality of the wireless device and the tree interconnection structure in the database.

One may add a new link without adding new device.

Clause 36. The method of the tree-structured wireless sensing system of clause 33, further comprising: modifying the tree by adding a new pairwise wireless link of the tree without adding any new wireless device to the tree; and updating the information of the plurality of the wireless device and the tree interconnection structure in the database.

One may add a new link by adding a new device.

Clause 37. The method of the tree-structured wireless sensing system of clause 33, further comprising: modifying the tree by adding a new pairwise wireless link of the tree by adding a new wireless device to the tree; and updating the information of the plurality of the wireless device and the tree interconnection structure in the database.

One may add a new wireless device. Server operation may comprise: request and control signals for adding a new device to the tree (receive request and send control signals to establish pairwise wireless link).

Clause 38. The method of the tree-structured wireless sensing system of clause 3, further comprising: sending a request to the server to add a new wireless device to the plurality of wireless devices as a node of tree; sending control signals to the new wireless device and at least one existing device of the tree such that at least one pairwise wireless link is established between the new wireless device and the at least one existing devices; updating at least one of: a routing table and the information of the plurality of wireless devices and the tree interconnection structure in the database.

New device (can be Type A or Type B device) may send probing signal to an existing (Type B, Origin/Rx) device in a pairwise wireless link.

Clause 39. The method of the tree-structured wireless sensing system of clause 38, further comprising: transmitting a wireless signal by the new wireless device to one of the at least one existing device in one of the at least one pairwise wireless link, wherein the existing device is a Type B device.

New device (as a bot/Tx device) may be Type B and may send/transmit/communicate linkwise analytics to the Origin/Tx device.

Clause 40. The method of the tree-structured wireless sensing system of clause 39, further comprising: wherein the new wireless device is a Type B device, transmitting at least one linkwise analytics related to the object motion by the new wireless device to the existing device in the pairwise wireless link.

The new device (can be Type A or Type B) may probe more than one Origin/Rx (Type B) device.

Clause 41. The method of the tree-structured wireless sensing system of clause 39, further comprising: transmitting another wireless signal by the new wireless device to another one of the at least one existing device in another one of the at least one pairwise wireless link, wherein the another existing device is a Type B device.

The new device may be a Type B device functioning as an Origin/Rx device, receiving probe signal from a Bot/Tx device (which may be a Type A device or a Type B device).

Clause 42. The method of the tree-structured wireless sensing system of clause 38, further comprising: wherein the new wireless device is a Type B device; receiving by the new wireless device a wireless signal from one of the at least one existing device in one of the at least one pairwise wireless link.

Server operation may comprise: the new device may receive linkwise analytics from the Bot, in the case of the Bot being a Type B device.

Clause 43. The method of the tree-structured wireless sensing system of clause 42, further comprising: wherein the existing device is a Type B device; receiving at least one linkwise analytics related to the object motion from the existing device in the pairwise wireless link.

One may remove an existing wireless device. The server may receive a request to remove a device (e.g. Type A or Type B) from the tree and send control signals to remove one or more links related to the device. The device may be a leaf node or a non-leaf node.

Clause 44. The method of the tree-structured wireless sensing system of clause 3, further comprising: sending a request to the server to remove an existing wireless device from the tree; sending control signals to the existing wireless device and at least one other device of the tree such that at least one pairwise wireless link associated with the existing wireless device is removed.

Clause 45. The method of the tree-structured wireless sensing system of clause 3, further comprising: sending a request to the server to remove an existing wireless devices from the tree; sending control signals to the existing wireless device and a first device of the tree such that a first pairwise wireless link between them is removed; sending control signals to the wireless device and a second device of the tree such that a second pairwise wireless link between them is removed; sending control signals to the first device and the second device such that a new pairwise wireless link is established between the them.

Clause 46. The method of the tree-structured wireless sensing system of clause 45: wherein the first device sends a first wireless signal to the wireless device in the first pairwise wireless link; wherein the wireless device sends a second wireless signal to the second device in the second pairwise wireless link; wherein the first device sends a third wireless signal to the second device in the new pairwise wireless link.

Clause 47. The method of the tree-structured wireless sensing system of clause 1, further comprising: adding a new wireless device to the plurality of wireless devices as a leaf node of the tree, wherein the new wireless device is at least one of: a Type A device and a Type B device.

A new device (which may be Type A or Type B) may be added to the tree by linking with an existing device (e.g. Type A or Type B). The new device may be a leaf node or a non-leaf node.

Clause 48. The method of the tree-structured wireless sensing system of clause 1, further comprising: adding a new wireless device to the plurality of wireless devices as a node of the tree, adding a new pairwise wireless link between the new device and an existing wireless device of the tree, updating the information of the plurality of the wireless device and the tree interconnection structure in the database, transmitting a wireless signal by the new device to the existing device, receiving the wireless signal by the existing device, obtaining a TSCI by the existing device from the wireless signal, monitoring the object motion by the existing device based on the TSCI, and computing a link-wise analytics by the existing device based on the TSCI.

The new device may be added to the tree by linking with an existing Type A (Tx) device, converting the Type A (Tx) device to a Type B (Rx) device as Rx device should be a Type B device.

Clause 49. The method of the tree-structured wireless sensing system of clause 48, further comprising: wherein the existing device is a Type A device, converting the existing device to a Type B device.

The new Type B device may receive analytics from other Type B device(s).

Clause 50. The method of the tree-structured wireless sensing system of clause 48, further comprising: wherein the new device is a Type B device, adding another new pairwise wireless link between the new device and another existing wireless device of the tree, receiving a wireless signal by the new device from the another existing device, obtaining a TSCI by the new device from the wireless signal, monitoring the object motion by the new device based on the TSCI, and computing a linkwise analytics by the new device based on the TSCI.

The new Type B device may receive analytics from other Type B device(s).

Clause 51. The method of the tree-structured wireless sensing system of clause 48, further comprising: wherein the new device is a Type B device, receiving at least one linkwise analytics by the new device from another device.

One may add a new device (Type B) as non-leaf node.

Clause 52. The method of the tree-structured wireless sensing system of clause 1, further comprising: adding a new wireless device to the plurality of wireless devices as a non-leaf node to the tree, wherein the new device is a Type B device.

One may add a new device (Type B) which may receive wireless signal from an existing device. obtain TSCI, and compute linkwise analytics.

Clause 53. The method of the tree-structured wireless sensing system of clause 1, further comprising: adding a new wireless device to the plurality of wireless devices as a non-leaf node to the tree, wherein the new device is a Type B device, adding a new pairwise wireless link between the new device and an existing wireless device of the tree, updating the information of the plurality of the wireless device and the tree interconnection structure in the database, receiving a wireless signal by the new device from the existing device, obtaining a TSCI by the new device from the wireless signal, monitoring the object motion by the new device based on the TSCI, and computing a linkwise analytics by the new device based on the TSCI.

The new device (Type B) may send the self-computed linkwise analytics to another existing device (towards the root device)

Clause 54. The method of the tree-structured wireless sensing system of clause 53, further comprising: sending the linkwise analytics by the new device to another existing device.

The new device may receive linkwise analytics from the existing device.

Clause 55. The method of the tree-structured wireless sensing system of clause 53, further comprising: wherein the existing device is a Type B device, receiving at least one linkwise analytics by the new device from the existing device.

The new device may monitor object motion jointly by using (1) self-computed linkwise analytics, and (2) received linkwise analytics from the existing device.

Clause 56. The method of the tree-structured wireless sensing system of clause 55, further comprising: monitoring the object motion by the new device based jointly on all the linkwise analytics.

The new device may forward/send the received (not the self-computed) linkwise analytics to another existing device (towards the root device).

Clause 57. The method of the tree-structured wireless sensing system of clause 55, further comprising: forwarding the at least one linkwise analytics by the new device to another existing device.

The new device may replace the root device as the new root device.

Clause 58. The method of the tree-structured wireless sensing system of clause 53: wherein the existing device is the existing root of the existing tree, wherein the new device replaces the existing device as the new root of the tree.

Clause 59. The method of the tree-structured wireless sensing system of clause 1, further comprising: removing an existing wireless device from the tree, removing a pairwise wireless link in which the existing wireless device transmits a wireless signal to another existing device, and updating the information of the plurality of the wireless device and the tree interconnection structure in the database.

One may remove an existing Rx device (Type B) and associated link.

Clause 60. The method of the tree-structured wireless sensing system of clause 1, further comprising: removing an existing wireless device from the tree, wherein the existing device is a Type B device, removing a pairwise wireless link in which the existing wireless device receives a wireless signal from another existing device, and updating the information of the plurality of the wireless device and the tree interconnection structure in the database.

One may remove an existing Rx device (Type B) and associated link.

Clause 61. The method of the tree-structured wireless sensing system of clause 1, further comprising: removing an existing wireless device from the tree, wherein the existing device is a Type B device, removing a pairwise wireless link in which the existing wireless device receives a first wireless signal from a first existing device, removing a pairwise wireless link in which the existing wireless device transmits a second wireless signal to a second existing device, adding a pairwise wireless link in which the first existing device transmits a third wireless signal to the second existing device, and updating the information of the plurality of the wireless device and the tree interconnection structure in the database.

One may add a link without adding a new device.

Clause 62. The method of the tree-structured wireless sensing system of clause 1, further comprising: adding a pairwise wireless link between a first existing device and a second existing device of the tree, updating the information of the plurality of the wireless device and the tree interconnection structure in the database.

One may add a new link without adding a new device, with detailed operations.

Clause 63. The method of the tree-structured wireless sensing system of clause 1, further comprising: adding a pairwise wireless link between a first existing device and a second existing device of the tree, updating the information of the plurality of the wireless device and the tree interconnection structure in the database, transmitting a wireless signal by the first device to the second device, receiving the wireless signal by the second device, obtaining a TSCI from the wireless signal by the second device, monitoring the object motion based on the TSCI by the second device, and computing a linkwise analytics based on the TSCI by the second device.

One may remove an existing link without removing any device.

Clause 64. The method of the tree-structured wireless sensing system of clause 1, further comprising: removing an existing pairwise wireless link between a first existing device and a second existing device of the tree, updating the information of the plurality of the wireless device and the tree interconnection structure in the database.

One may add a new link without adding a new device, with detailed operations.

Clause 65. The method of the tree-structured wireless sensing system of clause 1, further comprising: removing an existing pairwise wireless link between a first existing device and a second existing device of the tree, updating the information of the plurality of the wireless device and the tree interconnection structure in the database, stopping to transmit a wireless signal by the first device to the second device, stopping to receive the wireless signal by the second device, stopping to obtain a TSCI from the wireless signal by the second device, stopping to monitor the object motion based on the TSCI by the second device, and stopping to compute a linkwise analytics based on the TSCI by the second device.

One may propagate updated information.

Clause 66. The method of the tree-structured wireless sensing system of clause 1, further comprising: updating at least one of: a routing table, and the information of the plurality of wireless devices and the tree interconnection structure in the database, and propagating the update to the plurality of wireless devices.

One may propagate more than one root devices (each with internee access, e.g. one using Ethernet and one using LTE).

Clause 67. The method of the tree-structured wireless sensing system of clause 1: wherein the tree interconnection structure has more than one roots, wherein each of the more than one roots of the tree is a Type B device.

There may be more than one routes between two nodes (e.g. first node may have a link to second node, but first node may also have a link to third node that has a link to second node).

Clause 68. The method of the tree-structured wireless sensing system of clause 1: wherein there are more than one routes from a first node of the tree to a second node of the tree.

Clause 69. System, device and software claims from: the angle of a Type A device, the angle of a Type B device as a leaf node, the angle of a Type B device as a non-leaf node, the angle of a Type B device as root node, the angle of server.

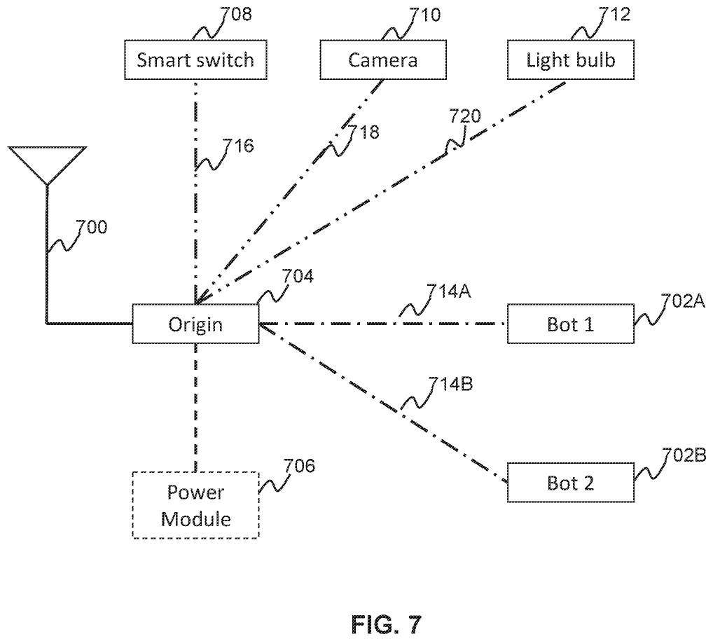

Another example is shown in FIG. 7, where the Type 1 device (Origin 704) and/or the Type 2 device (Bot 1 702A, Bot 2 702B) may be a standalone device, or an embedded device. It may be connected to another system (for power 716, signaling, network access, etc.) using a connector/port such as USB (e.g. Type A/B/C/D/E, micro-USB, mini-USB, etc.), Thunderbolt, Firewire, Lightning (e.g. in Apple devices such as iPhone, iPad, AirPods, etc.), 013D (on-board-diagnostic port), cigarette lighter port (e.g. 12V), PCI (e.g. PCI, PCI Express, etc.), VGA, DVI, HDMI, parallel port, serial port, ADAT, BNC, D-SUB, F. MCX, N, PS/2, RCA, SATA, S-video, SATA, mSATA, m.2, SMA, SMB, SMC, S/PDIF, RJ-11, RJ-45, SCSI, TNC, TS, TRS, UHF, XLR, coaxial, optical, Ethernet, display port, etc. For example in FIG. 7, the Origin 704 may be connected to mobile devices, personal computers, home appliance, a smart switch 708, cameras 710, light bulbs 712, smoke detector, and etc. The Origin 704 may do automation trigger (e.g., turn on/off a light bulb, camera, electric appliance, AC, save an image/video clip on a camera, etc.) upon detecting motion, breathing, presence, security alert, body motion, people movement, vehicle motion, in-vehicle activities, etc., through direction connection, open/public IFTTT, closed/private API integration, etc. Storage may be communicatively associated with the Type 1 and/or Type device, such as SD card, hard disk, etc. For example, motion is detected, then the camera is triggered to capture a picture or video clip which is saved on the storage. Alert may also be sent to end user.

Any device (e.g., Origin 704, Bot 1 702A, Bot 2 702B in FIG. 7) may provide location information, through GPS, MAC layer, layer, Wi-Fi, an IEEE 802.11 standard, 802.11a/b/g/n/ac/ad/af/ag/ah/ai/aj/aq/ax/ay, Bluetooth, Bluetooth 1.0/1.1/1.2/2.0/2.1/3.0/4.0/4.1/4.2/5, BLE, mesh network, an IEEE 802.16/1/1a/1b/2/2a/a/b/c/d/e/f/g/h/i/j/k/l/m/n/o/p/, standard, 802.16, Zigbee, Max, IJWB, mobile channel, 1G/2G/3G/3.5G/4G/LTE/5G/6G/7G/NBIoT, etc.

In one embodiment, automatic and optimized device-to-cloud connection for WiFi sensing is described. The Type 1 device and/or Type 2 device may be communicatively couple with: the internet, another device with access to internet (e.g. smart phone), a cloud server, an edge server, a local server, and/or a storage, a base station operating on 1G/2G/3G/3.5G/4G/LTE/5G/6G/7G/NBIoT etc, and the link/communication between the at least one of them and the Type 1 device and/or Type 2 device may be established with a simplified set up process. This may improve the user experience, and reduce the operational effort/cost of internet service provider (ISP), dealers or technicians.

In one embodiment, automatic device-to-cloud connection is described. In one aspect, the Type 1 device and/or Type 2 device can initiate/start the connection within x time after it is turned on without a user action, where x can be several milliseconds, several seconds or several minutes.

In one embodiment, the optimal connection is selected. In another aspect, the Type 1 and/or Type 2 device can automatically choose the best connection means, without a user action, to ensure the bet device-to-cloud connectivity. The best connection be may determined based on the stream of traffic, class of service (CoS), latency, user experience from end to end, packet loss, bandwidth; data rate supported, types of applications or data during the connection, performance and service level agreements (SLAs), availability, provisioning time, security, price per magabit, initial setup costs, etc.

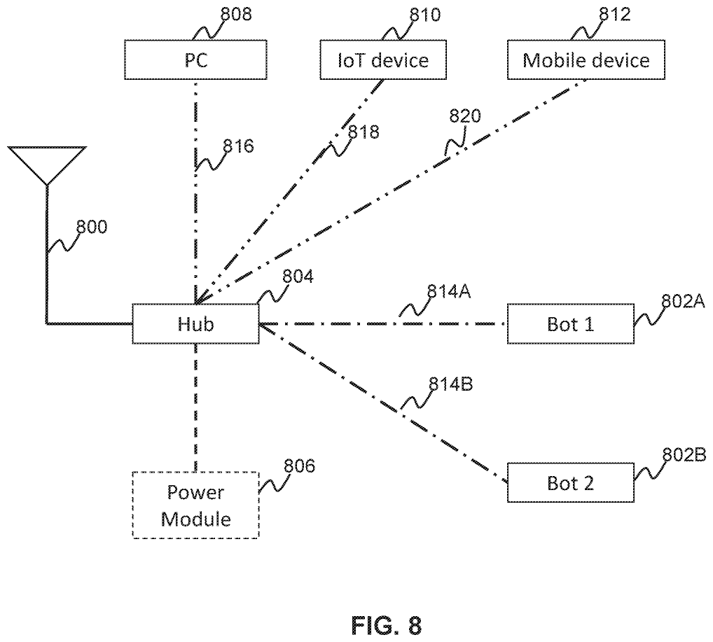

In another example, in FIG. 8, the Origin may be a hub 804. It may connect to PC 808; IoT devices 810, mobile devices 812, etc. for sending/receiving data. The data rate may/may not be low. It may also connect to Bot(s) 802A, 802B for wireless sensing.

In various embodiments of the present teaching, an exemplary WiFi sensing system/device/method/software is disclosed in the following clauses.

Clause A1. A method/system/device/soft-ware of a wireless sensing system having at least a processor and a memory with a set of instructions stored therein for sensing motion in a venue, comprising: a Type 1 heterogeneous wireless device configured for transmitting a wireless signal through a wireless multipath channel impacted by a motion of an object in the venue; a Type 2 heterogeneous wireless device configured for: receiving the wireless signal through the wireless multipath channel impacted by the motion of the object in the venue, and obtaining a time series of channel information (CI) of the wireless multipath channel based on the wireless signal; and a motion sensor configured for monitoring the motion of the object in the venue based on motion information related to the motion of the object, wherein the motion information associated with the Type 1 and Type 2 wireless devices is computed based on the time series of CI by at least one of: the motion detector and the Type 2 wireless device.

One Type 2 device may serve two different Type 1 device in two different motion monitoring tasks.

Clause A2. The method/system/device/software of the wireless sensing system of clause A1, further comprising: another Type 1 heterogeneous wireless device configured for transmitting another wireless signal through another wireless multipath channel impacted by another motion of another object in another venue; the Type 2 heterogeneous wireless device is further configured for: receiving the another wireless signal through the another wireless multipath channel impacted by the another motion of the another object in the venue, and obtaining another time series of another channel information (CI) of the another wireless multipath channel based on the another wireless signal; and another motion sensor configured for monitoring the another motion of the another object in the another venue based on another motion information related to the another motion of the another object, wherein the another motion information associated with the another Type 1 device and the Type 2 wireless devices is computed based on the another time series of another CI by at least one of: the another motion detector and the second wireless device.

One Type 2 device may be with two different Type 1 devices in a common motion monitoring task.

Clause A3. The method/system/device/software of the wireless sensing system of clause A1, further comprising: another Type 1 heterogeneous wireless device configured for transmitting another wireless signal through another wireless multipath channel impacted by the motion of the object in the venue; wherein the Type 2 heterogeneous wireless device is further configured for: receiving the another wireless signal through the another wireless multipath channel impacted by the motion of the object in the venue, and obtaining another time series of another channel information (CI) of the another wireless multipath channel based on the another wireless signal; and wherein another motion sensor is further configured for monitoring the motion of the object in the venue based on another motion information related to the motion of the object, wherein the another motion information associated with the another Type 1 device and the Type 2 wireless devices is computed based on the another time series of another CI by at least one of: the another motion detector and the second wireless device.

One Type 2 device may be with two different Type 1 devices in a common motion monitoring task.

Clause A1. The method/system/device/software of the wireless sensing system of clause A1, further comprising: another Type 1 heterogeneous wireless device configured for transmitting another wireless signal through another wireless multipath channel impacted by the motion of the object in the venue; wherein the Type 2 heterogeneous wireless device is further configured for: receiving the another wireless signal through the another wireless multipath channel impacted by the motion of the object in the venue, and obtaining another time series of another channel information (CI) of the another wireless multipath channel based on the another wireless signal; and wherein the motion sensor is further configured for monitoring the motion of the object in the venue jointly based on the motion information and another motion information related to the motion of the object, wherein the another motion information associated with the another Type 1 device and the Type 2 wireless devices is computed based on the another time series of another CI by at least one of: the motion detector and the second wireless device.

One Type 2 device may be with two different Type 1 devices in a common motion monitoring task.

Clause A5. The method/system/device/software of the wireless sensing system of clause A1, further comprising: another Type 1 heterogeneous wireless device configured for transmitting another wireless signal through the wireless multi path channel impacted by the motion of the object in the venue; wherein the Type 2 heterogeneous wireless device is further configured for: receiving the another wireless signal through the wireless multipath channel impacted by the motion of the object in the venue, and obtaining another time series of channel information (CI) of the wireless multipath channel based on the another wireless signal; and wherein the motion sensor is further configured for monitoring the motion of the object in the venue jointly based on the motion information and another motion information related to the motion of the object, wherein the another motion information associated with the another Type 1 device and the Type 2 wireless devices is computed based on the another time series of CI by at least one of: the motion detector and the second wireless device.

One Type 1 device may be with two different Type 2 devices in two different motion monitoring tasks.

Clause A6. The method/system/device/software of the wireless sensing system of clause A1, further comprising: another Type 2 heterogeneous wireless device, wherein the Type 1 heterogeneous wireless device is further configured for transmitting another wireless signal through another wireless multipath channel impacted by another motion of another object in another venue, wherein the another Type 2 heterogeneous wireless device is configured for: receiving the another wireless signal through the another wireless multipath channel impacted by the another motion of the another object in the another venue, and obtaining another time series of another channel information (CI) of the another wireless multipath channel based on the another wireless signal; another motion sensor configured for monitoring the another motion of the another object in the another venue based on another motion information related to the another motion of the another object, wherein the another motion information associated with the Type 1 and the another Type 2 wireless devices is computed based on the another time series of another CI by at least one of: the another motion detector and the another Type 2 wireless device.

One Type 1 device may be with two different Type 2 device in two different motion monitoring tasks.

Clause A7. The method/system/device/software of the wireless sensing system of clause A1, further comprising: another Type 2 heterogeneous wireless device, wherein the Type 1 heterogeneous wireless device is further configured for transmitting another wireless signal through another wireless multipath channel impacted by the motion of the object in the venue, wherein the another Type 2 heterogeneous wireless device is configured for: receiving the another wireless signal through the another wireless multipath channel impacted by the motion of the object in the venue, and obtaining another time series of another channel information (CI) of the another wireless multipath channel based on the another wireless signal; another motion sensor configured for monitoring the motion of the object in the venue based on another motion information related to the motion of the object, wherein the another motion information associated with the Type 1 and the another Type 2 wireless devices is computed based on the another time series of another CI by at least one of: the another motion detector and the another Type 2 wireless device.

Clause A8. The method/system/device/software of the wireless sensing system of clause A1, further comprising: another Type 2 heterogeneous wireless device, wherein the Type 1 heterogeneous wireless device is further configured for transmitting another wireless signal through another wireless multipath channel impacted by the motion of the object in the venue, wherein the another Type 2 heterogeneous wireless device is configured for: receiving the another wireless signal through the another wireless multipath channel impacted by the motion of the object in the venue, and obtaining another time series of another channel information (CI) of the another wireless multipath channel based on the another wireless signal; wherein the motion sensor is further configured for monitoring the motion of the object in the venue jointly based on the motion information and another motion information related to the motion of the object, wherein the another motion information associated with the Type 1 and the another Type 2 wireless devices is computed based on the another time series of another CI by at least one of: the another motion detector and the another Type 2 wireless device.

Clause A9. The method/system/device/software of the wireless sensing system of clause A1, further comprising: another Type 2 heterogeneous wireless device, wherein the Type 1 heterogeneous wireless device is further configured for transmitting another wireless signal through the wireless multipath channel impacted by the motion of the object in the venue, wherein the another Type 2 heterogeneous wireless device is configured for: receiving the another wireless signal through the wireless multipath channel impacted by the motion of the object in the venue, and obtaining another time series of channel information (CI) of the wireless multipath channel based on the another wireless signal; wherein the motion sensor is further configured for monitoring the motion of the object in the venue jointly based on the motion information and another motion information related to the motion of the object, wherein the another motion information associated with the Type 1 and the another Type 2 wireless devices is computed based on the another time series of CI by at least one of: the motion detector and the another Type 2 wireless device.

Type 2 device may play the role of Type 1 device in another “link”—between the Type 2 device and another Type 2 device.

Clause A10. The method/system/device/software of the wireless sensing system of clause A1, further comprising: wherein the Type 2 heterogeneous wireless device is further configured for transmitting another wireless signal through another wireless multipath channel impacted by another motion of another object in another venue, another Type 2 heterogeneous wireless device configured for: receiving the another wireless signal through the another wireless multipath channel impacted by the another motion of the another object in the another venue, and obtaining another time series of another channel information (CI) of the another wireless multipath channel based on the another wireless signal; and another motion sensor configured for monitoring the another motion of the another object in the another venue based on another motion information related to the another motion of the another object, wherein the another motion information associated with the Type 2 and the another Type 2 wireless devices is computed based on the another time series of another CI by at least one of: the another motion detector and the another Type 2 wireless device.

Clause A11. The method/system/device/software of the wireless sensing system of clause A1, further comprising: wherein the Type 2 heterogeneous wireless device is further configured for transmitting another wireless signal through another wireless multipath channel impacted by the motion of the object in the venue, another Type 2 heterogeneous wireless device configured for: receiving the another wireless signal through the another wireless multipath channel impacted by the motion of the object in the venue, and obtaining another time series of another channel information (CI) the another wireless multipath channel based on the another wireless signal; and another motion sensor configured for monitoring the motion of the object in the venue based on another motion information related to the motion of the object, wherein the another motion information associated with the Type 2 and the another Type 2 wireless devices is computed based on the another time series of another CI by at least one of: the another motion detector and the another Type 2 wireless device.

Clause A12. The method/system/device/software of the wireless sensing system of clause A1, further comprising: wherein the Type 2 heterogeneous wireless device is further configured for transmitting another wireless signal through the wireless multipath channel impacted by the motion of the object in the venue, another Type 2 heterogeneous wireless device configured for: receiving the another wireless signal through the wireless multipath channel impacted by the motion of the object in the venue, and obtaining another time series of channel information (CI) of the wireless multipath channel based on the another wireless signal; and wherein the motion sensor is further configured for monitoring the motion of the object in the venue jointly based on the motion information and another motion information related to the motion of the object, wherein the another motion information associated with the Type 2 and the another Type 2 wireless devices is computed based on the another time series of CI by at least one of: the motion detector and the another Type 2 wireless device.

Type 1 device may play the role of Type 2 device in another “link”—between the Type 1 device and another Type 1 device.

Clause A13. The method/system/device/software of the wireless sensing system of clause A1, further comprising: another Type 1 heterogeneous wireless device configured for transmitting another wireless signal through another wireless multipath channel impacted by, another motion of another object in another venue; wherein the Type 1 heterogeneous wireless device is further configured for: receiving the another wireless signal through the another wireless multipath channel impacted by the another motion of the another object in the another venue, and obtaining another time series of another channel information (CI) of the another wireless multipath channel based on the another wireless signal; and another motion sensor configured for monitoring the another motion of the another object in the another venue based on another motion information related to the another motion of the another object, wherein the another motion information associated with the another Type 1 and the Type 1 wireless devices is computed based on the another time series of another CI by at least one of: the another motion detector and the Type 1 wireless device.

Type 1 device may play the role of Type 2 device in another “link”—between the Type 1 device and another Type 1 device.

Clause A14. The method/system/device/software of the wireless sensing system of clause A1; further comprising: another Type 1 heterogeneous wireless device configured for transmitting another wireless signal through another wireless multipath channel impacted by the motion of the object in the venue; wherein the Type 1 heterogeneous wireless device is further configured for: receiving the another wireless signal through the another wireless multipath channel impacted by the motion of the object in the venue, and obtaining another time series of another channel information (CI) of the another wireless multipath channel based on the another wireless signal; and another motion sensor configured for monitoring the motion of the object in the venue based on another motion information related to the motion of the object, wherein the another motion information associated with the another Type 1 and the Type 1 wireless devices is computed based on the another time series of another CI by at least one of: the another motion detector and the Type 1 wireless device.

Clause A15. The method/system/device/software of the wireless sensing system of clause A1, further comprising: another Type 1 heterogeneous wireless device configured for transmitting another wireless signal through the wireless multipath channel impacted by the motion of the object in the venue; wherein the Type 1 heterogeneous wireless device is further configured for: receiving the another wireless signal through the wireless multipath channel impacted by the motion of the object in the venue, and obtaining another time series of channel information (CI) of the wireless multipath channel based on the another wireless signal; and wherein the motion sensor is further configured for monitoring the motion of the object in the venue jointly based on the motion information and another motion information related to the motion of the object, wherein the another motion information associated with the another Type 1 and the Type 1 wireless devices is computed based on the another time series of CI by at least one of: the motion detector and the Type 1 wireless device.

In terms of power dependence/independency, the Type 1 device or Type 2 device may be battery-powered, AC-powered, DC-powered, solar-powered, etc.

Clause A16. The method/system/device/software of the wireless sensing system of clause A1: wherein at least one of: the Type 1 wireless device, the Type 2 wireless device and the motion detector is powered by at least one of: external power source, internal power source, a wall power source, a fixed power source, a portable power source, a direct-current (DC) power source, an alternate-current (AC) power source, a power storage device, a power generating device, a power converting device, a power transforming device, a battery, a rechargeable battery, a fuel cell, a solar panel, a solar cell, a power supply, a USB port (e.g. Type A/B/C/D/E, micro USB, mini USB), a Thunderbolt port (in Apple devices such as iPhone, iPad, AirPods, etc., a Firewire port, a Lightning port, an OBD (on board diagnostic) port (e.g. in cars), a cigarette lighter port (12V), PoE (power over Ethernet), PCI (e.g. PCI, PCI Express, etc.), VGA, DVI, HDMI, parallel port, serial port, ADAT, BNC, D-SUB, F, MIDI, UHF, MCX, N, PS/2, RCA, SATA, S-video, SATA, mSATA, m.2, SMA, SMB, SMC, S/PDIF, RJ-11, RJ-45, SCSI, TNC, TS, TRS, UHF, mini-UHF, XLR, coaxial, optical, Ethernet, display port, and another power source.

Clause A17. The method/system/device/software of the wireless sensing system of clause A1: wherein at least one of: the Type 1 wireless device, the Type 2 wireless device and the motion detector comprises at least one of: an external power source, an internal power source, a direct-current (DC) power source, a DC adapter, an alternate-current (AC) power source, an AC adapter, a power storage unit, a power generating unit, a power converting unit, a power transforming unit, a charging unit, a charger, a transformer, a magnetic coupling, an electro-magnetic coupling, a battery, a rechargeable battery, a fuel cell, a capacitor, an inductor, an alternator, a generator, a solar panel, a solar cell, a power supply, and another power management unit.

Type 1 device or Type 2 device may connect to cloud server automatically.

Clause A18. The method/system/device/software of the wireless sensing system of clause A1: wherein at least one of: the Type 1 wireless device, the Type 2 wireless device and the motion detector establishes communication with a remote server in at least one of the following manners: (a) automatic, (b) fully automatic, (c) semi-automatic, (d) manual, (e) no user input, (f) preset, (g) upon power-up, (h) upon reboot, (i) upon reset or restart, (j) upon a key press, (k) upon a click, (l) upon set-up, (m) upon a user input, (n) direct, (o) indirect, and (p) another manner.

Type 1 device or Type 2 device may associate with cloud server automatically.

Clause A19. The method/system/device/software of the wireless sensing system of clause A1: wherein at least one of: the Type 1 wireless device, the Type 2 wireless device and the motion detector associates with a remote server in at least one of the following manners: (a) automatic, (b) fully automatic, (c) semi-automatic, (d) manual, (e) no user input. (f) preset, (g) upon power-up, (h) upon reboot, (i) upon reset or restart, (j) upon a key press, (k) upon a click, (l) upon set-up, (m) upon a user input, (n) direct, (o) indirect, and (p) another manner.

Type 1 device or Type 2 device may use various connectivity to connect to the cloud.

Clause A20. The method/system/device/software of the wireless sensing system of clause A1: wherein at least one of: the Type 1 wireless device, the Type 2 wireless device and the motion detector establishes communication with a remote server based on at least one of the following connectivity: wired connectivity, wired network, USB, Thunderbolt, Firewire, Lightning, OBD, cigarette lighter, PoE, PCI, VGA, DVI, HDMI, parallel port, serial port, ADAT, BNC, D-SUB, F, MIDI, UHF, MCX, N, PS/2, RCA, SATA, S-video, SATA, mSATA, m.2, SMA, SMB, SMC, S/PDIF, RJ-11, RJ-45, SCSI, TNC, TS, TRS, UHF, mini-UHF, XLR, coaxial, optical, Ethernet, display port, wireless connectivity, wireless network, WiFi, UWB, mesh network, Bluetooth, BLE, mmWave, Zigbee, microwave, light communication, connected lighting, 802.11, 802,15, 802.16, mobile connectivity, mobile network, 2G, 3G, 4G. LTE, 5G, 6G, 7G, 8G, WiMax, LTE, 3GPP, WLAN, WPAN, WMAN, and another connectivity.

Type 1 device or Type 2 device may select optimal connectivity.

Clause A21. The method/system/device/software of the wireless sensing system of clause A1: wherein at least one of: the Type 1 wireless device, the Type 2 wireless device and the motion detector establishes communication with a remote server by selecting at least one of the following connectivity based on a selection criterion: wired connectivity, wired network, USB, Thunderbolt, Firewire, Lightning, OBD, cigarette lighter, PoE, PCI, VGA, DVI, HDMI, parallel port, serial port, ADAT, BNC, D-SUB, F, MIDI, UHF, MCX, N, PS/2, RCA, SATA, S-video, SATA, mSATA, m.2, SMA, SMB, SMC, S/PDIF, RJ-11, RJ-45, SCSI, TNC, TS, TRS, UHF, mini-UHF, XLR, coaxial, optical, Ethernet, display port, wireless connectivity, wireless network, WiFi, UWB, mesh network, Bluetooth, BLE, mmWave, Zigbee, microwave, light communication, connected lighting, 802,11, 802.15, 802,16, mobile connectivity, mobile network, 2G, 3G, 4G, LTE, 5G, 6G, 7G, 8G, WiMax, LTE, NBIoT, 3GPP, WLAN, WPAN, WMAN, and another connectivity.

Type 1 device or Type 2 device may have storage card such as SD card.

Clause A22. The method/system/device/software of the wireless sensing system of clause A1: wherein at least one of: the Type 1 wireless device, and the Type 2 wireless device comprises at least one of: an external storage unit, a removable storage, a harddisk, a flash drive, a flash memory, local storage, a memory card, a memory cartridge, an secure digital (SD) card, a microSD card, a CompactFlash (CF) card, a SmartMedia card, a miniature card, a multimedia card (MMC), a PCMCIA card, a memory stick, an XD card, a P2 card, a m.2 card, a SIM card, and another storage medium.

Clause A23. The method/system/device/software of the wireless sensing system of clause A1: wherein the venue comprises at least one of: an indoor environment, an enclosed environment, an outdoor environment, an open-air environment, a facility, a warehouse, a factory, a manufacturing facility, an assembly line, a building, a multi-storey building, a house, a home, an office, a store, a supermarket, a casino, a hotel, a room, a box, a stadium, a hall, a station, a hospital, an airport, a port, a subway, a vehicle, a car, a boat, a ship, a cruise ship, a submersible, a plane, a drone, a cave, a tunnel, a pipe, a piping system, a crawl space, a maintenance system, a tube, an air conditioning/ventilation system, a fluid, and another venue.

Clause A24. The method/system/device/software of the wireless sensing system of clause A1: wherein the venue comprises at least one of: people, pet, children, animals, plants, partitions, walls, dry walls, concrete walls, brick walls, glass walls, metal walls, doors, windows, glasses, floors, ceilings, attics, garage, fireplace, parking facilities, structure elements, columns, beams, movable objects, non-movable objects, furniture, wardrobe, fixtures, machines, devices, lighting, curtains, blinds, construction features, building features, water pipes, air ducts, crawl space, basement, elevator, stairs, stair wells, hall way, corridor, maintenance space, fan, ventilation system, air-condition system, heat, HVAC, electrical wiring, refrigerator, cooking devices, oven, microwave, stove, television, sound system, smart speaker, lights, carpets, restricted area, limited-access area, forbidden area, and another feature.

The Type 1 device or Type 2 device may house an IoT device.

Clause A25. The method/system/device/software of the wireless sensing system and of clause A1: wherein at least one of: the Type 1 device and the Type 2 device, to house at least one of: another device, an Internet-of-thing (IoT) device, a smart-device, a smart appliance, a smart fixture, a smart clock, a smart stationary, a smart pen, a smart user-interface, a smart paper, a smart mat, a smart camera, a smart television (TV), a set-top-box, a smart microphone, a smart speaker, a smart refrigerator, a smart oven, a smart machine, a smart phone, a smart wallet, a smart furniture, a smart door, a smart window, a smart ceiling, a smart floor, a smart wall, a smart table, a smart chair, a smart bed; a smart night-stand, a smart air-conditioner, a smart heater, a smart pipe, a smart duct, a smart cable, a smart carpet, a smart decoration, a smart gadget, a smart USB device, a smart plug, a smart dongle, a smart lamp/light, a smart tile, a smart ornament, a smart bottle, a vehicle, a smart car, a smart AGV, a drone, a smart robot, a laptop, a tablet, a computer, a harddisk, a network card, a smart instrument, a smart racket, a smart ball, a smart shoe, a smart wearable, a smart clothing, a smart glasses, a smart hat, a smart necklace, a smart food, a smart pill, a small device that moves in the body of a creature, and another device.

The Type 1 device or Type 2 device may trigger an IoT device.

Clause A26. The method/system/device/software of the wireless sensing system and of clause A1: wherein at least one of: the Type 1 device and the Type 2 device, to trigger at least one of: another device, an internet-of-thing (IoT) device, a smart-device, a smart appliance, a smart fixture, a smart clock, a smart stationary, a smart pen, a smart user-interface, a smart paper, a smart mat, a smart camera, a smart television (TV), a set-top-box, a smart microphone, a smart speaker, a smart refrigerator, a smart oven, a smart machine, a smart phone, a smart wallet, a smart furniture, a smart door, a smart window, a smart ceiling, a smart floor, a smart wall, a smart table, a smart chair, a smart bed, a smart night-stand, a smart air-conditioner, a smart heater, a smart pipe, a smart duct, a smart cable, a smart carpet, a smart decoration, a smart gadget, a smart USB device, a smart plug, a smart dongle, a smart lamp/light, a smart tile, a smart ornament, a smart bottle, a vehicle, a smart car, a smart AGV, a drone, a smart robot, a laptop, a tablet, a computer, a harddisk, a network card, a smart instrument, a smart racket, a smart ball, a smart shoe, a smart wearable, a smart clothing, a smart glasses, a smart hat, a smart necklace, a smart food, a smart pill, a small device that moves in the body of a creature, and another device.

The motion sensor may monitor various things.

Clause A27. The method/system/device/software of the wireless sensing system and of clause A1: wherein the motion sensor is configured to monitor at least one of the motion of the object, a breathing motion of a person, a periodic motion of a person, a repeated motion of a person, a fall-down of a person, a transient motion of the person, a change of the object, a presence, an absence, a presence of motion, an absence of motion, a presence of the object, an absence of the object, a change of the object, a deformation of the object, an action of the object, a movement of the object, an entrance of the object, an exit of the object, a presence of a repetitive motion, a motion frequency, a motion period, a motion rhythm, a breathing motion frequency, a breathing motion period, a motion cycle, a motion count, a motion intensity, a breathing motion period, a motion classification, a gait information, a motion sequence, a presence of a transient motion, a motion change, a motion event information, an entrance event, an exit event, an object fall down motion, a resizing motion, a deformation motion, a turning motion, a translational motion, a rotational motion, a gesture, a handwriting motion, a head motion, a mouth motion, a heart motion, an internal organ motion, a presence of a statistical motion, a statistical motion quantity, a mean, a variance, an autocorrelation, an auto-covariance, a cross correlation, a cross covariance, a wind motion, a motion localization, a motion location, a motion intensity, a presence of motion, an absence of motion, a presence of the object, an absence of the object, a time history of the motion statistics, a change of the motion statistics, a behavior of the motion statistics, and/or, a trend of the motion statistics, an appearing, a disappearing, an increase, a decrease, a spending-up, a slowing-down, a direction change, a sudden motion, an impulsive motion, a size, a length, an area, a volume, a capacity, a shape, a form, a spatial quantity, a location, a distance, a spatial range, a spatial label, a spatial tag, a starting location, an ending location, a speed, an acceleration, a rotation, an angular motion, a differential, a direction, a spatial trend, a temporal quantity, a time stamp, a time label, a time tag, a starting quantity, an ending quantity, a starting time, an ending time, a duration, a count, a period, a time window, a rate, a timing, a time delay, a trend, a time trend, a motion profile, a time event, a time-space quantity, a time-frequency quantity, a time-frequency-space quantity, a. periodic behavior, a transient behavior, a periodic motion, a pseudo-periodic motion, a transient motion, a steady state behavior, a planned motion, an unplanned motion, and/or a perturbation, a statistical behavior, a stationary behavior, a quasi-stationary behavior, a cyclo-stationary behavior, a chaotic behavior, a co-occurrence, a timed-occurrence, an interaction, a response, an activity, a sign of an activity, a gesture, a gait, a body motion, a body part motion, a hand motion, an atm motion, a foot motion, a leg motion, a head motion, a facial motion, a mouth motion, an eye motion, a gaze, a breathing motion, a heart motion, a writing motion, a drawing motion, a finger motion, a user-interface motion, an event, a fall-down event, a security event, an accident event, a home event, an office event, a factory event, a warehouse event, a manufacturing event, an assembly line event, a maintenance event, a car-related event, a navigation event, a tracking event, a door event, a door-open event, a door-close event, a window event, a window-open event, a window-close event, a repeatable event, a one-time event, another event, a frequency characteristics, a frequency, a spectrum, a starting frequency, an ending frequency, a changing frequency, a frequency shift, a frequency trend, a frequency event, a user, a household, an office, a factory, a warehouse, a facility, an identity (ID), a consumed quantity, an unconsumed quantity, a state, a physical state, a health state, a well-being state, an emotional state, a mental state, and another motion information.

One may compute analytics.

Clause A28. The method/system/device/software of the wireless sensing system and of clause A1: wherein the motion sensor is configured to compute an analytics based on the motion of the object.

One may process analytics.

Clause A29. The method/system/device/software of the wireless sensing system and of clause A1: wherein the motion sensor is configured to process at least one of: an analytics computed based on the motion of the object, and a history of the analytics.

Clause A30. The method/system/device/software of the wireless sensing system and of clause A1: wherein the motion sensor is configured to compute an analytics based on the motion of the object, wherein the motion sensor is further configured to at least one of: store at least one of: the analytics, and a history of the analytics, compute another analytics based on at least one of: the analytics, and a history of the analytics, communicate at least one of: the analytics, and the history of the analytics, to a remote device, process at least one of: the another analytics, and another history of the another analytics, communicate at least one of: the another analytics, and the another history of the another analytics, to a remote device.

Clause A31. The method/system/device/software of the wireless sensing system and of clause A1: wherein the motion sensor is configured to compute an analytics based on the motion of the object, wherein at least one of: the analytics, and a history of the analytics, is communicated to a remote device, wherein at least one of: the analytics, and the history of the analytics, is displayed by the remote device.

Clause A32. The method/system/device/software of the wireless sensing system and of clause A1: wherein the motion sensor is configured to compute an analytics based on the motion of the object, wherein at least one of: the analytics, and a history of the analytics, is communicated to a remote device, wherein at least one of: the analytics, and the history of the analytics, is analyzed by the remote device, wherein another analytics is computed and processed by the remote device based on at least one of: the analytics, and the history of the analytics.

Clause A33. The method/system/device/software of the wireless sensing system and of clause A32: wherein at least one of: the another analytics, and another history of the another analytics, is communicated to and displayed by another remote device.

The features described above may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result, A computer program may be written in any form of programming language (e.g., C, Java), including compiled or interpreted languages, and it may be deployed in any form, including as a stand-alone program or as a module, component, subroutine, a browser-based web application, or other unit suitable for use in a computing environment.

Suitable processors for the execution of a program of instructions include, e.g., both general and special purpose microprocessors; digital signal processors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

While the present teaching contains many specific implementation details, these should not be construed as limitations on the scope of the present teaching or of what may be claimed, but rather as descriptions of features specific to particular embodiments of the present teaching. Certain features that are described in this specification in the context of separate embodiments may also be implemented in combination in a single embodiment. Conversely, various features that are described in the context of a single embodiment may also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiting such separation in all embodiments, and it should be understood that the described program components and systems may generally be integrated together in a single software product or packaged into multiple software products.

Particular embodiments of the subject matter have been described. Any combination of the features and architectures described above is intended to be within the scope of the following claims. Other embodiments are also within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A method of a wireless sensing system comprising a processor, a memory communicatively coupled with the processor, and a set of instructions stored in the memory to be executed by the processor, comprising, comprising:
determining an interconnection structure of the wireless sensing system comprising a plurality of wireless devices in a venue to be a tree, wherein:
each of the plurality of wireless devices is at least one of: a Type A device having at least one wireless transmitter configured for transmitting wireless signals, or a Type B device having at least one wireless transceiver configured for both transmitting and receiving wireless signals,
each of the plurality of wireless devices is a node of the tree,
each Type A device is a leaf of the tree,
each Type B device is a leaf or a non-leaf of the tree,
one Type B device is a root device of the tree;
the plurality of wireless devices form at least one pairwise wireless link each being a branch of the tree and connecting a first device and a second device,
the first device is at least one of: a Type A device or a non-root Type B device, and
the second device is a Type B device; and
for each pairwise wireless link,
transmitting, by the first device, a wireless signal through a wireless multipath channel of the venue to the second device, wherein the wireless multipath channel is impacted by an object motion of an object in the venue,
receiving the wireless signal by the second device,
obtaining a time series of channel information (CI) of the wireless multipath channel based on the wireless signal,
monitoring the object motion based on the time series of CI (TSCI), and
computing a linkwise analytics related to the object motion based on the TSCI.

2. The method of claim 1, wherein:
the root device is a gateway device with a network access through at least one of: a wired network connection or a wireless network connection;
the network access comprises an access to at least one of: Internet, PAN, LAN, WLAN, CAN, MAN, WAN, SAN, or another network;
the wired network connection comprises at least one of: an Ethernet, a token ring, an FDDI, an optical fiber, a cable modem, a DSL modem, an ADSL modem, a HDSL modem, or another wired network connection;
the wireless network connection comprises at least one of: WiFi, LTE, 3G, 4G, 5G, 6G, Bluetooth, BLE, RFID, microwave link, satellite link or another wireless network connection.

3. The method of claim 1, further comprising:
storing an information of the plurality of wireless devices and the tree in a database in a server; and
updating the database in the server,
wherein the server is at least one of: one of the plurality of wireless devices, a local device, a cloud device, a dedicated device, or another device,
wherein the information comprises at least one of:
an identifier (ID) of the tree,
an address of the tree;
a setting of the tree,
an attribute of the tree,
a structure of the tree,
an identifier (ID) of the venue associated with the tree,
a physical location of the venue associated with the tree,
an address of the venue associated with the tree,
a cost associated with the tree,
another association of the tree,
an identifier (ID) of each of the plurality of wireless devices,
an address of each wireless device comprising at least one of: an IP address, a MAC address, or another address,
a setting of each wireless device,
an attribute of each wireless device,
a physical location of the venue associated with each wireless device,
a region of the venue associated with each wireless device,
a cost associated with each wireless device,
another association of each wireless device,
an ID of the root device,
a description of each pairwise wireless link comprising at least one of:
an identifier (ID) of the link,
a setting of the link,
an attribute of the link,
a physical location of the venue associated with the link,
a physical region of the venue associated with the link,
an event associated with the link,
a cost associated with the link,
another association of the link,
a Type 1 heterogeneous wireless device, a transmitting wireless device, a Tx device, an ID of the transmitting wireless device, or
a Type 2 heterogeneous wireless device, a receiving wireless device, an Rx device, an ID of the receiving wireless device, a MAC address of the receiving wireless device, or
a routing table comprising at least one of:
the description of the pairwise wireless links,
a routing of data from a wireless device towards another wireless device through the pairwise wireless links,
a routing of linkwise analytics towards at least one of: a destination device, the root device, a local server, or a cloud server,
a distance of each wireless device to the root device, or
a count of pairwise wireless links between each wireless device and a destination device.

4. The method of claim 3, further comprising:
updating at least one of: the information or the routing table.

5. The method of claim 4, further comprising:
finding a path to send data through the nodes of the tree towards a destination device based on at least one of: the information, the routing table, a requirement, or a criterion; and
changing the path based on at least one of: updated destination, updated information, updated routing table, updated requirement, or updated criterion.

6. The method of claim 1, further comprising:
routing the linkwise analytics towards the root device of the tree based on at least one of: a routing table, an information of the plurality of wireless devices, or the interconnection structure;
updating the routing based on at least one of: updated destination, updated information, updated routing table, updated requirement, or updated criterion.

7. The method of claim 1, further comprising:
transmitting the linkwise analytics through a number of nodes of the tree to the root device of the tree based on at least one of: a routing table, an information of the plurality of wireless devices, or the interconnection structure.

8. The method of claim 1, further comprising:
identifying at least one pairwise wireless link of the tree to be associated with a target region of the venue based on at least one of: a routing table or an information of the plurality of wireless devices.

9. The method of claim 1, further comprising:
identifying at least one pairwise wireless link of the tree to be associated with the object motion of the object in the venue based on at least one of: a routing table or an information of the plurality of wireless devices.

10. The method of claim 1, further comprising:
identifying at least one pairwise wireless link of the tree to be associated with a trajectory of the object moving through the venue based on at least one of: a routing table or an information of the plurality of wireless devices.

11. The method of claim 1, further comprising, for each pairwise wireless link where both the first device and the second device are Type B devices:
transmitting at least one linkwise analytics related to the object motion of the object in the venue by the first device to the second device;
receiving the at least one linkwise analytics by the second device; and
monitoring the object motion based on the at least one linkwise analytics.

12. The method of claim 1, further comprising, for each pairwise wireless link where both the first device and the second device are Type B devices:
transmitting at least one link-wise analytics related to the object motion of the object in the venue by the second device to the first device;
receiving the at least one linkwise analytics by the first device; and
monitoring the object motion based on the at least one linkwise analytics.

13. The method of claim 1, further comprising:
obtaining all of the computed linkwise analytics by the root device of the tree;
monitoring the object motion by the root device based on the obtained linkwise analytics; and
computing at least one overall analytics by the root device based on the obtained linkwise analytics.

14. The method of claim 13, further comprising:
receiving at least one wireless signal by the root device from at least one of the plurality of wireless devices;
obtaining at least one TSCI by the root device from the at least one wireless signal; and
computing at least one linkwise analytics by the root device based on the at least one TSCI.

15. The method of claim 13, further comprising:
making available, in a database through a network by the root device, at least one of: an overall analytics, a linkwise analytics, or a portion of an information of the plurality of wireless devices or the interconnection structure.

16. The method of claim 15, further comprising:
transmitting a message by the root device to a user device through a network based on at least one of: the overall analytics, the linkwise analytics, or the portion of the information of the plurality of wireless devices or the interconnection structure, in the database.

17. The method of claim 3, further comprising:
modifying the tree, wherein the tree is modified based on at least one of:
modifying the at least one pairwise wireless link without adding any new wireless device or removing any existing wireless device,
rearranging the at least one pairwise wireless link among a set of the plurality of wireless devices while keeping compositions of the set unchanged,
adding a new wireless device, wherein the new wireless device is at least one of: a Type A device, a Type B device, a leaf node, a non-leaf node, or a root node,
removing an existing wireless device, wherein the existing wireless device is at least one of: a Type A device, a Type B device, a leaf node, a non-leaf node, or a root node,
replacing the root device with another device of the plurality of wireless devices,
changing the at least one pairwise wireless link,
adding a new pairwise wireless link,
removing an existing pairwise wireless link,
removing an existing pairwise wireless link of the tree without removing any wireless device of the tree,
removing an existing pairwise wireless link of the tree by removing a wireless device of the tree,
adding a new pairwise wireless link of the tree without adding any new wireless device to the tree, or
adding a new pairwise wireless link of the tree by adding a new wireless device to the tree; and
updating the information of the plurality of wireless devices and the tree in the database.

18. The method of claim 3, further comprising:
sending a request to the server to add a new wireless device to the plurality of wireless devices as a node of tree;
sending control signals to the new wireless device and at least one existing device of the tree such that at least one pairwise wireless link is established between the new wireless device and the at least one existing device; and
updating at least one of: a routing table, or the information of the plurality of wireless devices and the tree in the database.

19. The method of claim 3, further comprising:
sending a request to the server to remove an existing wireless device from the tree;
sending control signals to the existing wireless device and at least one other device of the tree such that at least one pairwise wireless link associated with the existing wireless device is removed.

20. The method of claim 3, further comprising:
sending a request to the server to remove an existing wireless devices from the tree;
sending control signals to the existing wireless device and a first associated device of the tree such that a first pairwise wireless link between the existing wireless device and the first associated device is removed;
sending control signals to the existing wireless device and a second associated device of the tree such that a second pairwise wireless link between the existing wireless device and the second associated device is removed; and
sending control signals to the first associated device and the second associated device such that a new pairwise wireless link is established between the first associated device and the second associated device.

21. The method of claim 1, further comprising:
adding a new device to the plurality of wireless devices as a leaf node of the tree, wherein the new device is at least one of: a Type A device or a Type B device.

22. The method of claim 21, further comprising:
adding a new pairwise wireless link between the new device and an existing device of the tree;
transmitting a wireless signal by the new device to the existing device;
receiving the wireless signal by the existing device;
obtaining a TSCI by the existing device based on the wireless signal;
monitoring the object motion by the existing device based on the TSCI; and
computing a linkwise analytics by the existing device based on the TSCI.

23. The method of claim 1, further comprising:
adding a new device to the plurality of wireless devices as a non-leaf node of the tree, wherein the new device is a Type B device.

24. The method of claim 23, further comprising:
adding a new pairwise wireless link between the new device and an existing device of the tree;
receiving a wireless signal by the new device from the existing device;
obtaining a TSCI by the new device based on the wireless signal;
monitoring the object motion by the new device based on the TSCI; and
computing a linkwise analytics by the new device based on the TSCI.

25. The method of claim 1, further comprising:
adding a pairwise wireless link between a first existing device and a second existing device of the tree;
transmitting a wireless signal by the first existing device to the second existing device;
receiving the wireless signal by the second existing device;
obtaining a TSCI based on the wireless signal by the second existing device;
monitoring the object motion based on the TSCI by the second existing device, and
computing a linkwise analytics based on the TSCI by the second existing device.

26. The method of claim 1, further comprising:
removing an existing pairwise wireless link between a first existing device and a second existing device of the tree;
stopping to transmit a wireless signal by the first existing device to the second existing device;
stopping to receive the wireless signal by the second existing device;
stopping to obtain a TSCI based on the wireless signal by the second existing device;
stopping to monitor the object motion based on the TSCI by the second existing device; and
stopping to compute a linkwise analytics based on the TSCI by the second existing device.

27. The method of claim 3, further comprising:
updating at least one of: a routing table, or the information of the plurality of wireless devices and the tree in the database; and
propagating the update to the plurality of wireless devices.

8. The method of claim 1, wherein:
the tree has at least two roots; and
each of the at least two roots of the tree is a Type B device.

29. The method of claim 1, wherein there are at least two routes from a first node of the tree to a second node of the tree.

30. A wireless sensing system, comprising:
a plurality of wireless devices in a venue, wherein:
an interconnection structure of the plurality of wireless devices is a tree,
each of the plurality of wireless devices is at least one of: a Type A device having at least one wireless transmitter configured for transmitting wireless signals, or a Type B device having at least one wireless transceiver configured for both transmitting and receiving wireless signals,
each of the plurality of wireless devices is a node of the tree,
each Type A device is a leaf of the tree,
each Type B device is a leaf or a non-leaf of the tree,
one Type B device is a root device of the tree,
the plurality of wireless devices form at least one pairwise wireless link each being a branch of the tree and connecting a first device and a second device,
the first device is at least one of: a Type A device or a non-root Type B device, and
the second device is a Type B device,
for each pairwise wireless link, the first device is configured for transmitting a wireless signal through a wireless multipath channel of the venue to the second device, wherein the wireless multipath channel is impacted by an object motion of an object in the venue, and the second device is configured for:
receiving the wireless signal from the first device,
obtaining a time series of channel information (CI) of the wireless multipath channel based on the wireless signal,
monitoring the object motion based on the time series of CI (TSCI), and
computing a linkwise analytics related to the object motion based on the TSCI.
